(19) United States
(12) Patent Application Publication
(10) Pub. No.: US 2021/0243064 A1
(43) Pub. Date: Aug. 5, 2021

(54) DCM-COFDM Signaling Using Square QAM Symbol Constellations with Lattice-point Labels Having Over Four Bits Apiece

(71) Applicant: Allen LeRoy Limberg, Port Charlotte, FL (US)

(72) Inventor: Allen LeRoy Limberg, Port Charlotte, FL (US)

(21) Appl. No.: 17/237,045

(22) Filed: Apr. 22, 2021

Related U.S. Application Data
(63) Continuation-in-part of application No. 16/455,699, filed on Jun. 27, 2019.
Application No. 16/455,699 is a continuation-in-part of application No. 16/736,645, filed on Jan. 7, 2020.
Application No. 16/736,645 is a continuation-in-part of application No. 16/900,907, filed on Jun. 13, 2020.

(51) Int. Cl. H04L 27/26

(52) U.S. Cl. CPC H04L 27/2697; H04L 27/2614

(57) ABSTRACT

Labeling diversity of the superposition coding modulation (SCM) of dual-carrier modulation (DCM) of a coded orthogonal frequency-division multiplexed (COFDM) signal is used to reduce its peak-to-average-power ratio (PAPR). The reduction of data throughput owing to DCM is compensated for by squaring the number of lattice points in SCM mappings of the quadrature amplitude modulation (QAM) of the carriers of the COFDM signal. The labeling diversity can be such as to minimize PAPR or such as to reduce PAPR less, but improve signal-to-noise (SNR) for reception of the COFDM signal transmitted via an additive-white-Gaussian-noise (AWGN) channel.

This is a continuation-in-part of U.S. patent application Ser. No. 16/455,699 filed on 27 Jun. 2019, of U.S. patent application Ser. No. 16/736,645 filed on 7 Jan. 2020, and of U.S. patent application Ser. No. 16/900,907 filed on 13 Jun. 2020.

### FIELD OF THE INVENTION

The invention relates to communication systems, such as a digital television (DTV) broadcasting system, that employ dual-carrier modulation (DCM) coded orthogonal frequency-division multiplexed (COFDM) signal. The invention relates more particularly to applying labeling diversity to DCM-COFDM signals employed in such communication systems, which labeling diversity improves transmission and reception of DCM-COFDM signals communicated via a channel afflicted with additive white Gaussian noise (AWGN) or other continuous noise.

### BACKGROUND OF THE INVENTION

Superposition coded modulation (SCM) is important in the quadrature-amplitude-modulation (QAM) of the carriers of preferred formats for DCM-COFDM signals, in which formats QAM is characterized by coded digital data (CDD) being mapped to square QAM symbol constellations. SCM is described in detail by Li Peng, Jun Tong, Xiaojun Yuan and Qinghua Guo in their paper “Superposition Coded Modulation and Iterative Linear MMSE Detection”, IEEE Journal on Selected Areas in Communications, Vol. 27, No. 6, August 2009, pp. 995-1004. In SCM the four quadrants of square QAM symbol constellations are each Gray mapped independently from the others and from the pair of bits in the map label specifying that quadrant. Peng et alli studied iterative linear minimum-mean-square-error (LMMSE) detection being used in the reception of SCM and found that SCM offers an attractive solution for highly complicated transmission environments with severe interference. Peng et alli analyzed the impact of signaling schemes on the performance of iterative LMMSE detection to prove that among all possible signaling methods, SCM maximizes the output signal-to-noise/interference ratio (SNIR) in the LMMSE estimates during iterative detection. The Peng et alli paper describes measurements that were made demonstrating that SCM outperforms other signaling methods when multi-user/multi-antenna/multipath channels have iterative LMMSE detection applied to them.

Jun Tong and Li Peng in a subsequent paper “Performance analysis of superposition coded modulation”, Physical Communication, Vol. 3, September 2010, pp. 147-155, separate superposition coded modulation into two general classes: single-code superposition coded modulation (SC-SCM) and multi-code superposition coded modulation (MC-SCM). In SC-SCM the bits in the superposed code layers are generated using a single encoder. SC-SCM can be viewed as conveying a special sort of bit-interleaved coded modulation (BICM) over successive SCM constellations. In MC-SCM the bits in the superposed code layers are generated using a plurality of encoders supplying respective codewords. MC-SCM can be viewed as conveying special-case multi-level coding (MLC) scheme over successive SCM constellations. (Single carrier modulation is referred to as “SCM” in some texts other than this document, but hereafter in this document the acronym “SCM” will be used exclusively to refer to superposition coded modulation.)

Patent application US-2017/0104553-A1 published 13 Apr. 2017, titled “LDPC Tone Mapping Schemes for Dual-Sub-Carrier Modulation in WLAN”, and filed 11 Oct. 2016 claiming inventorship for Jian-Han Liu, Sheng-Quan Hu, Tian-Yu Wu and Thomas Edward Pare, Jr. describes a species of split-spectrum COFDM modulation signal which utilizes dual carrier modulation (DCM). The DCM modulates the same information on pairs of carriers, which carriers in each pair of them can be separated in frequency to improve frequency diversity in OFDM systems. US-2017/0104553-A1 points out that such separation improves reliability of reception, especially when there are narrow-band interferences (such as occur because of multipath reception, for example). It is important to consider this advantage of DCM, when making an overall comparison comparing DCM-COFDM signals against COFDM signals that employ individual carrier modulation (ICM).

US-2017/0104553-A1 further describes dissimilar respective mappings of first and second sets of square 16QAM symbol constellations transmitted parallelly in time, the primary design goal of this being to reduce the peak-to-average-power ratio (PAPR) of the DCM-COFDM signals significantly. FIGS. 4(a) and 4(b) of the drawings of US-2017/0104553-A1 depict the first and second patterns of labeling uniformly-spaced lattice points in these first and second sets of square 16QAM symbol constellations. These first and second patterns of labeling uniformly-spaced lattice points in first and second sets of square 16QAM symbol constellations correspond to those depicted in FIG. 1(a) of the drawings of patent application US-2008/00212694-A1 published 4 Sep. 2008, titled “Signal Decoding Systems”, and filed 8 May 2007 claiming inventorship for Martin Geoffrey Leach and Peter Anthony Borowski. US-2008/00212694-A1 refers to the DCM-COFDM signal being configured for reduction of its peak-to-average-power ratio (PAPR), but does not prescribe each pair of QAM carriers conveying the same CDD being spaced half-channel-width apart in frequency to improve the reliability of reception when narrow-band interferences occur.

There is a basic guiding principle for reducing the PAPR of DCM-COFDM signaling in which pairs of carriers conveying the same coded digital data (CDD) are modulated in accordance with respective patterns of mapping CDD to square QAM symbol constellations, each of which patterns has a prescribed number of labeled lattice points therein. Namely, the lattice-point labels (LPLs) associated with high peak power in either one of the two patterns of mapping lattice points in QAM symbol constellations are associated with low peak power in the other one of the two patterns of mapping lattice points in QAM symbol constellations. Accordingly the DCM CFDM signal has a strong tendency to have average power constantly. This basic guiding principle is adhered to in the novel labeling diversity for patterns of mapping lattice points in QAM symbol constellations governing DCM, which novel labeling diversity is referred to in the SUMMARY OF THE INVENTION infra.

The labeled lattice points in each of the pair of square 16QAM symbol constellations described in US-2008/0212694-A1 and in US-2017/0104553-A1 are arranged in a respective SCM mapping pattern. Four of the 16 lattice points in any square 16QAM symbol constellation have respective palindromic lattice-point labels, each differing from the three other palindromic LPLs. These four palindromic LPLs are separated into first and second sets of two 4-bit LPLs for further consideration. A first pair of palindromic lattice-point labels (LPLs) are in the outermost corners of two quadrants diagonally opposite from each other in a first of that pair of square 16QAM symbol constellations and are in the innermost corners of the other two quadrants.

Different, other pairs of square 16QAM symbol constellations having labeled lattice points in each of them arranged in a respective SCM mapping pattern are depicted in FIGS. 10 through 15 of patent application US-2019/0334755-A1 published 31 Jan. 2020, titled “COFDM DCM Systems with Preferred Labeling-Diversity Formats” and claiming an original filing date of 27 Jun. 2019 for inventor Allen LeRoy Limberg.

Pairs of square 64QAM symbol constellations having labeled lattice points in each of them arranged in a respective SCM mapping pattern are depicted in FIGS. 34 through 39 of patent application US-2019/0007255-A1 published 1 Jan. 2019, titled “Receivers for COFDM Signals Conveying the Same Data in Lower- and Upper-Frequency Sidebands” and claiming an original filing date of 17 Jul. 2018 for inventor Allen LeRoy Limberg. Eight of the lattice points in any square 64QAM symbol constellation have respective palindromic lattice-point labels, each different from the seven others. These eight palindromic LPLs are separated into first and second sets of four 6-bit LPLs for further consideration. A pair of the 64QAM symbol constellations depicted in two of FIGS. 34 through 39 of patent application US-2019/0007255-A1 exhibit lessened PAPR in a DCM-COFDM signal employing them, providing the following conditions obtain. Respective ones of the first set of four palindromic LPLs label the corners of the four quadrants of one of the SCM-mapped 64QAM symbol constellations, which corners are furthest from constellation center; and those same four palindromic LPLs label the corners of the four quadrants of the other of the SCM-mapped 64QAM symbol constellations, which corners are closest to constellation center. Respective ones of the second set of four palindromic LPLs label the corners of the four quadrants of said one of the SCM-mapped 64QAM symbol constellations, which corners are closest to constellation center; and those same four palindromic LPLs label the corners of the four quadrants of said other of the SCM-mapped 64QAM symbol constellations, which corners are furthest from constellation center.

Another pair of square 64QAM symbol constellations having labeled lattice points in each of them arranged in a respective SCM mapping pattern are depicted in FIGS. 30 and 31 of patent application US-2020/0028725-A1 published 23 Jan. 2020, titled “COFDM DCM Signaling That Employs Labeling Diversity to Minimize PAPR” and claiming an original filing date of 12 Dec. 2018 for inventor Allen LeRoy Limberg. Pairs of palindromic LPLs that are in the corners of two of the quadrants of each one of the SCM-mapped 64QAM symbol constellations, which corners are furthest from constellation center, are in the corners of two of the quadrants of the other one of the SCM-mapped 64QAM symbol constellations, which corners are closest to constellation center.

A shortcoming of utilizing DCM in a communication system using COFDM signals is the inherent tendency of DCM to halve data throughput if there be no compensatory adjustment of the scheme for modulating individual carriers in the DCM-COFDM signals. Simply increasing the number of levels in the quadrature-amplitude-modulation (QAM) of each of the carriers in the COFDM signal poses risk of increasing the bit error ratio (BER) of the coded digital data (CDD) recovered by a receiver of the DCM-COFDM signal. With each quadrupling of the number of uniformly-spaced labeled lattice points in a square QAM symbol constellation of prescribed power level, so as to increase the number of bits in each lattice-point label (LPL) by two, there is an accompanying reduction in the separation between respective modulation levels of adjoining labeled lattice points. Therefore, low-level noise accompanying the DCM-COFDM signal is more likely to cause error in the bits of CDD that a DCM-COFDM signal receiver recovers by demapping QAM symbol constellations.

Another factor adversely affects BER when there is increase in the number of lattice points in the square QAM symbol constellations in the dual mapping employed in generation of the DCM-COFDM signaling. The digital information encoded in the less reliable bits of the LPLs provides a sort of “noise” for the digital information encoded in the more reliable bits of the LPLs, which “noise” may displace the amplitudes of QAM carriers in the DCM-COFDM signal from respective values where more reliable bits of recovered CDD are at their most reliable.

To considerable degree, a DCM-COFDM signal receiver can counter these tendencies toward increased BER as the number of labeled lattice points in QAM symbol constellations is increased. The receiver accomplishes this by maximal ratio combining of corresponding bits in the LPLs of the respective results of QAM demapping dual carriers that convey the same CDD. Yet, there is still an appreciable increase in BER, arising from continuous noise accompanying the DCM-COFDM signal. Generally, this continuous noise is considered in theory to be additive white Gaussian noise (AWGN). In actuality, by way of example, this continuous noise is primarily composed of (a) atmospheric noise arising during passage of COFDM signal through an over-the-air communication channel, (b) thermal noise arising in components of the COFDM signal receiver, and (c) quantization noise arising during analog-to-digital conversions in the receiver.

Maximal ratio combining (MRC) is a method of diversity combining in which (a) the signals from each channel are added together. (b) the gain of each channel is made proportional to the rms signal level and inversely proportional to the mean square noise level in that channel, and (c) different proportionality constants are used for each channel. MRC of carriers amplitude modulated by analog signals was described being done at symbol level by Leonard Kahn in Correspondence titled “Ratio Squarer” appearing in Proceedings of the IRE. Vol. 42, Issue 11, (November 1954). MRC was subsequently performed at QAM symbol level on carriers quadrature amplitude modulated by digital signals. U.S. Pat. No. 7,236,548 titled “Bit level diversity combining for COFDM system” issued 26 Jun. 2007 to Monisha Ghosh, Joseph P. Meehan and Xuemei Ouyang describes diversity combining of digitally modulated carriers being perforned at bit level, rather than at sybol level. Their work was directed to multiple-in/multiple-out (MIMO) reception of COFDM signals from plural-antenna arrays. U.S. Pat. No. 7,236,548 does not indicate labeling diversity having been used in their work. U.S. Pat. No. 7,236,548 reports BER being 2.5 dB lower when diversity combining is performed at bit level, as opposed to performing diversity combining at symbol level.

US-2019/0007255-A1 describes (with reference to FIGS. 64-72, 74, and 77-82 of its drawings) various COFDM signal receivers that use maximal ratio combining of corresponding bits in the LPLs of the respective results of QAM demapping pairs of COFDM carriers, wherein the two carriers in each pair of them convey the same segment of CDD. US-2019/0007255-A1 prescribes labeling diversity for the first and second patterns of labeling uniformly-spaced lattice points in first and second sets of square QAM symbol constellations be provided in the following manner. The bits in the LPLs for the first pattern of mapping QAM symbol constellations, which bits are more likely to be in error owing to accompanying AWGN, correspond to ones of the bits in the LPLs for the second pattern of mapping QAM symbol constellations, which bits are less likely to be in error owing to accompanying AWGN. Furthermore, the bits in the LPLs for the second pattern of mapping QAM symbol constellations. which bits are more likely to be in error owing to accompanying AWGN. correspond to ones of the bits in the LPLs of the first pattern of mapping QAM symbol constellations, which are less likely to be in error owing to accompanying AWGN. This sort of labeling diversity tends to reduce the BER of CDD resulting from maximal ratio combining performed on a bit-by-bit basis.

### SUMMARY OF THE INVENTION

The invention concerns compensating for the DCM-COFDM signal being handicapped by data throughput being halved because each segment of coded digital data (CDD) is conveyed twice, by respective ones of a pair of modulated carriers. This is done in DCM, rather than each segment of coded digital data being conveyed just once, by a single modulated carrier. Compensatory increase in data throughput is provided by increasing to more than sixteen the number of labeled lattice points in square QAM symbol constellations controlling the modulation of carriers conveying CDD. At heart, the invention more particularly concerns novel labeling diversity between lattice-point labels (LPLs) for the two maps of QAM symbol constellations governing DCM. This novel labeling diversity is of such design as not only to keep the peak-to-average-power ratio (PAPR) of the DCM-COFDM signal minimal, but also to keep bit error ratio (BER) low despite the number of labeled lattice points in the square QAM symbol constellations being increased to more than sixteen.

An aspect of the invention is a method for generating DCM-COFDM signaling with that novel labeling diversity between a QAM symbol constellation map governing modulation of the COFDM carriers in the lower half of the frequency spectrum of a communication channel, thus to convey given CDD, and another QAM symbol constellation map governing modulation of the COFDM carriers in the upper half of the frequency spectrum of that communication channel, thus to convey the same given CDD also. Other aspects of the invention concern electronic apparatus configured for combination with DCM-COFDM signaling conveyed by a plurality of quadrature-amplitude-modulated (QAM) electromagnetic carrier waves, which combination is useful in an enabling manner within a communication system for conveying CDD.

By way of example, the electronic apparatus configured for combination with DCM-COFDM signaling is transmitter apparatus designed for transmitting the DCM-COFDM signaling. Particularly, the dual mapping of CDD to QAM carrier waves is designed to exhibit the novel labeling diversity that is characteristic of various aspects of the invention and that keeps the PAPR of the DCM-COFDM signal minimal. The resultant low PAPR of the DCM-COFDM signaling permits the linear radio-frequency power amplifier to be of simpler design, which no longer needs be of Doherty type to avoid excessive standby power consumption.

By way of further example, the electronic apparatus configured for combination with DCM-COFDM signaling is receiver apparatus designed for receiving the DCM-COFDM signaling. The invention is embodied in apparatus for demodulating dual-mapped QAM signals that have lattice-point labeling diversity between them that benefits diversity combining of their soft bits of coded digital data (CDD). First and second QAM symbol demappers in this receiver apparatus demap first and second sets, respectively, of successive square QAM symbols of a prescribed size having more labeled lattice points than 16QAM symbols. There is uniform spacing between those labeled lattice points, which simplifies analog-to-digital conversion procedures in the receiver apparatus. The same coded digital signal is conveyed in both the first and second sets of successive QAM symbols. The respective demapping results from the first and second QAM symbol demappers are maximal ratio combined at bit level to supply CDD to a decoder that recovers the digital data.

In the novel labeling diversity that is characteristic of various aspects of the invention, the bits in the LPLs of the first mapping of QAM symbol constellations that are more likely to be in error owing to accompanying AWGN correspond to the bits in the LPLs of the second mapping of QAM symbol constellations that are less likely to be in error owing to accompanying AWGN. Furthermore, the bits in the LPLs of the second mapping of QAM symbol constellations that are more likely to be in error owing to accompanying AWGN correspond to the bits in the LPLs of the first mapping of QAM symbol constellations that are less likely to be in error owing to accompanying AWGN. This substantially benefits the maximal ratio combining of the respective demapping results from the first and second QAM symbol demappers at bit level to supply CDD to a decoder that recovers the digital data, whenever the DCM-COFDM signal is accompanied by low-level noise extending over the entire frequency spectrum of the communication channel. This is because there is increased possibility that one of each pair of corresponding bits of the LPLs recovered by QAM demappers in the DCM-COFDM signal receiver will have lower likelihood of being in error owing to low-level noise.

### BRIEF DESCRIPTION OF THE DRAWINGS

FIG. 1 is a flow chart illustrative of the general method for generating DCM-COFDM signaling in accordance with the invention.

FIG. 2 is a flow chart illustrative of a preferred method to recover digital data from DCM-COFDM signal.

FIGS. 3, 4 and 5 together form a schematic diagram of transmitter apparatus for DCM-COFDM signal.

FIG. 6 is a detailed schematic diagram of any of a number of cascade connections as can be used in respective physical layer pipes of the FIG. 4 portion of the transmitter apparatus for DCM-COFDM signal, each of which cascade connections comprises a parallel pair of mappers to QAM symbol constellations and a subsequent frequency interleaver.

FIG. 7 is an illustration of the preferred response of the frequency interleaver depicted in FIG. 6.

FIGS. 8 and 9 depict first and second SCM maps of square 64QAM symbol constellations, respectively, the correspondingly positioned labels of which mirror each other in their orders of bits.

FIG. 10 is a third SCM map of square 64QAM symbol constellations modifying the FIG. 8 first SCM map of 64QAM symbol constellations by (a) exchanging the positions of −I,+Q and +I,−Q quadrants going from the FIG. 8 map to the FIG. 10 map and (b) exchanging the positions of +I, +Q and −I,−Q quadrants going from the FIG. 8 map to the FIG. 10 map.

FIG. 11 is a fourth SCM map of 64QAM symbol constellations modifying the FIG. 10 third SCM map of 64QAM symbol constellations by diagonally twisting the pattern of map labels in each quadrant.

FIG. 12 is a fifth SCM map of square 64QAM symbol constellations modifying the FIG. 9 second SCM map of 64QAM symbol constellations by (a) exchanging the positions of −I,+Q and +I,−Q quadrants going from the FIG. 9 map to the FIG. 12 map and (b) exchanging the positions of +I,+Q and −I,−Q quadrants going from the FIG. 9 map to the FIG. 12 map.

FIG. 13 is a sixth SCM map of 64QAM symbol constellations modifying the FIG. 12 fifth SCM map of 64QAM symbol constellations by diagonally twisting the pattern of map labels in each quadrant.

FIGS. 14, 15, 16, 17, 18 and 19 present decimal labeling for the SCM maps of 64QAM symbol constellations depicted in FIGS. 8, 9, 10, 11, 12 and 13 respectively.

FIGS. 20 and 21 are seventh and eighth SCM maps of 64QAM symbol constellations, respectively, which maps have preferred labeling diversity from each other.

FIGS. 22 and 23 present decimal labeling for the seventh and eighth SCM maps of 64QAM symbol constellations, respectively.

FIGS. 24 and 25 are ninth and tenth SCM maps of 64QAM symbol constellations, respectively, which maps have preferred labeling diversity from each other.

FIGS. 26 and 27 present decimal labeling for the ninth and tenth SCM maps of 64QAM symbol constellations, respectively.

FIGS. 28 and 29 are eleventh and twelfth SCM maps of 64QAM symbol constellations, respectively, which maps have preferred labeling diversity from each other.

FIGS. 30 and 31 present respective decimal labelings for the eleventh and twelfth SCM maps of 64QAM symbol constellations, respectively.

FIGS. 32 and 33 are thirteenth and fourteenth SCM maps of 64QAM symbol constellations, respectively, which maps have preferred labeling diversity from each other.

FIGS. 34 and 35 present decimal labelings for the thirteenth and fourteenth SCM maps of 64QAM symbol constellations, respectively

FIG. 36 depicts the central portion of a first SCM map of square 256QAM symbol constellations.

FIG. 37 depicts the central portion of a second SCM map of square 256QAM symbol constellations.

FIGS. 38, 39, 40 and 41 depict respective quadrants of the first SCM map of square 256QAM symbol constellations.

FIGS. 42, 43, 44 and 45 depict respective quadrants of the second SCM map of square 256QAM symbol constellations.

FIGS. 46, 47, 48 and 49 depict respective quadrants of a third SCM map of square 256QAM symbol constellations having a preferred labeling diversity from the first SCM map of square 256QAM symbol constellations.

FIGS. 50, 51, 52 and 53 depict respective quadrants of a fourth SCM map of square 256QAM symbol constellations having a preferred labeling diversity from the first SCM map of square 256QAM symbol constellations.

FIGS. 54, 55, 56 and 57 depict respective quadrants of a fifth SCM map of square 256QAM symbol constellations having a preferred labeling diversity from the second SCM map of square 256QAM symbol constellations.

FIGS. 58, 59, 60 and 61 depict respective quadrants of a sixth SCM map of square 256QAM symbol constellations having a preferred labeling diversity from the second SCM map of square 256QAM symbol constellations.

FIG. 62 presents decimal labeling for the first SCM map of 256QAM symbol constellations depicted in FIGS. 38, 39, 40 and 41.

FIG. 63 presents decimal labeling for the second SCM map of 256QAM symbol constellations depicted in FIGS. 42, 43, 44 and 45.

FIG. 64 presents decimal labeling for the third SCM map of 256QAM symbol constellations depicted in FIGS. 46, 47, 48 and 49.

FIG. 65 presents decimal labeling for the fourth SCM map of 256QAM symbol constellations depicted in FIGS. 50, 51, 52 and 53.

FIG. 66 presents decimal labeling for the fifth SCM map of 256QAM symbol constellations depicted in FIGS. 54, 55, 56 and 57.

FIG. 67 presents decimal labeling for the sixth SCM map of 256QAM symbol constellations depicted in FIGS. 58, 59, 60 and 61.

FIGS. 68 and 69 present respective decimal labeling for seventh and eighth SCM maps of 256QAM symbol constellations, which labelings have preferred labeling diversity from each other.

FIGS. 70 and 71 present respective decimal labeling for ninth and tenth SCM maps of 256QAM symbol constellations, which labelings have preferred labeling diversity from each other.

FIGS. 72 and 73 present respective decimal labeling for eleventh and twelfth SCM maps of 256QAM symbol constellations, which labelings have preferred labeling diversity from each other.

FIGS. 74 and 75 present respective decimal labeling for thirteenth and fourteenth SCM maps of 256QAM symbol constellations, which labelings have preferred labeling diversity from each other.

FIG. 76 depicts the central portion of a first SCM map of square 256QAM symbol constellations alternative to the FIG. 36 first SCM map of square 256QAM symbol constellations.

FIG. 77 depicts the central portion of a second SCM map of square 256QAM symbol constellations alternative to the FIG. 37 second SCM map of square 256QAM symbol constellations.

FIG. 78 lists the palindromic map labels in diagonals of the −I,+Q quadrants of first and second SCM maps of 16QAM, 64QAM, 256QAM, 1024QAM and 4096QAM.

FIG. 79 lists the palindromic map labels in diagonals of the +I,+Q quadrants of first and second SCM maps of 16QAM, 64QAM, 256QAM, 1024QAM and 4096QAM.

FIG. 80 lists the palindromic map labels in diagonals of the +I,−Q quadrants of first and second SCM maps of 16QAM, 64QAM, 256QAM, 1024QAM and 4096QAM.

FIG. 81 lists the palindromic map labels in diagonals of the −I,−Q quadrants of first and second SCM maps of 16QAM, 64QAM, 256QAM, 1024QAM and 4096QAM.

FIGS. 82 and 83 together form a schematic diagram of the general structure of single-sideband receiver apparatus adapted for receiving DCM-COFDM signals.

FIG. 84 is a detailed schematic diagram of modifications made to the receiver apparatus shown in FIG. 83 to arrange for performing soft-demapping and soft-decoding procedures iteratively in accordance with the “turbo” principle.

FIG. 85 is a schematic diagram of a diversity combiner that can be used for combining the results of dual QAM demapping in either of the configurations depicted in FIGS. 83 and 84, which diversity combiner comprises a maximal-ratio combiner of corresponding soft bits of respective similar labels of each successive pair of QAM symbols from dual QAM-symbol demapping procedures, which maximal-ratio combiner is operative on soft bits at bit level, rather than at symbol level.

FIG. 86 is a schematic diagram of a diversity combiner that can be used for combining the results of dual QAM demapping either of the configurations depicted in FIGS. 83 and 8495, which diversity combiner comprises a maximal-ratio combiner operative on soft bits at bit level, rather than at symbol level, the demapping results of the dual QAM demappers being adjusted prior to application to the maximal-ratio combiner thus to implement a degree of selective diversity combining.

FIG. 87 is a schematic diagram of a variant of the FIG. 82 receiver structure.

FIG. 88 is a schematic diagram of COFDM transmitter apparatus that is configured for transmitting DCM-COFDM signals using independent-sideband (ISB) amplitude modulation of a center-channel principal carrier frequency.

FIGS. 89 and 83 together form a schematic diagram of the general structure of receiver apparatus for DCM-COFDM signals using respective phase-shift methods to respond separately to the concurrent lower-frequency and upper-frequency subbands of those signals.

FIG. 90 is a schematic diagram of a two-phase divide-by-four frequency divider constructed from gated D flip-flops or data latches, which sort of frequency divider is an element in the receiver apparatus depicted in FIGS. 82, 85, 86, 87, 89 and 90.

FIG. 91 is a schematic diagram of double superheterodyne front-end tuner structure suitable for inclusion in any of the apparatuses for demodulating DCM-COFDM signals depicted in FIGS. 89, 92, 93 and 83.

FIGS. 92 and 83 together form a schematic diagram of a variant of the receiver apparatus for demodulation of DCM-COFDM signal that is depicted in FIGS. 89 and 83, digital circuitry depicted in FIG. 92 replacing some of the analog circuitry depicted in FIG. 89.

FIGS. 93 and 83 together form a schematic diagram of the general structure of receiver apparatus for demodulation of DCM-COFDM signals using phase-shift methods modified in a first manner.

FIGS. 94 and 83 together form a schematic diagram of a variant of the receiver apparatus for demodulation of DCM-COFDM signals depicted in FIGS. 93 and 83, digital circuitry depicted in FIG. 94 replacing some of the analog circuitry depicted in FIG. 93.

FIG. 95 is a schematic diagram of a modification suitable both for the FIG. 93 receiver structure and for the FIG. 94 receiver structure.

FIGS. 96 and 83 together form a schematic diagram of the general structure of receiver apparatus to process DCM-COFDM signals using Weaver methods.

FIGS. 97 and 83 together form a schematic diagram of receiver apparatus for demodulation of DCM-COFDM signals using modified phase-shift methods to respond separately to the concurrent lower-frequency and upper-frequency subbands of those signals after discrete Fourier transforms of those subbands are computed.

FIG. 98 is a schematic diagram of a double superheterodyne front-end tuner structure suitable for inclusion in each of the apparatuses for demodulating DCM-COFDM signals depicted in FIGS. 96 and 97.

### DETAILED DESCRIPTION

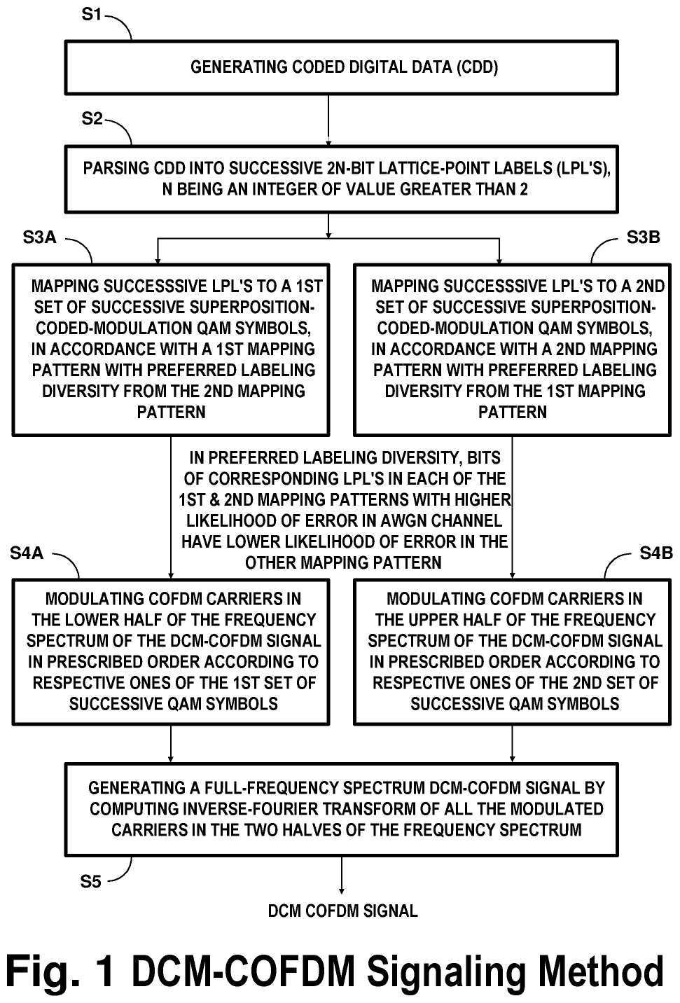

The FIG. 1 flow chart illustrates the general method for generating DCM-COFDM signaling in accordance with the invention. Coded digital data (CDD) is generated in an initial step S1 of that method. The coding of digital data in step S1 customarily employs a forward-error-correction (FEC) code. In the second step S2 of the general method illustrated in FIG. 1, the CDD is parsed into successive 2N-bit lattice-point labels (LPLs), N being an integer of value greater than two. Mapping the successive LPLs to QAM symbol constellations is carried out by parallel steps S3A and S3B of the general method illustrated in FIG. 1.

In accordance with a first mapping pattern, the successive LPLs are mapped to a first set of successive superposition-coded-modulation (SCM) quadrature-amplitude-modulation (QAM) symbols in step S3A. In accordance with a second mapping pattern, the successive LPLs are mapped to a second set of successive SCM QAM symbols in step S3B. Preferably, the SCM QAM symbols are defined by square QAM symbol constellations having uniform spacing between adjacent labeled lattice points. There is labeling diversity between the first and second patterns of mapping LPLs to both the first and the second sets of successive SCM QAM symbols. In preferred labeling diversity bits of corresponding LPLs in each of these first and second mapping patterns, which bits have higher likelihood of error in reception of DCM-COFDM signal owing to accompanying AWGN DM signal have lower likelihood of error in the other of these first and second mapping patterns.

Modulating the carriers of the DCM-COFDM signal according to the QAM symbol constellations is carried out by parallel steps S4A and S4B of the general method illustrated in FIG. 1. In step S4A COFDM carriers in the lower half of the frequency spectrum of the communication channel for the DCM-COFDM signal are modulated in prescribed order according to respective ones of the first set of successive QAM symbols supplied by the mapping step S3A. In step S4B COFDM carriers in the upper half of the frequency spectrum of the communication channel for the DCM-COFDM signal are modulated in prescribed order according to respective ones of the second set of successive QAM symbols supplied by the mapping step S3B. Step 5 for generating a full-frequency-spectrum DCM-COFDM signal computes the inverse-Fourier transform of all the COFDM carriers supplied by steps 4A and 4B of modulating carriers.

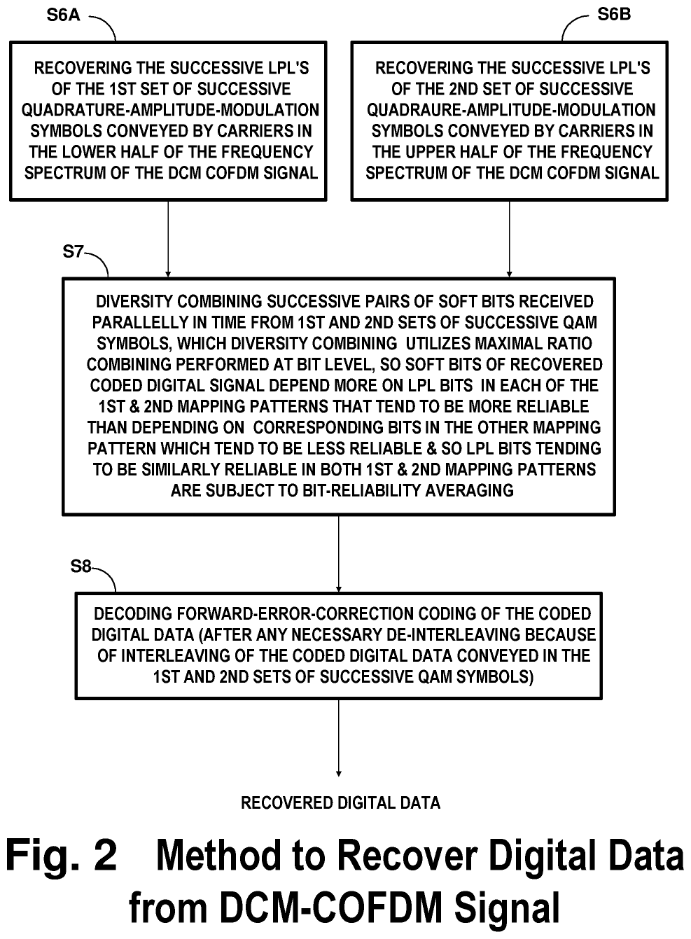

The FIG. 2 flow chart illustrates the general method for demodulating dual-mapped QAM signals having lattice-point labeling diversity between them, as used in apparatus embodying the invention. First and second sets of successive QAM symbols are supplied in initial parallel steps S6A and S6B of this method. These first and second sets of successive QAM symbols both convey the same coded digital data parallelly in time, but with labeling diversity between their QAM symbols that convey corresponding segments of that same coded digital.

The first set of successive QAM symbols supplied in step S6A map successive segments of coded digital data, each having a given number of bits, to square QAM symbol constellations. This mapping is done in accordance with a first pattern of labeling lattice points in these square QAM symbol constellations. In this first pattern, successive bits of each lattice point label (as considered in a prescribed sequential order) are progressively more likely to be in error because of the first set of successive QAM symbols being accompanied by additive white Gaussian noise (AWGN).

The second set of successive QAM symbols supplied in step S6B map successive segments of coded digital data, each having a given number of bits, to square QAM symbol constellations. This mapping is done in accordance with a second pattern of labeling lattice points in these square QAM symbol constellations. In this second pattern successive bits of each lattice point label (as considered in said prescribed sequential order) are progressively less likely to be in error because of the second set of successive QAM symbols being accompanied by AWGN.

In the FIG. 2 flow chart the initial steps S6A and S6B of the general method for demodulating dual-mapped QAM signals are followed by a step S7 of diversity combining successive pairs of soft bits of the coded digital data received parallelly in time, as supplied by those initial steps S6A and S6B. The step S7 of diversity combining utilizes a bit-reliability-averaging (BRA) technique to recover coded digital data (CDD), the bits of which have average likelihood of being in error caused by AWGN.

In the FIG. 2 flow chart the step S7 of diversity combining successive pairs of soft bits of the coded digital data received parallelly in time is followed by a step S8 of decoding the forward-error correction (FEC) coding of the CDD, thus generating recovered digital data. Such decoding is performed after any interim step of de-interleaving the coded digital data necessitated because of interleaving of the CDD conveyed in the first and second sets of successive QAM symbols supplied in the initial steps S6A and S6B of the general method for demodulating ual-mapped QAM signals shown in the FIG. 2 flow chart.

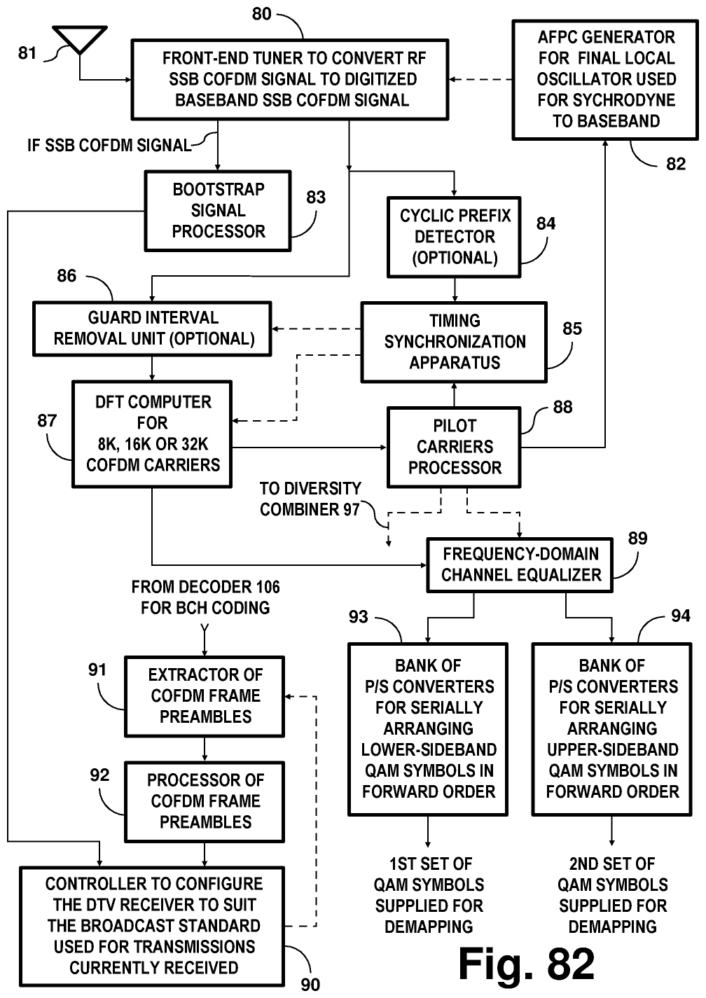

Bit-reliability-averaging in the step S7 of diversity combining avoids the step S8 of decoding the forward-error correction coding of the CDD being presented with bits with low reliability of being correct when there is accompanying AWGN. This increases the capability of the decoding of FEC coding to recover correct digital data at higher levels of accompanying AWGN. This increased capability is more pronounced as QAM symbol size is made larger. The advantages of the general method for demodulating dual-mapped QAM signals illustrated in the FIG. 2 flow chart are exploited in DCM-COFDM signal receiver apparatuses as shown in FIGS. 82-87, 89 and 92-97.

The data throughput for a COFDM signal using dual-carrier modulation (DCM) of its carriers is half the data throughput for a COFDM signal the carriers of which are modulated individually, presuming the carriers in both signals are all quadrature amplitude modulated in accordance with the same-size square QAM symbol constellations. The data throughput of DCM-COFDM signal can be doubled by squaring the number of labeled lattice points in the square QAM symbol constellations that describe the modulation of the carriers of the DCM-COFDM signal used to convey data. This is because squaring the number of labeled lattice points in a square QAM symbol constellation doubles the number of bits in each lattice-point label (LPL). However, increasing the even number of bits in the LPLs of square QAM symbol constellations increases bit error rate (BER) of coded data recovered during reception of a COFDM signal over an additive-white-Gaussian-noise (AWGN) channel. This increase in BER is problematic, especially at lower received signal strengths.

Each quadrupling of the number of lattice points in the square QAM symbol constellations halves the amplitude of AWGN that will be of a threshold value small enough not to cause error in any bit of the lattice-point labeling of the QAM symbol constellations recovered by a DCM-COFDM signal receiver. As the amplitude of AWGN increases more and more above that threshold value, increasingly more of the bits in the lattice-point labels of QAM symbols will be susceptible of error.

The bit of a particular bit position in the lattice-point label of a square QAM symbol constellation is more likely to be in error when the location of the lattice point approaches the boundary of the bin for the value of that bit position with the bin for the other value of that bit position. The bit of a particular position in the lattice-point label of a square QAM symbol constellation is least likely to be in error when the location of the lattice point is in an outside edge of the QAM symbol constellation which includes the boundary of the bin for the value of that bit position.

If the bin for the value of a particular bit position in the lattice-point label of a square QAM symbol constellation does not have a boundary for such value that is in an outside edge of the QAM symbol constellation, the likelihood of a bit in that position in the lattice-point label being correct will be greatest when a component of carrier amplitude modulation terminates nearest the center of that bin. (The component of carrier amplitude modulation defined by a bit will usually not be at exact center of the bin it defines, owing to the offset introduced by bits defining bins smaller than its own bin.) The likelihood of a bit in a position in the lattice-point label being correct when a component of carrier amplitude modulation terminates nearest the center of a bin for that bit position is directly proportional to the distance to the edge of such bin.

Increasing the even number of bits in the LPLs of SCM-mapped square QAM symbol constellations to more than four increases BER of coded data recovered during reception of a DCM-COFDM signal over an AWGN channel. As pointed out supra, increased BER is especially problematic at lower received signal strengths. In regard to the bits if LPLs associated with bins of smaller size, the increase in BER associated with those bits despite AWGN being quite low in power is attributable to the AWGN moving the amplitude of the carrier out of the bin associated with the correct value for that LPL bit when correct and into an adjoining bin associated with the opposite (and incorrect) value of that LPL bit.

A DCM-COFDM signal receiver using the FIG. 2 method is configured to supply first and second sets of successive QAM symbols, each mapping successive segments of coded digital data that have a given number of bits to square symbol constellations. These first and second sets of successive QAM symbols convey the same coded digital data in a dual mapping wherein concurrent QAM symbols convey similar segments of that coded digital data. The concurrent QAM symbols have labeling diversity between them. With regard to bit errors caused by accompanying AWGN, the successive bits of lattice-point labels for the square symbol constellations of the first set of successive QAM symbols, as read in a prescribed order, have likelihoods to be in error that are complementary to the likelihoods to be in error of the successive bits of lattice-point labels for the square symbol constellations of the second set of successive QAM symbols, when read in the same prescribed order. That is, with regard to a pair of corresponding bits in the two sets of QAM symbols, the more likely one of those bits is to be in error because of accompanying noise of given level, the less likely the other of those bits is to be in error because of accompanying noise of the same given level,

The concurrent QAM symbols in each successive pair of them are subjected to a step S7 of diversity combining that utilizes maximal ratio combining (MRC) at bit level. Customarily, a “soft” bit of CDD is expressed as a “hard” bit accompanied by bits expressing a logarithmic likelihood ratio (LLR) of the hard bit being correct. When one of the corresponding soft bits of the LPLs of these concurrent QAM symbols is less likely to be in error than the other, the soft bits of coded digital data (CDD) generated by this MRC depend more heavily on this bit than on the other bit more likely to be in error. The LLR of a soft bit resulting from MRC at bit level is adjusted downward or upward from that of the more-reliable soft bit input that would be chosen in straightforward selective combining.

If the hard-bit portions of the corresponding bits differ, there is some downward adjustment of that LLR, the LLR of the less reliable bit being differentially combined with the LLR of the more reliable bit. If the LLRs being differentially combined are close in value, the LLR of the soft bit resulting from MRC at bit level being correct is very low. Knowledge of this bit almost certainly being in error may benefit the step S8 of decoding FEC coding of the CDD. If CDD decoding involves repeated trial-and-error attempts to determine correct digital data, decoding attempts which assume the bit may be correct can be eschewed.

If the hard-bit portions of the corresponding bits are both ONE or both ZERO, there is some upward adjustment of the LLR of a soft bit resulting from MRC at bit level, the LLR of the less reliable bit being additively combined with the LRR of the more reliable bit. If the LLRs being additively combined are close in value, the LLR of the soft bit resulting from MRC bit level is essentially doubled, reducing the BER of its hard bit by 6 dB (or perhaps 2.5 dB more, as suggested by U.S. Pat. No. 7,236,548).

The coding of digital data supplied by the diversity-combining step S7 to the decoding step S8 entails, at least in part, some sort of forward-error-correction (FEC) coding. At the time this document is filed for patenting, concatenated BCH/LDPC coding composed of Bose-Chaudhuri-Hocquenghem (BCH) outer block-coding and low-density parity-check (LDPC) inner block-coding is favored for digital television broadcasting. Typically, the coded digital signal resulting from diversity combining has bit interleaving and/or time interleaving, so is appropriately de-interleaved to generate the signal offered for step S8 decoding to recover the original digital data supplied to the DCM-COFDM signal transmitter apparatus.

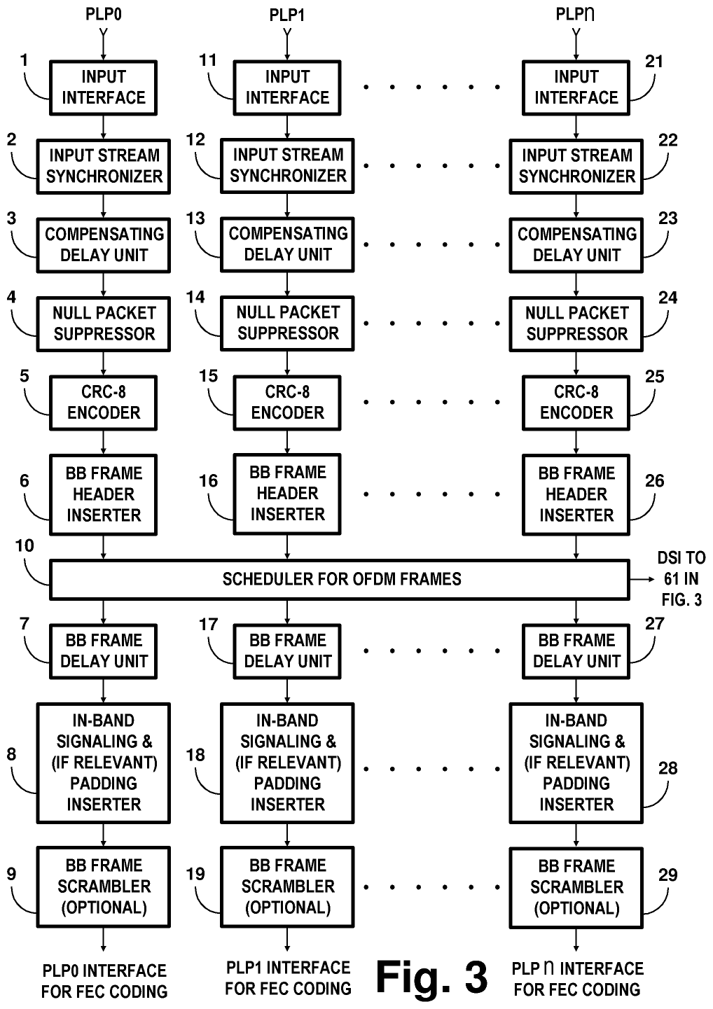

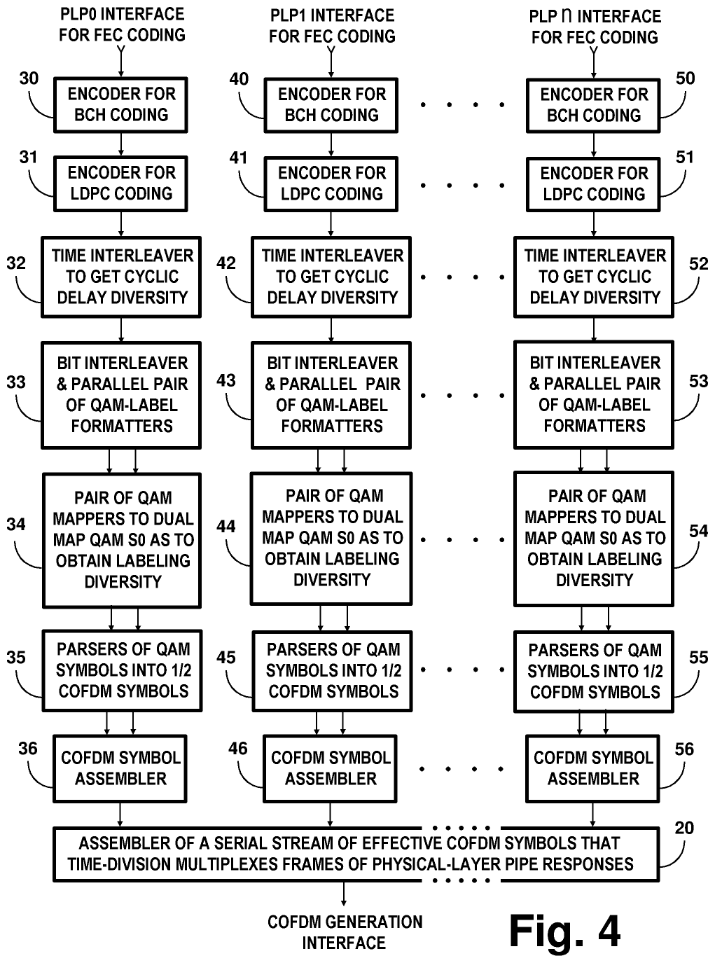

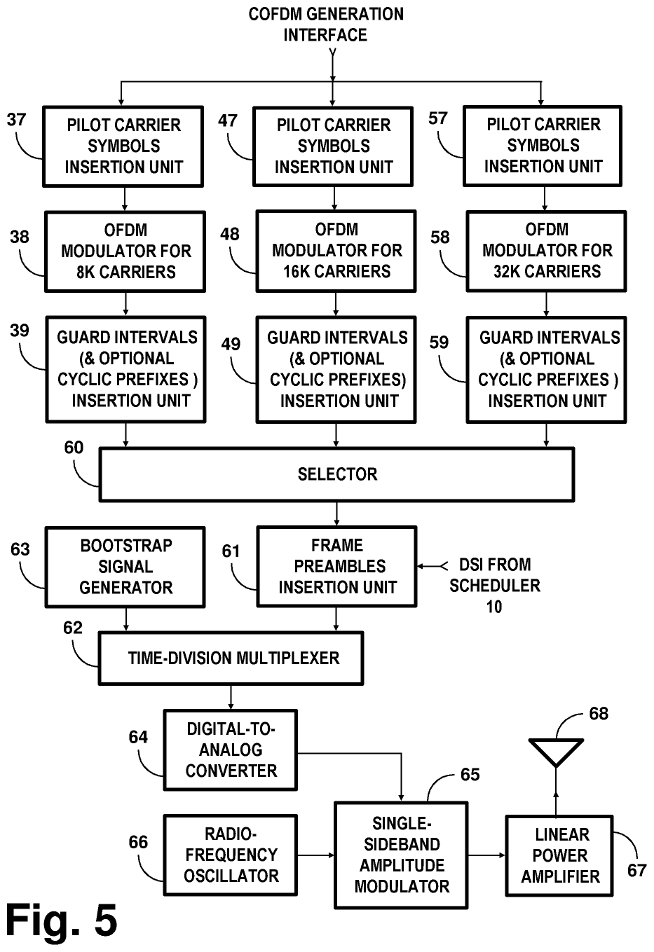

Together, FIGS. 3, 4 and 5 depict in considerable detail a DTV transmitter apparatus generating DCM-COFDM signals designed for reception by DTV receivers. FIG. 3 depicts apparatus for generating baseband frames (BBFRAMES) at physical-layer-pipe (PLP) interfaces. FIG. 4 depicts apparatus for generating bit-wise forward-error-correction (FEC) coding and subsequent COFDM symbol blocks responsive to the BBFRAMEs supplied at the PLP interfaces. FIG. 5 depicts apparatus for generating and transmitting radio-frequency COFDM signals. Much of the DTV transmitter apparatus depicted in FIGS. 3, 4 and 5 is similar to that specified in European Telecommunications Standards Institute (ETSI) standard EN 302 755 V1.3.1 published in April 2012, titled “Digital Video Broadcasting (DVB); Frame structure channel coding and modulation for a second-generation digital terrestrial television broadcasting system (DVB-T2)”, and incorporated herein by reference.

A scheduler 10 for interleaving time-slices of services to be broadcast to stationary DTV receivers is depicted in the middle of FIG. 3. The scheduler 10 schedules transmissions of time slices for a number (n+1) of physical layer pipes (PLPs), n being a positive integer at least zero. FIGS. 3 and 4 identify these PLPs by the letters “PLP” followed respectively by consecutive positive integers of a modulo-(n+1) numbering system. The scheduler 10 also generates and schedules dynamic scheduling information (DSI) for application to an additional PLP depicted in FIG. 5, which additional PLP generates OFDM symbol blocks that convey the DSI and first layer conformation specifications in respective pilot symbols P1 and P2 in preambles of OFDM frames. Recommended practice is that at least the physical layer pipe PLP0 is a so-called “common” PLP used for transmitting data, such as a program guide, relating to the other “data” PLPs. At least one common PLP is transmitted in each OFDM frame following the P1 and P2 symbols, but before the data PLP or PLPs. A data PLP may be of a first type transmitted as a single slice per OFDM frame, or a data PLP may be of a second type transmitted as a plurality of sub-slices disposed in non-contiguous portions of each OFDM frame to achieve greater time diversity.

FIG. 3 depicts the (n+1)th physical layer pipe PLP0 comprising elements 1-6 in cascade connection before the scheduler 10 and further comprising elements 7-9 in cascade connection after the scheduler 10, but before a PLP0 interface for forward-error-correction (FEC) coding. More specifically, FIG. 3 indicates that a PLP0 stream of logical digital data is supplied to the input port of an input interface 1, the output port of which connects to the input port of an input stream synchronizer 2. The output port of the input stream synchronizer 2 connects to the input port of a compensating delay unit 3, the output port of which connects to the input port of a null-packet suppressor 4. The output port of the null-packet suppressor 4 connects to the input port of a CRC-8 encoder 5 operative at user packet level, the output port of which connects to the input port of an inserter 6 of headers for baseband (BB) frames. The output port of the BBFRAME header inserter 6 connects to a respective input port of the scheduler 10. The physical layer pipe PLP0 continues following the scheduler 10, with FIG. 3 showing a respective output port of the scheduler 10 connecting to the input port of a delay unit 7 for delaying baseband (BB) frames. FIG. 3 shows the output port of the BBFRAME delay unit 7 connecting to the input port of an inserter 8 for inserting in-band signaling into BBFRAMEs, which in-band signaling essentially consists of dynamic scheduling information (DSI) generated by the scheduler 10, and/or for inserting padding into the BBFRAME. Padding is inserted in circumstances when the user data available for transmission is insufficient to fill a BBFRAME completely, or when an integer number of user packets is required to be allocated to a BBFRAME. FIG. 3 shows the output port of the inserter 8 connecting to the input port of a BBFRAME scrambler 9, which data randomizes bits of the BBFRAME supplied from the output port of the BBFRAME scrambler 9 as the PLP0 interface for FEC coding. In practice the delay unit 7, the inserter 8 and the BBFRAME scrambler 9 are realized by suitable configuration of a multi-port random-access memory.

FIG. 3 depicts the first physical layer pipe PLP1 comprising elements 11-16 in cascade connection before the scheduler 10 and further comprising elements 17-19 in cascade connection after the scheduler 10, but before a PLP1 interface for forward-error-correction (FEC) coding. More specifically, FIG. 3 indicates that a PLP1 stream of logical digital data is supplied to the input port of an input interface 11, the output port of which connects to the input port of an input stream synchronizer 12. The output port of the input stream synchronizer 12 connects to the input port of a compensating delay unit 13, the output port of which connects to the input port of a null-packet suppressor 14. The output port of the null-packet suppressor 14 connects to the input port of a CRC-8 encoder 15 operative at user packet level, the output port of which connects to the input port of an inserter 16 of headers for BBFRAMEs. The output port of the BBFRAME header inserter 16 connects to a respective input port of the scheduler 10. The physical layer pipe PLP1 continues following the scheduler 10, with FIG. 3 showing a respective output port of the scheduler 10 connecting to the input port of a delay unit 17 for delaying BBFRAMEs. FIG. 3 shows the output port of the BBFRAME delay unit 17 connecting to the input port of an inserter 18 for inserting in-band signaling into BBFRAMEs, which in-band signaling essentially consists of DSI generated by the scheduler 10, and/or for inserting padding into the BBFRAME. FIG. 3 shows the output port of the inserter 18 connecting to the input port of a BBFRAME scrambler 19, which data-randomizes bits of the BBFRAME supplied from the output port of the BBFRAME scrambler 19 as the PLP1 interface for FEC coding. In practice the delay unit 17, the inserter 18 and the BBFRAME scrambler 19 are realized by suitable operation of a multi-port random-access memory.

FIG. 3 depicts the (n)th physical layer pipe PLPn comprising elements 21-26 in cascade connection before the scheduler 10 and further comprising elements 27-29 in cascade connection after the scheduler 10, but before a PLPn interface for forward-error-correction (FEC) coding. More specifically, FIG. 3 indicates that a PLPn stream of logical digital data is supplied to the input port of an input interface 21, the output port of which connects to the input port of an input stream synchronizer 22. The output port of the input stream synchronizer 22 connects to the input port of a compensating delay unit 23, the output port of which connects to the input port of a null-packet suppressor 24. The output port of the null-packet suppressor 24 connects to the input port of a CRC-8 encoder 25 operative at user packet level, the output port of which connects to the input port of an inserter 26 of headers for BBFRAMEs. The output port of the BBFRAME header inserter 26 connects to a respective input port of the scheduler 10. The physical layer pipe PLPn continues following the scheduler 10, with FIG. 3 showing a respective output port of the scheduler 10 connecting to the input port of a delay unit 27 for delaying BBFRAMEs. FIG. 3 shows the output port of the BBFRAME delay unit 27 connecting to the input port of an inserter 28 for inserting in-band signaling into BBFRAMEs, which in-band signaling essentially consists of dynamic scheduling information (DSI) generated by the scheduler 10, and/or for inserting padding into the BBFRAME. FIG. 3 shows the output port of the inserter 28 connecting to the input port of a BBFRAME scrambler 29, which data randomizes bits of the BBFRAME supplied from the output port of the BBFRAME scrambler 29 as the PLPn interface for FEC coding. In practice the delay unit 27, the inserter 28 and the BBFRAME scrambler 29 are apt to be realized by appropriate operation of a multi-port random-access memory.

The input stream synchronizers 2, 12, 22 etc. are operable to guarantee Constant Bit Rate (CBR) and constant end-to-end transmission delay for any input data format when there is more than one input data format. Some transmitters may omit ones of the input stream synchronizers 2, 12, 22 etc. or ones of the compensating delay units 3, 13, 23 etc. For some Transport-Stream (TS) input signals, a large percentage of null-packets may be present in order to accommodate various bit-rate services in a constant bit-rate TS. In such case, to avoid unnecessary transmission overhead, the null-packet suppressors 4, 14, 24 etc. identify TS null-packets from the packet-identification (PID) sequences in their packet headers and remove those TS null-packets from the data streams to be scrambled by the BBFRAME scramblers 9, 19, 29 etc. This removal is done in a way such that the removed null-packets can be re-inserted in the receiver in the exact positions they originally were in, thus guaranteeing constant bit-rate and avoiding the need for updating the Program Clock Reference (PCR) or time-stamp. Further details of the operation of the input stream synchronizers 2, 12, 22 etc.; the compensating delay units 3, 13, 23 etc.; and the null-packet suppressors 4, 14, 24 etc. can be gleaned from ETSI standard EN 302 755 V1.3.1 for DVB-T2.

FIG. 4 specifically indicates FEC coding to be concatenated BCH/LDPC coding composed of Bose-Chaudhuri-Hocquenghem (BCH) outer block coding and low-density parity-check (LDPC) inner block coding, which FEC coding is currently favored in the DVB-T2 broadcasting art. Alternatively, the FEC coding can take any one of a variety of other forms, including concatenated Reed-Solomon (RS) outer coding and turbo inner coding e.g., as specified by the earlier DVB-T broadcast standard.

FIG. 4 depicts the (n+1)th physical layer pipe PLP0 further comprising elements 30-38 in cascade connection after the PLP0 interface for FEC coding, but before a respective input port of an assembler 20 for assembling a serial stream of effective COFDM symbols. More specifically, FIG. 4 depicts an encoder 30 for BCH coding with its input port connected to receive the PLP FEC-coding interface signal from the output port of the BBFRAME scrambler 9 and with its output port connected to the input port of an encoder 31 for LDPC coding. The output port of the encoder 31 connects to the input port of a bit interleaver and QAM-label formatter 32. FIG. 4 depicts the output port of the bit interleaver and QAM-label formatter 32 connected to the input port of a time interleaver 33 for successive QAM labels. The time interleaver 33 shuffles the order of the QAM symbols in each successive FEC block. This shuffling implements cyclic delay diversity (CDD) that helps the FEC coding to overcome fading. The output port of the QAM-label time interleaver 33 connects to the respective input ports of a pair 34 of QAM mappers for dual mapping successive QAM labels to the complex coordinates of respective successions of QAM symbol constellations. The two QAM mappers in the pair 34 of them map same coded data to QAM of their respective OFDM carriers according to respective patterns that differ from each other, thereby to implement labeling diversity.

Conventional practice for over-the-air broadcasting of COFDM television signals without DCM has been to use 16QAM or 64QAM symbol constellations to facilitate reception by mobile DTV receivers and by DTV receivers with indoor antennas. When DCM with labeling diversity is employed 256QAM symbol constellations have to be broadcast to achieve data throughput similar to that when 16QAM symbol constellations is used in COFDM signals without DCM. When DCM with labeling diversity is employed 4096QAM symbol constellations have to be broadcast to achieve data throughput similar to that when 64QAM symbol constellations is used in COFDM signals without DCM.

The respective output ports of the pair 34 of QAM mappers are connected for supplying first and second sets of successive QAM symbol constellations to respective input ports of parsers 35 of the first and second sets of successive of QAM symbols into respective successions of half COFDM symbols. These successions of half COFDM symbols are supplied to first and second input ports of a COFDM symbol assembler 36, which responds to their half COFDM symbols alternately to generate complete COFDM symbols. The output port of the COFDM symbol assembler 36 is connected to a respective input port of the assembler 20 of a serial stream of effective COFDM symbols, in which frames of PLP responses from the various physical layer pipes are time-division multiplexed. Together, the parsers 35 and the COFDM symbol assembler 36 combine to provide a COFDM symbol generator for arranging successive ones of the first set of QAM symbols in first prescribed order in initial halves of successive COFDM symbols and arranging successive ones of the second set of QAM symbols in second prescribed order in final halves of successive COFDM symbols.

FIG. 4 depicts the first physical layer pipe PLP1 further comprising elements 40-46 in cascade connection after the PLP1 interface for FEC coding, but before a respective input port of the assembler 20 for assembling a serial stream of effective COFDM symbols. More specifically, FIG. 4 depicts an encoder 40 for BCH coding with its input port connected to receive the PLP1 FEC-coding interface signal from the output port of the BBFRAME scrambler 19 and with its output port connected to the input port of an encoder 41 for LDPC coding. The output port of the encoder 41 is connected to the input port of a bit interleaver and QAM-label formatter 42. FIG. 4 depicts the output port of the bit interleaver and QAM-label formatter 42 connected to the input port of a time interleaver 43 for successive QAM labels. The time interleaver 43 shuffles the order of the QAM symbols in each successive FEC block. This shuffling implements cyclic delay diversity that helps the FEC coding to overcome fading. The output port of the QAM-label time interleaver 43 connects to the respective input ports of pair 44 of QAM mappers for dual-mapping successive QAM labels to the complex coordinates of respective successions of QAM symbol constellations. The two QAM mappers in the pair 44 of them map same coded data to QAM of their respective OFDM carriers according to respective patterns that differ from each other, thereby to implement labeling diversity.

The respective output ports of the pair 44 of QAM mappers are connected for supplying first and second sets of successive QAM symbol constellations to respective input ports of parsers 45 of the first and second sets of successive of QAM symbols into respective successions of half COFDM symbols. These successions of half COFDM symbols are supplied to first and second input ports of a COFDM symbol assembler 46, which responds to their half COFDM symbols alternately to generate complete COFDM symbols. The output port of the COFDM symbol assembler 46 is connected to a respective input port of the assembler 20 of a serial stream of effective COFDM symbols, in which frames of PLP responses from the various physical layer pipes are time-division multiplexed. Together, the parsers 45 and the COFDM symbol assembler 46 combine to provide a COFDM symbol generator for arranging successive ones of the first set of QAM symbols in first prescribed order in initial halves of successive COFDM symbols and arranging successive ones of the second set of QAM symbols in second prescribed order in final halves of successive COFDM symbols.

FIG. 4 depicts the (n)th physical layer pipe PLPn further comprising elements 50-55 in cascade connection after the PLP0 interface for FEC coding, but before a respective input port of the assembler 20 for assembling a serial stream of effective COFDM symbols. More specifically, FIG. 4 depicts an encoder 50 for BCH coding with its input port connected to receive the PLPn FEC-coding interface signal from the output port of the BBFRAME scrambler 29 and with its output port connected to the input port of an encoder 51 for LDPC coding. The output port of the encoder 51 is connected to the input port of bit interleaver and QAM-label formatter 52. FIG. 4 depicts the output port of the bit interleaver and QAM-label formatter 52 connected to the input port of a time interleaver 53 for successive QAM labels. The time interleaver 53 shuffles the order of the QAM symbols in each successive FEC block. This shuffling implements cyclic delay diversity (CDD) that helps the FEC coding to overcome fading. The output port of the QAM-label time interleaver 53 connects to the respective input ports of a pair 54 of QAM mappers for dual mapping successive QAM labels to the complex coordinates of respective successions of QAM symbol constellations. The two QAM mappers in the pair 54 of them map same coded data to QAM of their respective OFDM carriers according to respective patterns that differ from each other, thereby to implement labeling diversity.

The respective output ports of the pair 54 of QAM mappers are connected for supplying first and second sets of successive QAM symbol constellations to respective input ports of parsers 55 of the first and second sets of successive of QAM symbols into respective successions of half COFDM symbols. These successions of half COFDM symbols are supplied to first and second input ports of a COFDM symbol assembler 46, which responds to their half COFDM symbols alternately to generate complete COFDM symbols. The output port of the COFDM symbol assembler 46 is connected to a respective input port of the assembler 20 of a serial stream of effective COFDM symbols, in which frames of PLP responses from the various physical layer pipes are time-division multiplexed. Together, the parsers 55 and the COFDM symbol assembler 46 combine to provide a COFDM symbol generator for arranging successive ones of the first set of QAM symbols in first prescribed order in initial halves of successive COFDM symbols and arranging successive ones of the second set of QAM symbols in second prescribed order in final halves of successive COFDM symbols.

Customarily there is a number of other physical layer pipes besides PLP0, PLP1 and PLPn, which other physical layer pipes are identified by the prefix PLP followed by respective ones of consecutive numbers two through (n−1). Each of the PLPs, n+1 in number, may differ from the others in at least one aspect. One possible difference between these n+1 PLPs concerns the natures of the FEC coding these PLPs respectively employ. The current trend is to use concatenated BCH coding and LDPC block coding for the FEC coding, but concatenated Reed-Solomon coding and convolutional coding have been used in the past. EN 302 755 V1.3.1 for DVB-T2 specifies a block size of 54,800 bits for normal FEC frames as a first alternative, and a block size of 16,200 bits is specified for short FEC frames as a second alternative. Also, a variety of different LDPC code rates are authorized. PLPs may differ in the number of OFDM carriers involved in each of their spectral samples, which affects the size of the DFT used for demodulating those OFDM carriers. Another possible difference between PLPs concerns the natures of the QAM symbol constellations (or possibly other modulation symbol constellations) they respectively employ.

FIG. 4 indicates that the output port of the assembler 20 of a serial stream of effective COFDM symbols, in which frames of PLP responses from the various physical layer pipes are time-division multiplexed, connects to subsequent elements via a COFDM generation interface depicted in both FIGS. 4 and 5. These subsequent elements are depicted in FIG. 5, which indicates where pilot carrier symbols are inserted into the effective COFDM symbol to generate complete COFDM symbols to be supplied to at least one COFDM modulator. Preferably, the pilot carrier symbols for modulating the OFDM carriers in the upper subband of the DCM-COFDM signal are similar to those specified for DSB-COFDM signal in the ATSC 3.0 Standard for DTV Broadcasting and are similarly positioned in each COFDM frame, and the pilot carrier symbols for modulating the OFDM carriers in the lower subband of the DCM-COFDM signal mirror those in the upper subband both as to modulation and positioning in each COFDM frame.

FIG. 5 depicts a pilot-carrier symbols insertion unit 37 having an input port connected for receiving the serial stream of effective COFDM symbols supplied from the FIG. 4 assembler 20 thereof via the COFDM generation interface. The pilot-carrier symbols insertion unit 37 introduces pilot symbols for the lower- and upper-frequency edges of a complete COFDM symbol and inserts pilot carrier symbols at suitable intervals between QAM symbols in each effective COFDM symbol to generate the rest of a respective complete COFDM symbol suitable for a subsequent 8K I-FFT. The output port of the pilot-carrier symbols insertion unit 37 is connected for supplying complete COFDM symbols to the input port of an OFDM modulator 38 which performs that subsequent 8K I-FFT. That is, the pilot-carrier symbols insertion unit 37 cooperates with the assembler 20 of a serial stream of effective COFDM symbols to form a COFDM symbol generator for supplying complete COFDM symbols to the OFDM modulator 38 that is the initial element of a subsequent generator of DCM-COFDM radio-frequency signal. Preferably, the pilot-carrier symbols insertion units 37 arranges for the insertion of a pilot carrier at midband, to facilitate separation of the lower-frequency and upper-frequency subbands of the DCM-COFDM signal in a receiver for such signal. FIG. 5 shows the output port of the OFDM modulator 38 connected for supplying 8K I-FFT results directly to the input port of a guard intervals insertion unit 39. Preferably, the guard intervals insertion unit 39 inserts a respective cyclic prefix within each guard interval.

FIG. 5 depicts a pilot-carrier symbols insertion unit 47 having an input port connected for receiving the serial stream of effective COFDM symbols supplied from the FIG. 4 assembler 20 thereof via the COFDM generation interface. The pilot-carrier symbols insertion unit 47 introduces pilot symbols for the lower- and upper-frequency edges of a complete COFDM symbol and inserts pilot carrier symbols at suitable intervals between QAM symbols in each effective COFDM symbol to generate the rest of a respective complete COFDM symbol suitable for a subsequent 16K I-FFT. The output port of the pilot-carrier symbols insertion unit 47 is connected for supplying complete COFDM symbols to the input port of an OFDM modulator 48 which performs that subsequent 16K I-FFT. That is, the pilot-carrier symbols insertion unit 47 cooperates with the assembler 20 of a serial stream of effective COFDM symbols to form a COFDM symbol generator for supplying complete COFDM symbols to the OFDM modulator 48 that is the initial element of a subsequent generator of DCM-COFDM radio-frequency signal. Preferably, the pilot-carrier symbols insertion units 47 arranges for the insertion of a pilot carrier at midband, to facilitate separation of the lower-frequency and upper-frequency subbands of the DCM-COFDM signal in a receiver for such signal. FIG. 5 shows the output port of the OFDM modulator 48 connected for supplying 16K I-FFT results directly to the input port of a guard intervals insertion unit 49. Preferably, the guard intervals insertion unit 49 inserts a respective cyclic prefix within each guard interval.

FIG. 5 depicts a pilot-carrier symbols insertion unit 57 having an input port connected for receiving the serial stream of effective COFDM symbols supplied from the FIG. 4 assembler 20 thereof via the COFDM generation interface. The pilot-carrier symbols insertion unit 57 introduces pilot symbols for the lower- and upper-frequency edges of a complete COFDM symbol and inserts pilot carrier symbols at suitable intervals between QAM symbols in each effective COFDM symbol to generate the rest of a respective complete COFDM symbol suitable for a subsequent 32K I-FFT. That is, the pilot-carrier symbols insertion unit 57 cooperates with the assembler 20 of a serial stream of effective COFDM symbols to form a COFDM symbol generator for supplying complete COFDM symbols to the OFDM modulator 58 that is the initial element of a subsequent generator of DCM-COFDM radio-frequency signal. Preferably, the pilot-carrier symbols insertion unit 57 arranges for the insertion of a pilot carrier at midband, to facilitate separation of the lower-frequency and upper-frequency subbands of the DCM-COFDM signal in a receiver for such signal. FIG. 5 shows the output port of the OFDM modulator 58 is connected for supplying 32K I-FFT results directly to the input port of a guard intervals insertion unit 59. Preferably, the guard intervals insertion unit 59 inserts a respective cyclic prefix within each guard interval.

Clipping methods of PAPR reduction necessarily involve distortion that tends to increase bit errors and thus tax iterative soft decoding of error-correction coding more. Furthermore, the PAPR reduction method using a complementary-power pair of QAM mappers suppresses occasional power peaks, which the various clipping methods of PAPR reduction rely upon to be markedly effective. Even so, most COFDM transmitter apparatus permits some clipping of power peaks that tend to occur infrequently, even where the power amplifier is of Doherty type. This is permitted in recognition of practical limitations on linearity in COFDM receiver apparatuses. However, band-limit filtering designed to suppress widening of the frequency spectrum caused by such clipping should follow the power amplifier for final-radio-frequency COFDM signal.

FIG. 5 further depicts a selector 60 having respective input ports to which the output ports of the guard intervals insertion units 39, 49 and 59 respectively connect. FIG. 5 depicts the output port of the selector 60 connected to the input port of a frame preambles insertion unit 61. The pilot-carrier symbol insertion unit 37, the OFDM modulator 38, any subsequent supplemental PAPR reduction unit and the guard intervals insertion unit 39 may be selectively powered, being powered only when transmissions using close to 8K OFDM carriers are made. Elements 37, 38 and 39 may all be omitted in some transmitters. The pilot-carrier symbols insertion unit 47, the OFDM modulator 48, any subsequent supplemental PAPR reduction unit and the guard intervals insertion unit 49 may be selectively powered, being powered only when transmissions using close to 16K OFDM carriers are made. Elements 47, 48 and 49 may all be omitted in some transmitters. The pilot-carrier symbols insertion unit 57, the OFDM modulator 58, any subsequent supplemental PAPR reduction unit and the guard intervals insertion unit 59 may be selectively powered, being powered only when transmissions using close to 32K OFDM carriers are made. All the elements 57, 58 and 59 may be omitted in some transmitters.

FIG. 5 shows the output port of the frame preambles insertion unit 61 connected to one of the two input ports of a time-division multiplexer 62. The other of the two input ports of the time-division multiplexer 62 is connected for receiving a bootstrap signal that a bootstrap signal generator 63 supplies from its output port. The time-division multiplexer 62 introduces the bootstrap signal before COFDM frames. The bootstrap signal is an innovation introduced by developers of the ATSC 3.0 Digital Television Standards. It conveys metadata descriptive of the transmission standard used for DTV broadcasting and critical information concerning the configuration of receivers for receiving DTV broadcasts made in accordance with that standard. The bootstrap signal is conveyed by an OFDM signal using a set of carriers that are apt to differ in frequencies in a defined way from the set of carriers used for COFDM transmission of DTV signal. The OFDM signal conveying the bootstrap is of narrower bandwidth (typically 4.5 MHz) than the 6 MHz, 7 MHz or 8 MHZ signals currently used for DTV in various countries around the world. The baseband bootstrap signal developed for the ATSC 3.0 Digital Television Standards comprises a Zadoff-Chu sequence, which identifies the basic standard governing the DTV broadcasting, and a set of repetitive pseudo-random-noise sequences that convey further metadata. This is described more fully in ATSC Standard A/321, System Discovery and Signaling (Doc. A/321:2016, approved 23 Mar. 2016). Digital output signal from the time-division multiplexer 62 (or from the frame preambles insertion unit 61 if elements 62 and 63 are not employed) is supplied to the input port of a digital-to-analog converter (or DAC) 64 to be converted to an analog signal applied as input modulating signal to a single-sideband amplitude modulator 65.

(The RF oscillator 66 combines with the SSB amplitude modulator 65 to constitute a generator of DCM-COFDM radio-frequency (RF) signal. Owing to arrangements of first and second sets of successive QAM symbols in the frequency spectrum carried out by at least one preceding generator of COFDM symbols, the lower-frequency subband of this RF signal conveys the first set of successive QAM symbols and the upper-frequency subband of this RF signal conveys a second set of successive QAM symbols. The amplitude modulator 65 supplies RF analog COFDM signal from an output port thereof to the input port of a linear power amplifier 67. Linear power amplifier 67 can be of Doherty type, which type conventionally is used to reduce the likelihood of clipping on peaks of RF signal amplitude. Using DCM in accordance with the invention reduces PAPR of COFDM signals significantly, however, so a simpler type of linear power amplifier 67 may be used. FIG. 5 shows the output port of the linear power amplifier 67 connected for driving amplified RF analog COFDM signal power to a transmission antenna 68. FIG. 5 omits showing some DTV transmitter details, such as band-shaping filters for the RF signals.

FIG. 5 shows a single-sideband amplitude modulator 65 connected for modulating an RF carrier wave of the frequency of the ultimate transmissions from the transmission antenna 68. In actual commercial practice the SSB amplitude modulator 65 is apt to be connected for modulating an intermediate frequency (IF) carrier wave. An up-converter converts the analog COFDM carriers in the SSB amplitude modulator 65 response to final radio frequencies and is connected for supplying them from its output port to the input port of the linear power amplifier 67. In some designs for the DTV transmitter the DAC 64 is designed to compensate for non-linear transfer functions of the SSB amplitude modulator 65, of the up-converter (if used), and of the linear power amplifier 67.

The frame preambles inserted by the frame preambles insertion unit 61 convey the conformation of each COFDM frame structure and also convey the dynamic scheduling information (DSI) produced by the scheduler 10. This information is conveyed using at least some of OFDM carriers also used for conveying the baseband OFDM information in the input signals to the frame preambles insertion unit 61. The OFDM carriers supplied by the bootstrap signal generator 63 are apt to have different frequencies than OFDM carriers used for conveying the baseband OFDM information in the input signals to the frame preambles insertion unit 61. The OFDM carriers supplied by the bootstrap signal generator 63 are constrained to a narrower bandwidth than the OFDM carriers used for conveying the baseband OFDM information in the input signals to the frame preambles insertion unit 61. The bootstrap signal conveys basic information as to the standard to which OFDM broadcasts conform, the bandwidth of the RF channel, and the size of the I-FFT used in the broadcasting of groups of OFDM frames, for example. If bootstrap signals are not used in the standard used for COFDM broadcasting, the elements 62 and 63 will be omitted, and the output port of the frame preambles insertion unit 61 will connect directly to the input port of the digital-to-analog converter 64.

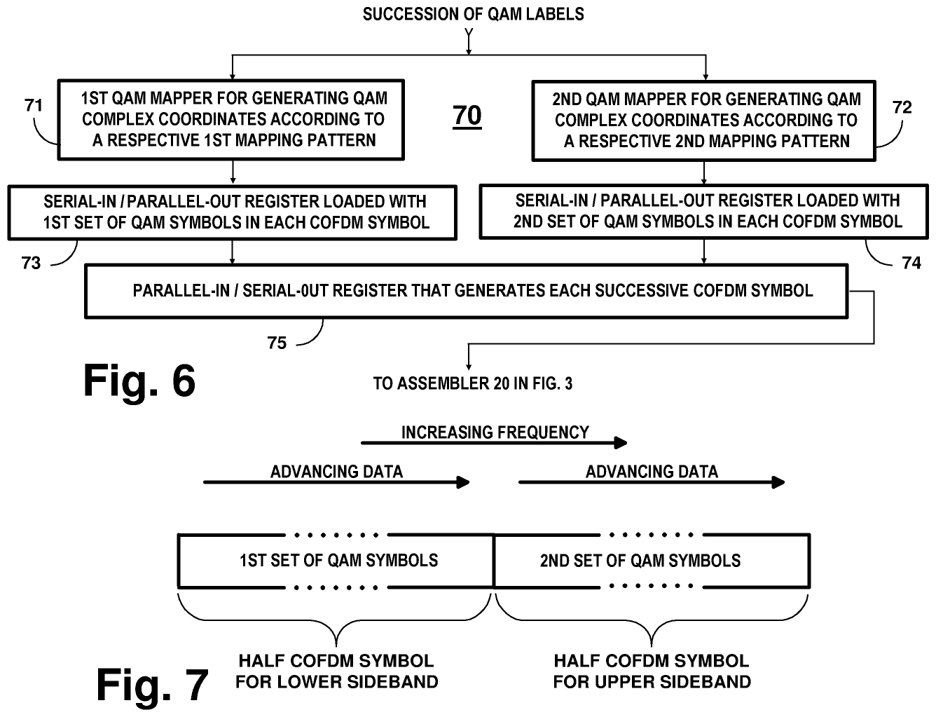

FIG. 6 is a detailed schematic diagram of representative structure 70 for any one of a number of cascade connections in respective physical layer pipes of the FIG. 4 portion of COFDM transmitter apparatus, which structure 70 is configured so as to generate separate half COFDM symbols to be transmitted in lower and upper subbands respectively of the COFDM signal. Each of these cascade connections comprises a respective pair of QAM mappers to QAM symbol constellations, followed by a respective COFDM symbol assembler. One of these cascade connections comprises the elements 34, 35 and 36 in PLP0. Another of these cascade connections comprises the elements 44, 45 and 46 in PLP1. Still another of these cascade connections comprises the elements 54, 55 and 56 in PLPn.

FIG. 6 shows any one of the respective pairs 34, 44, 54 etc. of mappers to QAM symbol constellations in the physical layer pipes PLP0, PLP1, PLPn etc. as consisting of a respective first QAM mapper 71 and a respective second QAM mapper 72. The respective input ports of the QAM mappers 71 and 72 are each connected for receiving the same succession of QAM lattice-point labels from a foregoing element, such as one of the QAM-label time interleavers 33, 43, 53 etc. Serial-input/parallel-output registers 73 and 74 correspond to the subsequent one of the pairs of parsers 35, 45, 55 etc. A parallel-input/serial-output (PISO) register 75 is configured as a COFDM symbol assembler of a type that is preferred for the respective COFDM symbol assemblers 36, 46, 46 etc. in the physical layer pipes PLP0, PLP1, PLPn etc.

The output port of the first QAM mapper 71 is connected for serially supplying the complex coordinates of a first set of QAM symbols to the input port of the serial-input/parallel-output register 73, which is capable of storing the complex coordinates of QAM symbols for inclusion in the lower-subband half of each COFDM symbol. The output port of the second QAM mapper 72 is connected for serially supplying the complex coordinates of a second set of QAM symbols to the input port of the serial-input/parallel-output register 74, which is capable of storing the complex coordinates of QAM symbols for inclusion in the upper-subband half of each COFDM symbol. The parallel output ports of the serial-input/parallel-output registers 73 and 74 are connected for delivering complex coordinates of respective first and second sets of QAM symbols as half COFDM symbols to the parallel input ports of the parallel-input/serial-output register 75, the output port of which connects to a respective input port of the assembler 20 in FIG. 4.

FIG. 7 illustrates the serial response that the parallel-input/serial-output register 75 is designed to supply from its serial output port to that one of the input ports of the assembler 20. Such response is obtained by appropriately connecting ones of the parallel output ports of the serial-input/parallel-output registers 73 and 74 to appropriate ones of the parallel input ports of the parallel-input/serial-output register 75. The complete first set of QAM symbols as generated by the first QAM mapper 71 for inclusion in a half COFDM symbol to be transmitted in the lower subband of the DCM-COFDM signal is followed by the complete second set of QAM symbols as generated by the second QAM mapper 72 for inclusion in a half COFDM symbol to be transmitted in the upper subband of the DCM-COFDM signal. This causes the SSB amplitude modulator 65 depicted in FIG. 5 to generate asymmetric-sideband amplitude modulation, presuming the principal carrier to be completely suppressed. The FIG. 7 frequency interleaving format spreads all the QAM symbols conveying the same information the maximum possible uniform distance in the frequency domain.

Following custom, each labeled lattice point of the QAM symbol constellation maps considered in this specification and its accompanying drawing is plotted respective to an in-phase (I) axis and a quadrature (Q) axis. Each QAM symbol constellation map is composed of four quadrants: a −I,+Q quadrant, a +I,+Q quadrant, a +I,−Q quadrant and a −I,−Q quadrant. In this document each of these four quadrants is considered to consist of four sub-quadrants arranged by column and row within that quadrant. An “innermost” of these sub-quadrants is closest of the four to a point of origin at which the I and Q axes cross, and an “outermost” of these sub-quadrants is furthest of the four from that point of origin. There are two “flanking” sub-quadrants in each quadrant besides the “innermost” and “outermost” sub-quadrants.

FIGS. 7-18 of the drawings of U.S. patent application Ser. No. 16/736,645 (and of the drawings of U.S. patent application Ser. No. 16/900,907 as well) depict various SCM-mapped square 16QAM symbol constellations that could be used in one of the pairs 34, 44 and 54 of QAM mappers in the FIG. 4 portion of the DCM-COFDM signal transmitting apparatus depicted in FIGS. 3, 4 and 5 of drawings for this document. The LPLs for a square 16QAM symbol constellation have only four bits apiece. FIGS. 7-18 of U.S. patent application Ser. No. 16/736,645 (or of U.S. patent application Ser. No. 16/900,907) are incorporated herein by reference, together with attendant written specification concerning those FIGS. 7-18. This incorporation by reference is for providing background information. The invention of interest in this document concerns using square QAM symbol constellations with more than sixteen labeled lattice points in each of them, which lattice points are each labeled with a respective LPL having therein an even number of bits, more than four.

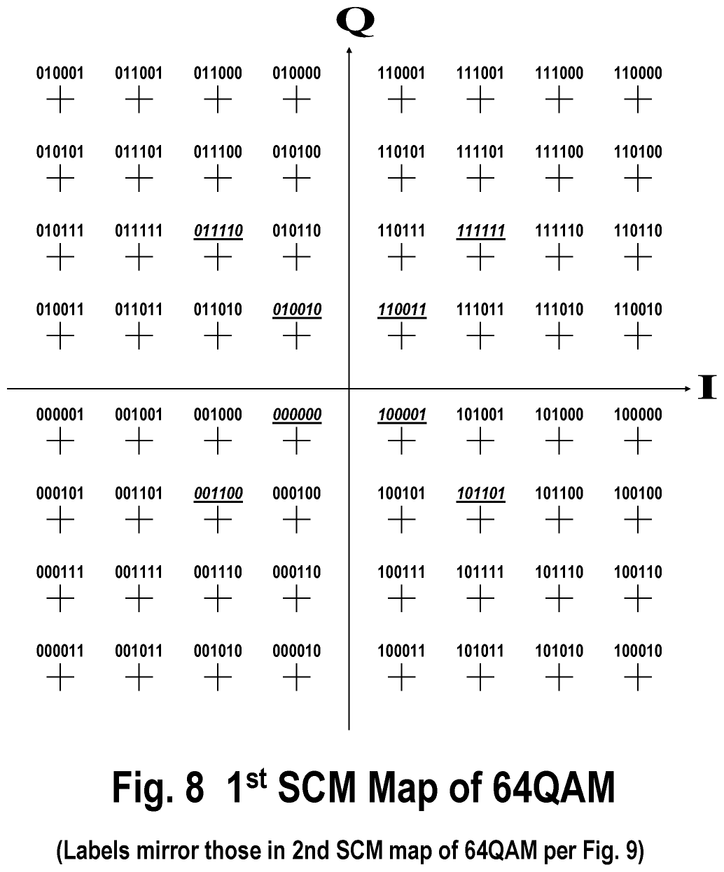

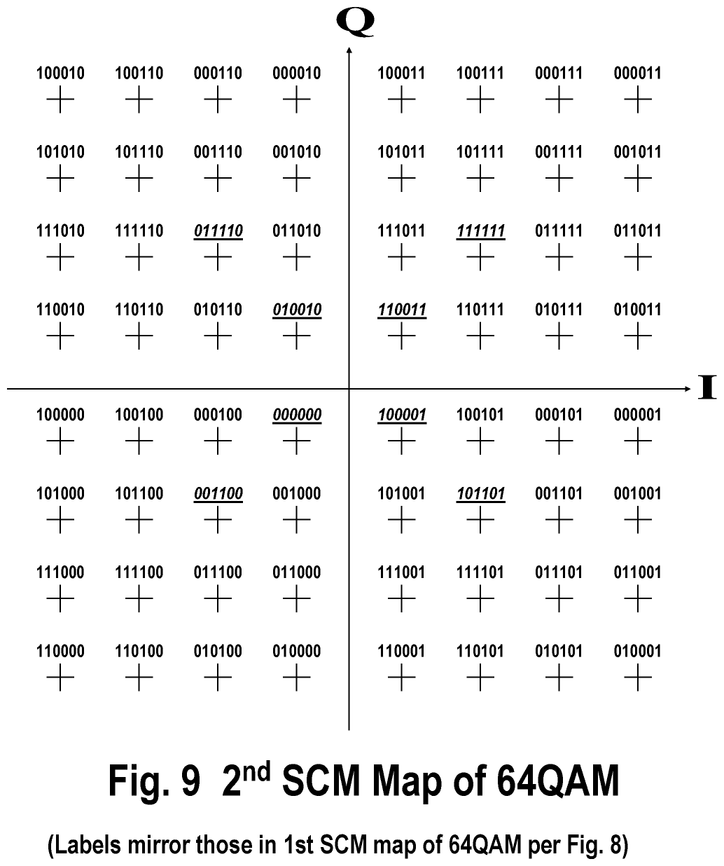

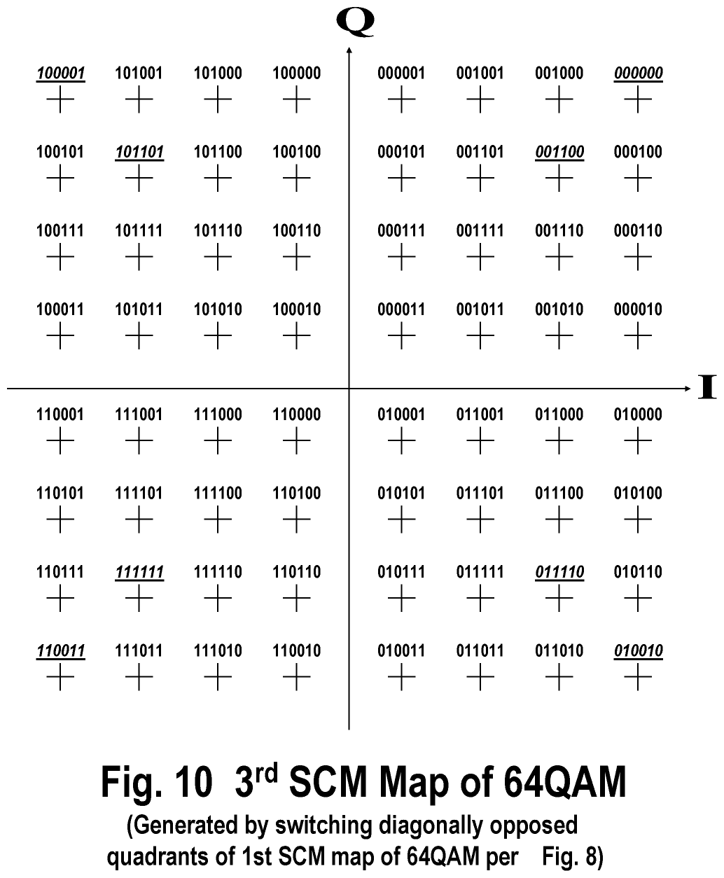

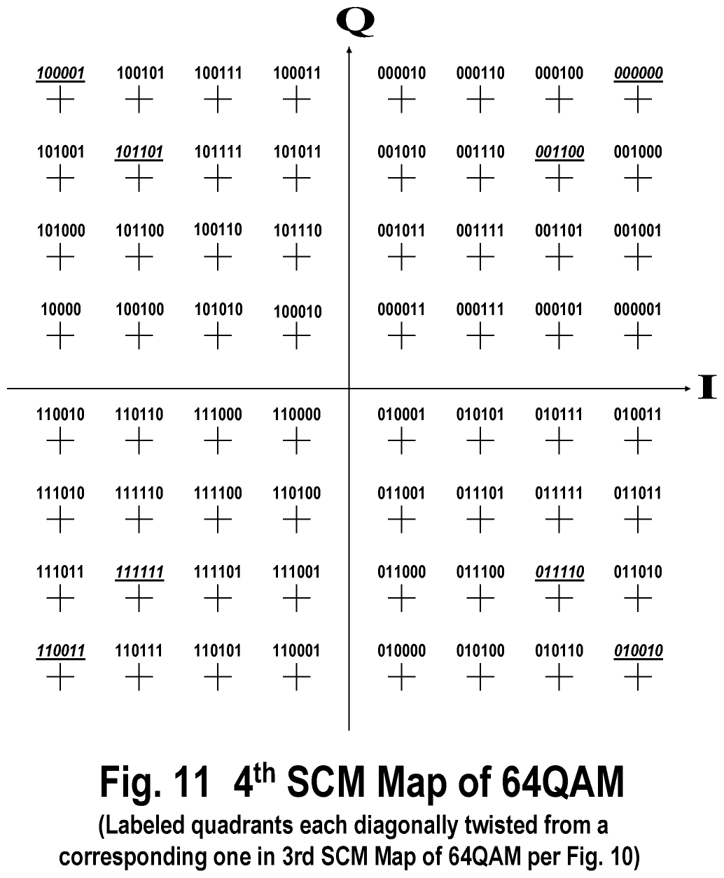

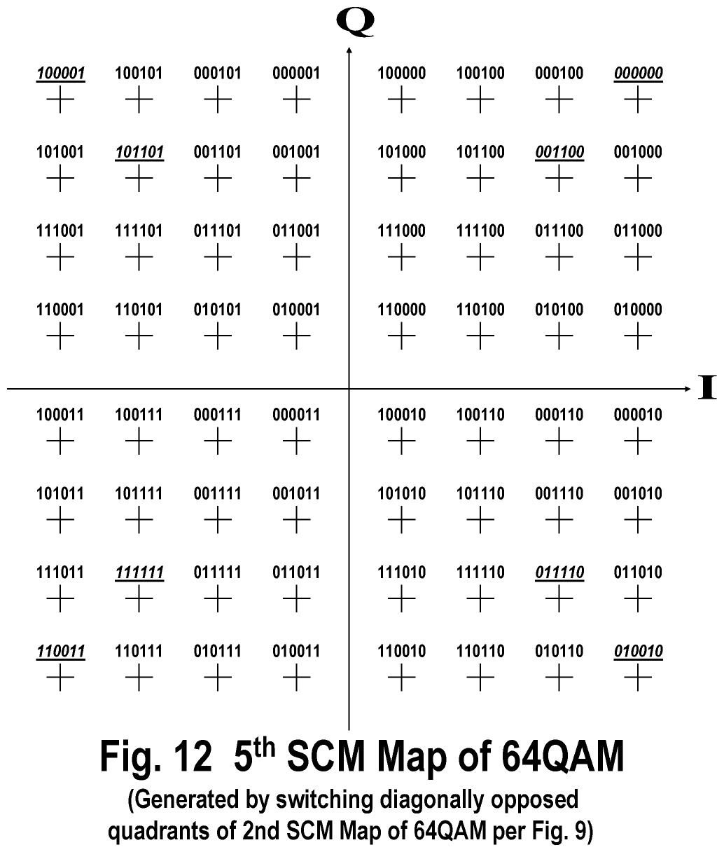

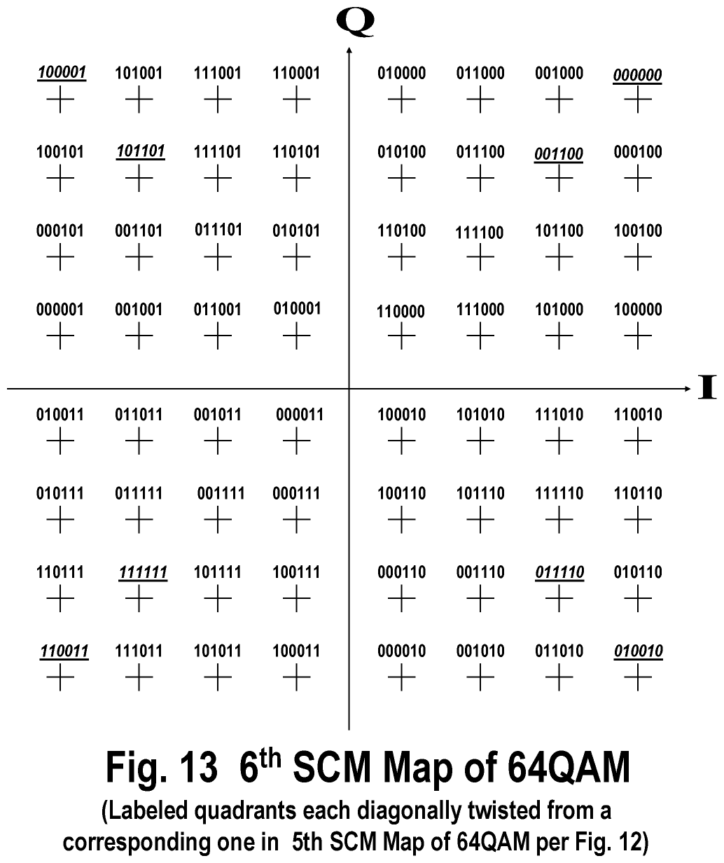

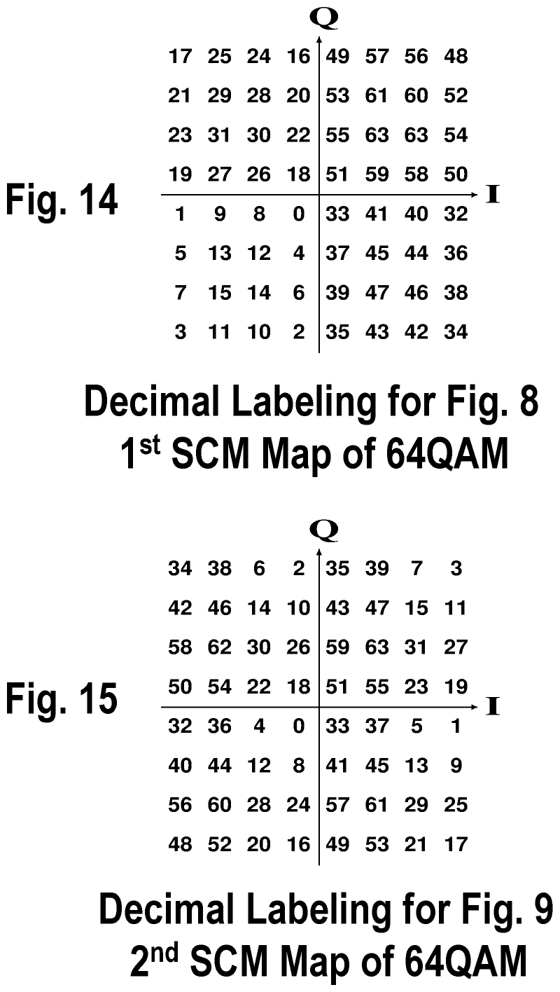

FIGS. 8 and 9 respectively depict first and second SCM maps of lattice points in square 64QAM symbol constellations. The LPLs in each of these SCM maps mirror the correspondingly positioned LPLs in the other of these SCM maps, insofar as order of bits in them is concerned. So, palindromic LPLs will be similarly positioned in both of these SCM maps. One of these first and second SCM maps of 64QAM is directly employed by one of the QAM mappers 71 and 72 in a physical layer pipe in some DCM-COFDM transmitter apparatuses embodying aspects of the invention. The other of the first and second SCM maps of 64QAM is not directly employed by either of the QAM mappers 71 and 72 QAM mappers 71 and 72, but provides the basis from which a further SCM map of 64QAM is derived. This further SCM map of 64QAM is directly employed by the other of the QAM mappers 71 and 72, the QAM mapper that does not directly employ either of the first and second SCM maps of 64QAM.

The palindromic LPL 000000 is applied to the lattice point located in the innermost corner of the −I,−Q quadrant in each of the FIG. 8 and FIG. 9 SCM maps of 64QAM, and the palindromic LPL 001100 is applied to the lattice point located diagonally next within that quadrant. The 010010 label is applied to the lattice point located in the innermost corner of the −I,+Q quadrant in each of the FIG. 8 and FIG. 9 SCM maps of 64QAM, and the palindromic LPL 011110 is applied to the lattice point located diagonally next within that quadrant. The 110011 label is applied to the lattice point located in the innermost corner of the +I,+Q quadrant in each of the FIG. 8 and FIG. 9 SCM maps of 64QAM, and the palindromic LPL 111111 is applied to the lattice point located diagonally next within that quadrant. The 100001 label is applied to the lattice point located in the innermost corner of the +I,−Q quadrant in each of the FIG. 8 and FIG. 9 SCM maps of 64QAM, and the palindromic LPL 101101 is applied to the lattice point located diagonally next within that quadrant.

In the Gray mapping of each quadrant of the FIG. 8 first SCM map of 64QAM, the leftmost two bits of LPLs identify that particular quadrant within which the lattice points are located, and the rightmost two bits of LPLs specify which of four sub-quadrants within that particular quadrant each lattice point is located within. In the Gray mapping of each quadrant of the FIG. 9 second SCM map of 64QAM, the rightmost two bits of LPLs identify that particular quadrant within which the lattice points are located, and the leftmost two bits of LPLs specify which of four sub-quadrants within that particular quadrant each lattice point is located within. The quadrant considered as a bin for LPLs has four columns and four rows of them, twice the number of columns and twice the number of rows as a sub-quadrant. Accordingly, the leftmost two bits of the LPLs in the FIG. 8 first SCM map of 64QAM have greater likelihood of being correct when accompanied by moderate levels of AWGN than the leftmost two bits of the LPLs in the FIG. 9 second SCM map of 64QAM have. Accordingly, also, the rightmost two bits of the LPLs in the FIG. 9 second SCM map of 64QAM have greater likelihood of being correct when accompanied by moderate levels of AWGN than the rightmost two bits of the LPLs in the FIG. 8 first SCM map of 64QAM have.

The central two bits of the 6-bit LPLs in the FIG. 8 first SCM map of 64QAM have substantially the same likelihood of being correct when the 64QAM symbols are accompanied by moderate levels of AWGN as the rightmost two bits of those LPLs have, less than the likelihood of the leftmost two bits in those LPLs being correct. The central two bits of the 6-bit LPLs in the FIG. 9 second SCM map of 64QAM have substantially the same likelihood of being correct when accompanied by moderate levels of AWGN as the leftmost two bits of those LPLs have, less than the likelihood of the rightmost two bits in those LPLs being correct. Presuming that the frequency spectrum of the DCM-COFDM signal to be flat, the following observations hold true. Maximal ratio combining the third bits of corresponding 6-bit LPLs from the FIG. 8 and FIG. 9 SCM maps of 64QAM should reduce BER at least 6 dB, owing to the CDD being correlated while AWGN or similar noise is uncorrelated. Reduction in BER may be as high as 8.5 dB, according to teaching in U.S. Pat. No. 7,236,548. Maximal ratio combining the fourth bits of corresponding 6-bit LPLs from the FIG. 8 and FIG. 9 SCM maps of 64QAM should reduce BER similarly. The 6 dB (or more) reductions in BER should offset (or more than offset) the increase in BER arising from AWGN accompanying DCM-COFDM signal, which increase comes about because of spacing between lattice points in 64QAM being halved as compared to 16QAM.

The greater likelihood of the leftmost two bits of the 6-bit LPLs being correct in the FIG. 8 first SCM map of 64QAM than in the FIG. 9 second SCM map of 64QAM is beneficial to maximal ratio combining (MRC) of corresponding ones of those bits. The greater likelihood of the rightmost two bits of the LPLs being correct in the FIG. 9 second SCM map of 64QAM than in the FIG. 8 first SCM map of 64QAM is beneficial to MRC of corresponding ones of those bits. In both of these cases of MRC, the reductions in BER for maximal ratio combining corresponding ones of those bits are more pronounced than the reductions in BER for maximal ratio combining corresponding ones of the central bits of those 6-bit LPLs. The more pronounced reductions in BER will more than offset the increase in BER arising from AWGN accompanying DCM-COFDM signal, which increase comes about because of spacing between lattice points in 64QAM being halved as compared to 16QAM.

So, when using DCM with 64QAM the overall likelihood of two 6-bit segments of CDD being correct should be as good, if not better, than for three 4-bit segments of the same CDD using 16QAM of OFDM carriers without DCM. So, using DCM-COFDM with 64QAM of carriers, to get two-thirds the data throughput as COFDM using 16QAM of carriers without DCM, should not cause anywhere near as much as 6 dB reduction in SNR of reception over an AWGN channel, if indeed there be reduction at all.

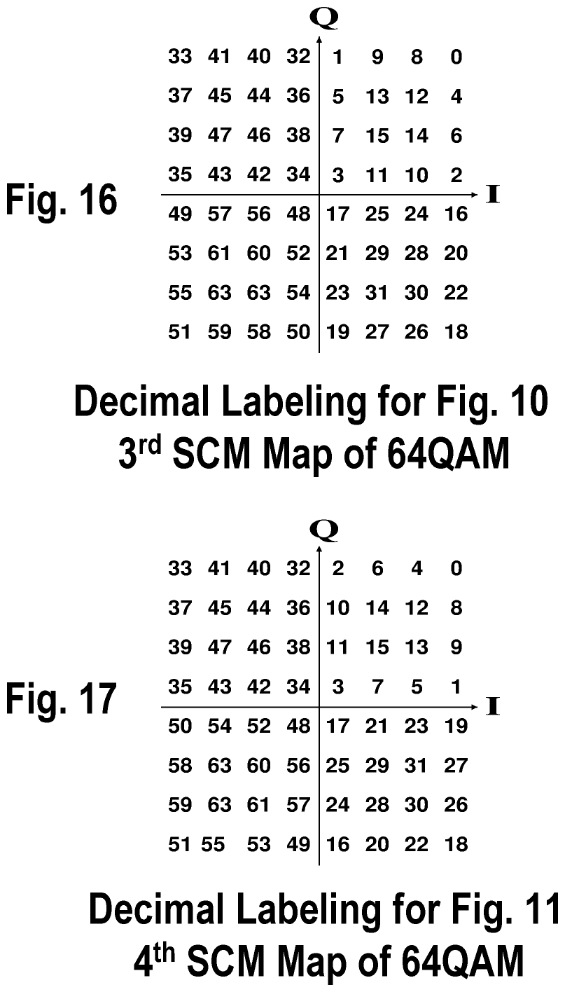

An aspect of the invention is embodied in the physical layer pipe of a DCM-COFDM transmitter apparatus in which QAM mappers 71 and 72 respectively employ different ones of the FIG. 9 second SCM map of 64QAM and the FIG. 10 third SCM map of 64QAM. The FIG. 10 third SCM map of square 64QAM symbol constellations results from modifying the FIG. 8 first SCM map of 64QAM symbol constellations by (a) exchanging the positions of −I,+Q and +I,−Q quadrants going from the FIG. 8 map to the FIG. 10 map and (b) exchanging the positions of +I,+Q and −I, −Q quadrants going from the FIG. 8 map to the FIG. 10 map. Despite these exchanges, the respective likelihoods of the successive bits of the LPLs in the FIG. 10 third SCM map of 64QAM being in error caused by accompanying AWGN of a given level remain the same as the respective likelihoods of the successive bits of the LPLs in the FIG. 8 first SCM map of 64QAM being in error caused by accompanying AWGN of that given level. So, the BER results of MRC in a receiver for DCM-COFDM signal are similar, irrespective of whether the dual-mapped 64QAM signals employ the FIG. 9 second SCM map together with the FIG. 8 first SCM map or together with the FIG. 10 third SCM map.

COFDM employing square 64 QAM symbols, but no DCM, exhibits a peak voltage proportional to seven times the square root of two times the voltage between adjoining lattice points of a square 64QAM symbol constellation—i. e., 9.900 times that voltage. So, the peak voltage of two such COFDM carriers reaches 19.800 times that voltage. The map labels in the outermost corners of the quadrants of the FIG. 10 third SCM map correspond to map labels in the innermost corners of the diagonally opposite quadrants of the FIG. 9 second SCM map. This constrains the peak voltage of the DCM-COFDM signal for any of these map labels to being proportional to eight times the voltage between adjoining lattice points times the voltage between adjoining lattice points of a square 64QAM symbol constellation—i. e., 11.314 times that voltage. The lattice points that are on an outside edge of either of the two the square 64QAM symbol constellations and that also flank either the I axis or the Q axis of such symbol constellation are each associated with a voltage twice the square root of 50 times the voltage between adjoining lattice points. This only constrains the peak voltage of a pair of the DCM-COFDM signal carriers for conveying any of these map labels to being proportional to twice the square root of 50 times the voltage between adjoining lattice points of a square 64QAM symbol constellation i. e., 14.142 times that voltage. This peak voltage is the least constrained of any of the peak voltages associated with a pair of similarly labeled DCM carriers and is representative of a 2.92 dB reduction in PAPR over COFDM with square 64QAM symbols and without DCM. The PAPR of COFDM with square 64QAM symbols and without DCM is 4.33 dB The PAPR of DCM-COFDM signal using square 64QAM symbols is 1.41 dB, which is considerably better than the 2.55 dB PAPR of COFDM with square 16QAM symbols and without DCM.

The FIG. 11 fourth SCM map of square 64QAM symbol constellations results from diagonally twisting the pattern of map labels in each quadrant of the FIG. 10 third SCM map of 64QAM symbol constellations. An aspect of the invention is embodied in the physical layer pipe of a DCM-COFDM transmitter apparatus in which QAM mappers 71 and 72 respectively employ different ones of the FIG. 9 second SCM map of 64QAM and the FIG. 11 fourth SCM map of 64QAM. Employing different ones of the FIG. 9 second SCM map of 64QAM and the FIG. 11 fourth SCM map of 64QAM in the QAM mappers 71 and 72 respectively apparently provides no appreciable advantage nor disadvantage compared to employing different ones of the FIG. 9 second SCM map of 64QAM and the FIG. 10 third SCM map of 64QAM in the QAM mappers 71 and 72.

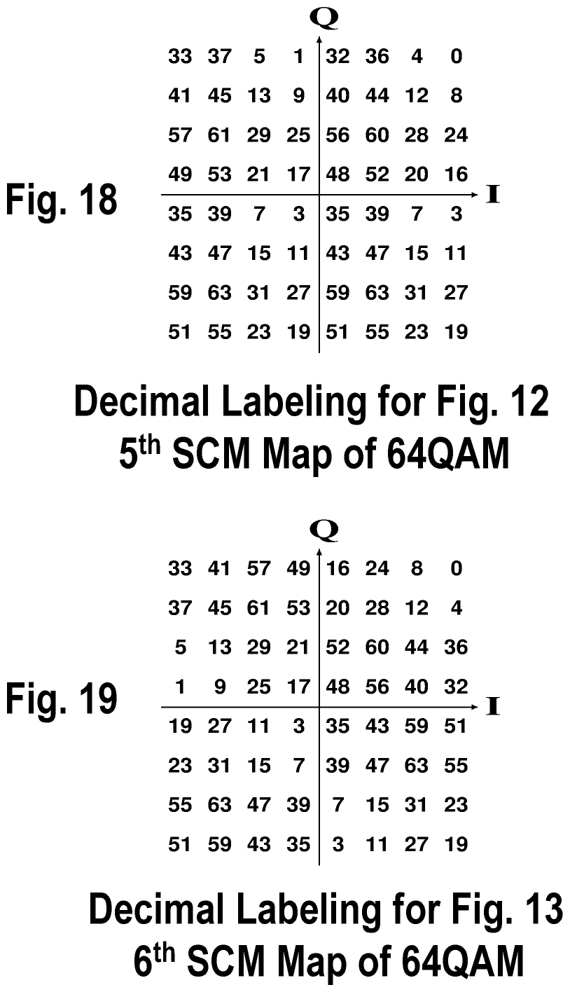

An aspect of the invention is embodied in the physical layer pipe of a DCM-COFDM transmitter apparatus in which QAM mappers 71 and 72 respectively employ different ones of the FIG. 8 first SCM map of 64QAM and the FIG. 12 fifth SCM map of 64QAM. FIG. 12 is a fifth SCM map of square 64QAM symbol constellations modifying the FIG. 9 second SCM map of 64QAM symbol constellations by (a) exchanging the positions of −I,+Q and +I,−Q quadrants going from the FIG. 9 map to the FIG. 12 map and (b) exchanging the positions of +I,+Q and −I,−Q quadrants going from the FIG. 9 map to the FIG. 12 map. Despite these exchanges, the respective likelihoods of the successive bits of the LPLs in the FIG. 12 fifth SCM map of 64QAM being in error caused by accompanying AWGN of a given level remain the same as the respective likelihoods of the successive bits of the LPLs in the FIG. 9 second SCM map of 64QAM being in error caused by accompanying AWGN of that given level. So, the BER results of MRC in a receiver for DCM-COFDM signal are similar, irrespective of whether the dual-mapped 64QAM signals employ the FIG. 8 first SCM map together with the FIG. 9 second SCM map or together with the FIG. 12 fifth SCM map. The constraints on the peak voltage of the DCM-COFDM signal when the QAM mappers 71 and 72 employ different ones of the FIG. 8 first SCM map of 64QAM and the FIG. 12 fifth SCM map of 64QAM in the QAM mappers 71 and 72 are similar to the constraints when those demappers those employ different ones of the FIG. 9 second SCM map of 64QAM and the FIG. 10 third SCM map of 64QAM. I. e., there is a 2.92 dB reduction in PAPR over conventional COFDM employing square 64 QAM symbols.

The FIG. 13 sixth SCM map of square 64QAM symbol constellations results from diagonally twisting the pattern of map labels in each quadrant of the FIG. 12 fifth SCM map of 64QAM symbol constellations. An aspect of the invention is embodied in the physical layer pipe of a DCM-COFDM transmitter apparatus in which QAM mappers 71 and 72 respectively employ different ones of the FIG. 8 first SCM map of 64QAM and the FIG. 13 sixth SCM map of 64QAM. Employing different ones of the FIG. 8 first SCM map of 64QAM and the FIG. 13 sixth SCM map of 64QAM in the QAM mappers 71 and 72 respectively apparently provides no appreciable advantage nor disadvantage compared to employing different ones of the FIG. 8 first SCM map of 64QAM and the FIG. 12 fifth SCM map of 64QAM in the QAM mappers 71 and 72.

FIGS. 14 and 18 present decimal labeling for the first and fifth SCM maps of 64QAM symbol constellations depicted in FIGS. 8 and 12, respectively, which maps can be used to provide advantageous labeling diversity for DCM in a COFDM signal. The LPLs 0, 4, 8 and 12 in the outermost sub-quadrant of the +I,+Q quadrant of the FIG. 18 fifth SCM map have high energies that average with low energies of the LPLs 0, 4, 8 and 12 in the innermost sub-quadrant of the −I,−Q quadrant of the FIG. 14 first SCM map. The LPLs 18, 22, 26 and 30 in the outermost sub-quadrant of the +I,−Q quadrant of the FIG. 18 fifth SCM map have high energies that average with low energies of the LPLs 18, 22, 26 and 30 in the innermost sub-quadrant of the −I,+Q quadrant of the FIG. 14 first SCM map. The LPLs 33, 37, 41 and 45 in the outermost sub-quadrant of the −I,+Q quadrant of the FIG. 18 fifth SCM map have high energies that average with low energies of the LPLs 33, 37, 41 and 45 in the innermost sub-quadrant of the +I,−Q quadrant of the FIG. 14 first SCM map. The LPLs 51, 55, 59 and 63 LPLs in the outermost sub-quadrant of the −I,−Q quadrant of the FIG. 18 fifth SCM map have high energies that average with low energies of the LPLs 51, 55, 59 and 63 in the innermost sub-quadrant of the +I,+Q quadrant of the FIG. 14 first SCM map. Averaging high energies of LPLs in the four outermost sub-quadrants of the FIG. 18 fifth SCM map with low energies of similar LPLs in the four innermost sub-quadrants of the FIG. 14 first SCM map contributes to keeping PAPR low in the DCM-COFDM signal.

Averaging of high energies of LPLs in the four outermost sub-quadrants of the FIG. 14 first SCM map with low energies of similar LPLs in the four innermost sub-quadrants of the FIG. 18 fifth SCM map also contributes to keeping PAPR low in the DCM-COFDM signal. The LPLs 48, 52, 56 and 60 in the outermost sub-quadrant of the +I,+Q quadrant of the FIG. 14 first SCM map have high energies that average with low energies of the LPLs 48, 52, 56 and 60 in the innermost sub-quadrant of the −I,−Q quadrant of the FIG. 18 fifth SCM map. The LPLs 34, 38, 42 and 46 in the outermost sub-quadrant of the +I,−Q quadrant of the FIG. 14 first SCM map have high energies that average with low energies of the LPLs 34, 38, 42 and 46 in the innermost sub-quadrant of the −I,+Q quadrant of the FIG. 18 fifth SCM map. The LPLs 17, 21, 25 and 29 in the outermost sub-quadrant of the −I,+Q quadrant of the FIG. 14 first SCM map have high energies that average with low energies of the LPLs 17, 21, 25 and 29 in the innermost sub-quadrant of the +I,−Q quadrant of the FIG. 18 fifth SCM map. The LPLs 3, 7, 11 and 15 in the outermost sub-quadrant of the −I,−Q quadrant of the FIG. 14 first SCM map have high energies that average with low energies of the LPLs 3. 7, 11 and 15 in the innermost sub-quadrant of the +I,+Q quadrant of the FIG. 18 fifth SCM map. The energies in the eight flanking sub-quadrants of the FIG. 14 first SCM map and the energies in the eight flanking sub-quadrants of the FIG. 18 fifth SCM map all tend toward the average. So, these energies do not boost the PAPR of the DCM-COFDM signal significantly, if at all.

FIGS. 14 and 19 present decimal labeling for the first and sixth SCM maps of 64QAM symbol constellations depicted in FIGS. 8 and 13, respectively, which maps can be used to provide advantageous labeling diversity for DCM in a COFDM signal. Averaging of high energies of LPLs in the four outermost sub-quadrants of the FIG. 19 sixth SCM map with low energies of similar LPLs in the four innermost sub-quadrants of the FIG. 14 first SCM map contributes to keeping PAPR low in the DCM-COFDM signal. Averaging of high energies of LPLs in the four outermost sub-quadrants of the FIG. 14 first SCM map with low energies of similar LPLs in the four innermost sub-quadrants of the FIG. 19 sixth SCM map also contributes to keeping PAPR low in the DCM-COFDM signal. The energies in the eight flanking sub-quadrants of the FIG. 14 first SCM map and the energies in the eight flanking sub-quadrants of the FIG. 19 sixth SCM map all tend toward the average. So, these energies do not boost the PAPR of the DCM-COFDM signal significantly, if at all.

FIGS. 15 and 16 present decimal labeling for the second and third SCM maps of 64QAM symbol constellations depicted in FIGS. 9 and 10, respectively, which maps can be used to provide advantageous labeling diversity for DCM in a COFDM signal. Averaging of high energies of LPLs in the four outermost sub-quadrants of the FIG. 16 third SCM map with low energies of similar LPLs in the four innermost sub-quadrants of the FIG. 15 second SCM map contributes to keeping PAPR low in the DCM-COFDM signal. Averaging of high energies of LPLs in the four outermost sub-quadrants of the FIG. 15 second SCM map with low energies of similar LPLs in the four innermost sub-quadrants of the FIG. 16 third SCM map also contributes to keeping PAPR low in the DCM-COFDM signal. The energies in the eight flanking sub-quadrants of the FIG. 15 second SCM map and the energies in the eight flanking sub-quadrants of the FIG. 16 third SCM map all tend toward the average. So, these energies do not boost the PAPR of the DCM-COFDM signal significantly, if at all.

FIGS. 15 and 17 present decimal labeling for the second and fourth SCM maps of 64QAM symbol constellations depicted in FIGS. 9 and 11, respectively, which maps can be used to provide advantageous labeling diversity for DCM in a COFDM signal. Averaging of high energies of LPLs in the four outermost sub-quadrants of the FIG. 17 fourth SCM map with low energies of similar LPLs in the four innermost sub-quadrants of the FIG. 15 second SCM map contributes to keeping PAPR low in the DCM-COFDM signal. Averaging of high energies of LPLs in the four outermost sub-quadrants of the FIG. 15 second SCM map with low energies of similar LPLs in the four innermost sub-quadrants of the FIG. 17 fourth SCM map also contributes to keeping PAPR low in the DCM-COFDM signal. The energies in the eight flanking sub-quadrants of the FIG. 15 second SCM map and the energies in the eight flanking sub-quadrants of the FIG. 17 fourth SCM map all tend toward the average. So, these energies do not boost the PAPR of the DCM-COFDM signal significantly, if at all.

Persons skilled in designing COFDM signals and acquainted with the foregoing disclosure are apt to discern that further modifications and variations can be made in the specifically described SCM mapping of square 64QAM symbol constellation without departing from the spirit or scope of the invention in certain broader ones of its aspects. A few of these variations will be specifically considered in the paragraphs next following. Similar variations are possible in the SCM mapping of square QAM symbol constellations of other sizes.

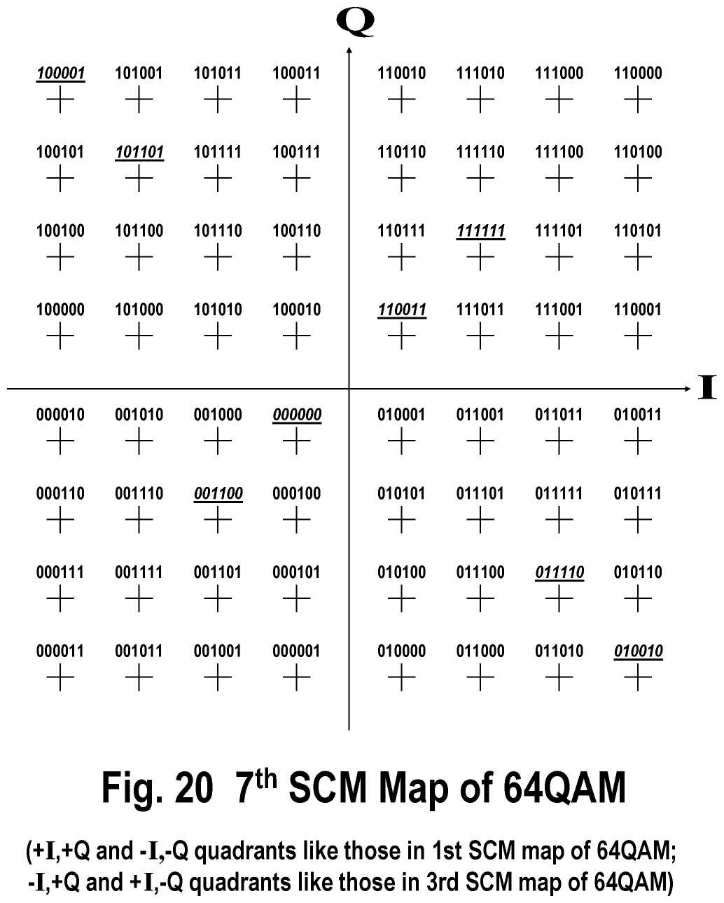

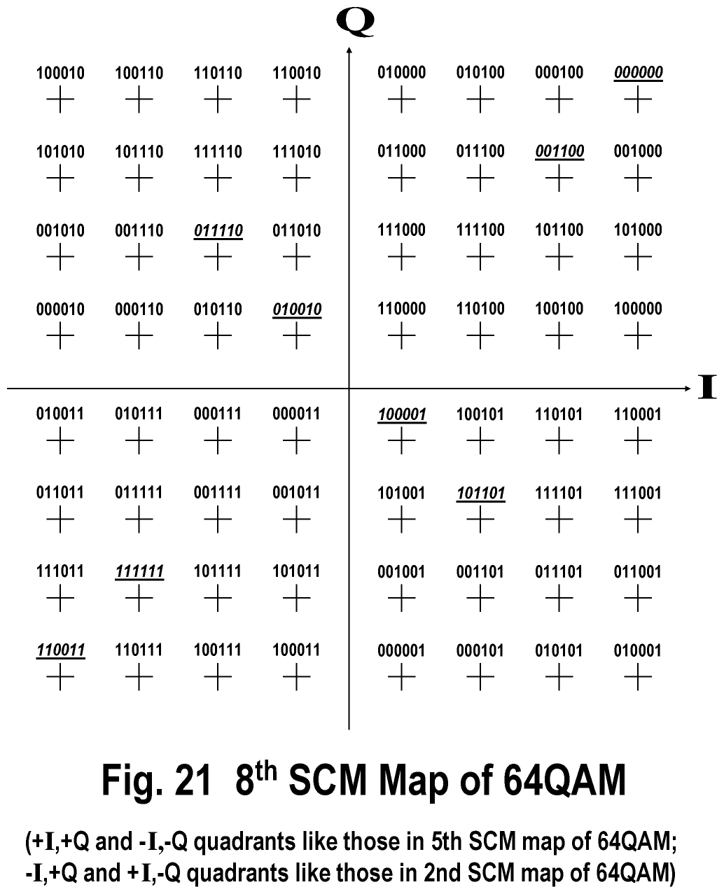

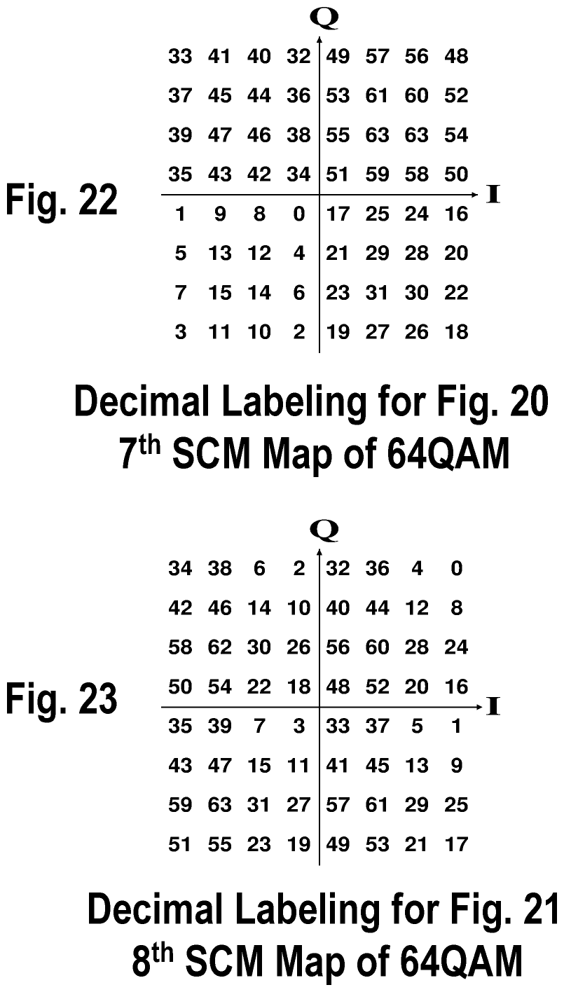

FIG. 20 and FIG. 21 are seventh and eighth SCM maps of 64QAM symbol constellations, respectively, which maps have preferred labeling diversity from each other. The FIG. 20 seventh SCM map of 64QAM is constructed by (a) using a −I,−Q quadrant and a +I,+Q quadrant similar to those in the FIG. 8 first SCM map of 64QAM and (b) using a −I,+Q quadrant and a +I, −Q quadrant similar to those in the FIG. 10 third SCM map of 64QAM. The FIG. 21 eighth SCM map of 64QAM is constructed by (a) using a −I,−Q quadrant and a +I,+Q quadrant similar to those in the FIG. 12 fifth SCM map of 64QAM and (b) using a −I,+Q quadrant and a +I, −Q quadrant similar to those in the FIG. 9 second SCM map of 64QAM. FIGS. 22 and 23 present decimal labeling for the FIG. 20 seventh SCM map of 64QAM and for the FIG. 21 eighth SCM map of 64QAM, respectively. Note that (a) the LPLs in the four outermost sub-quadrants of the FIG. 20 seventh SCM map of 64QAM appear in the four innermost sub-quadrants of the FIG. 21 eighth SCM map of 64QAM and (b) the LPLs in the four outermost sub-quadrants of the FIG. 21 eighth SCM map of 64QAM appear in the four innermost sub-quadrants of the FIG. 20 seventh SCM map of 64QAM. Accordingly, these seventh and eighth SCM maps of 64QAM support low PAPR in a DCM-COFDM signal employing them.

Variants of the seventh and eighth SCM maps of 64QAM depicted in FIG. 20 and FIG. 21 include quadrants similar to those in the FIG. 11 fourth and FIG. 13 sixth SCM maps of 64QAM symbol constellations, instead of quadrants similar to those in the FIG. 10 third and FIG. 12 fifth SCM maps of 64QAM symbol constellations. These variants of the seventh and eighth SCM maps of 64QAM also support low PAPR in a DCM-COFDM signal employing them.

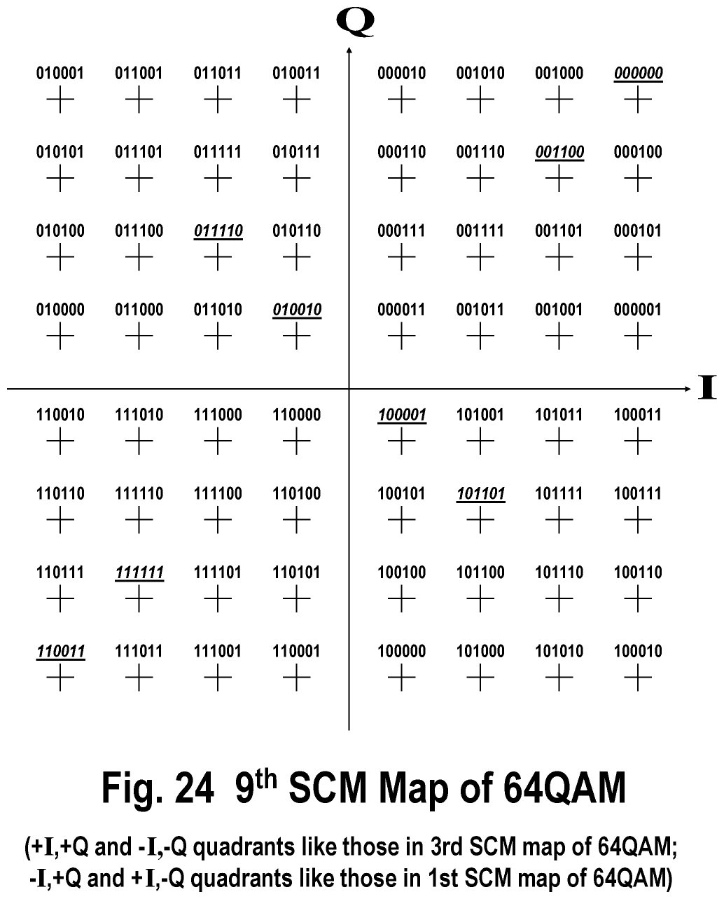

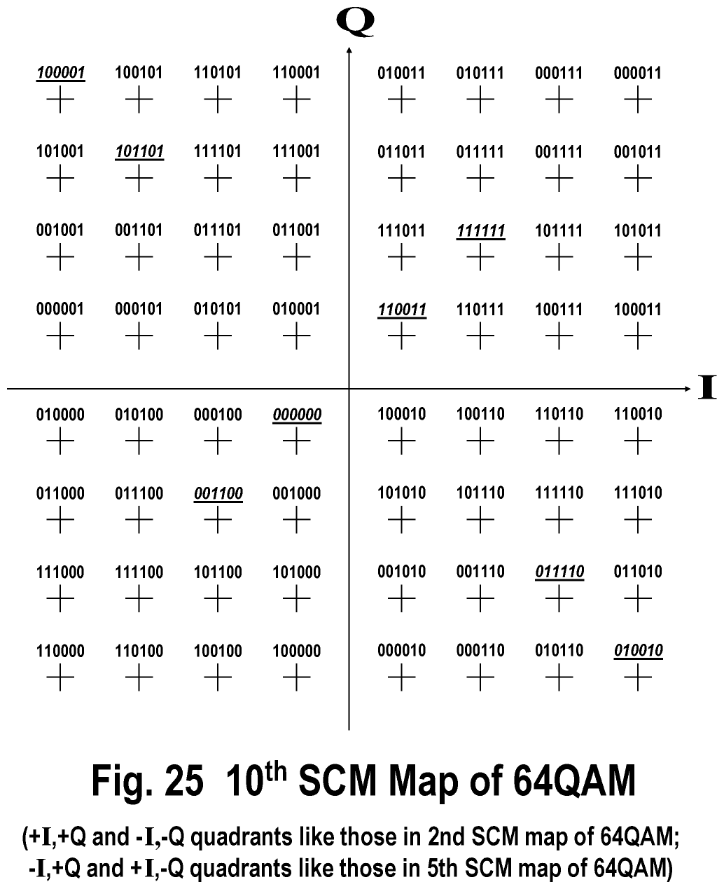

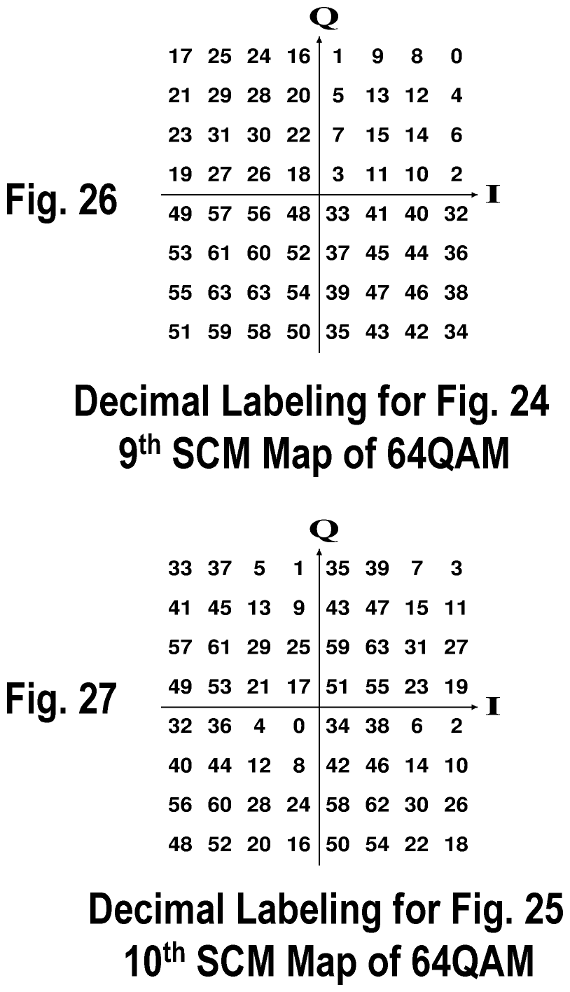

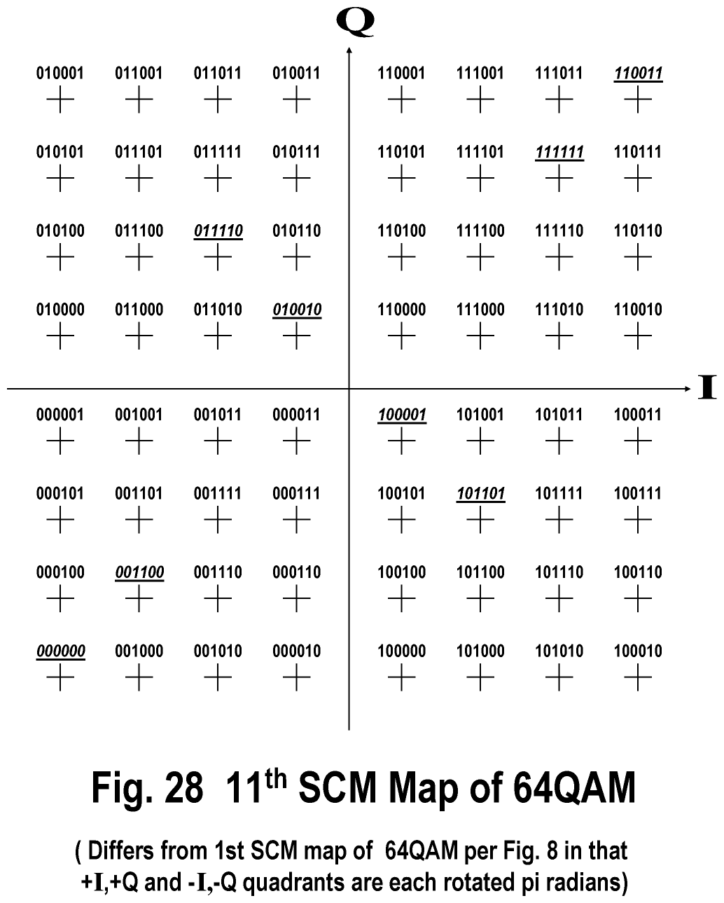

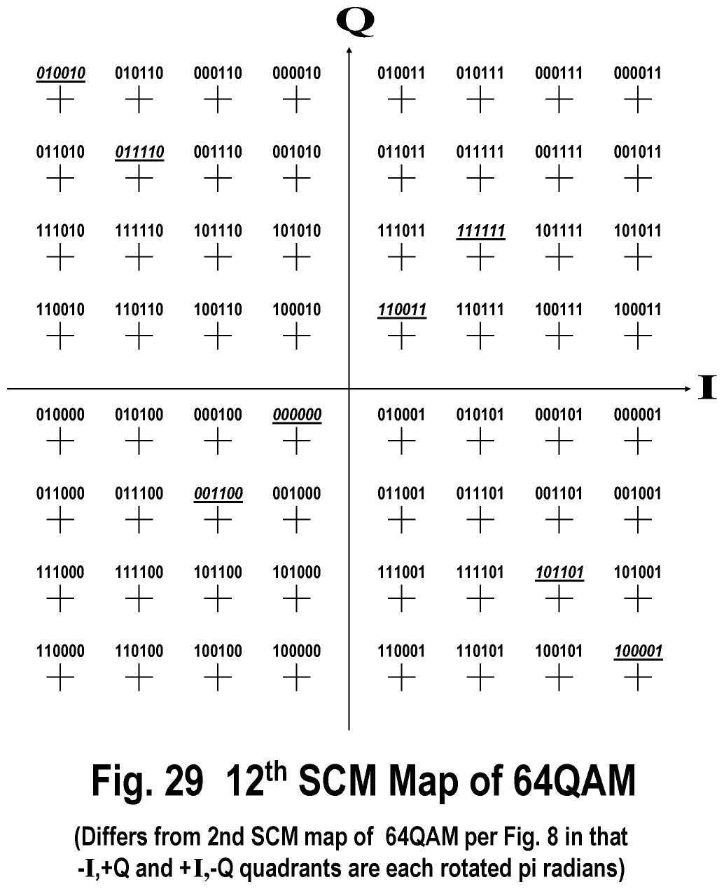

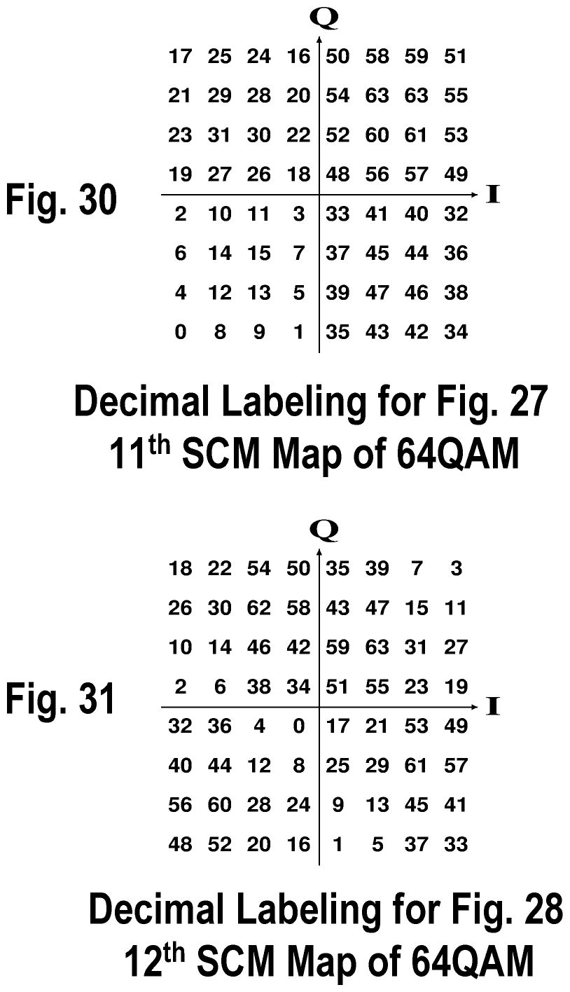

FIG. 24 and FIG. 25 are ninth and tenth SCM maps of 64QAM symbol constellations, respectively, which maps have preferred labeling diversity from each other. The FIG. 24 ninth SCM map of 64QAM is constructed by (a) using a −I,−Q quadrant and a +I,+Q quadrant similar to those in the FIG. 10 third SCM map of 64QAM and (b) using a −I,+Q quadrant and a +I, −Q quadrant similar to those in the FIG. 8 first SCM map of 64QAM. The FIG. 25 tenth SCM map of 64QAM is constructed by (a) using a −I,−Q quadrant and a +I,+Q quadrant similar to those in the FIG. 9 second SCM map of 64QAM and (b) using a −I,+Q quadrant and a +I, −Q quadrant similar to those in the FIG. 12 fifth SCM map of 64QAM. FIGS. 26 and 27 present decimal labeling for the FIG. 24 ninth SCM map of 64QAM and for the FIG. 25 tenth SCM map of 64QAM, respectively. Note that (a) the LPLs in the four outermost sub-quadrants of the FIG. 24 ninth SCM map of 64QAM appear in the four innermost sub-quadrants of the FIG. 25 tenth SCM map of 64QAM and (b) the LPLs in the four outermost sub-quadrants of the FIG. 25 tenth SCM map of 64QAM appear in the four innermost sub-quadrants of the FIG. 24 ninth SCM map of 64QAM. Accordingly, these ninth and tenth SCM maps of 64QAM support lower PAPR in a DCM-COFDM signal employing them.

Variants of the ninth and tenth SCM maps of 64QAM depicted in FIG. 24 and FIG. 25 include quadrants similar to those in the FIG. 11 fourth and FIG. 13 sixth SCM maps of 64QAM symbol constellations, instead of quadrants similar to those in the FIG. 10 third and FIG. 12 fifth SCM maps of 64QAM symbol constellations. These variants of the ninth and tenth SCM maps of 64QAM also support low PAPR in a DCM-COFDM signal employing them.

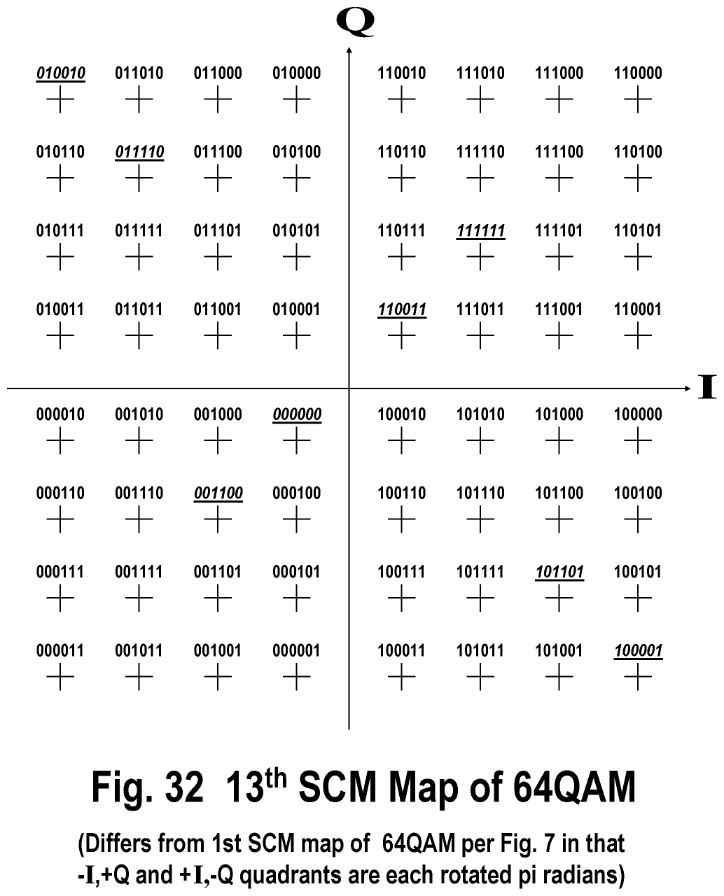

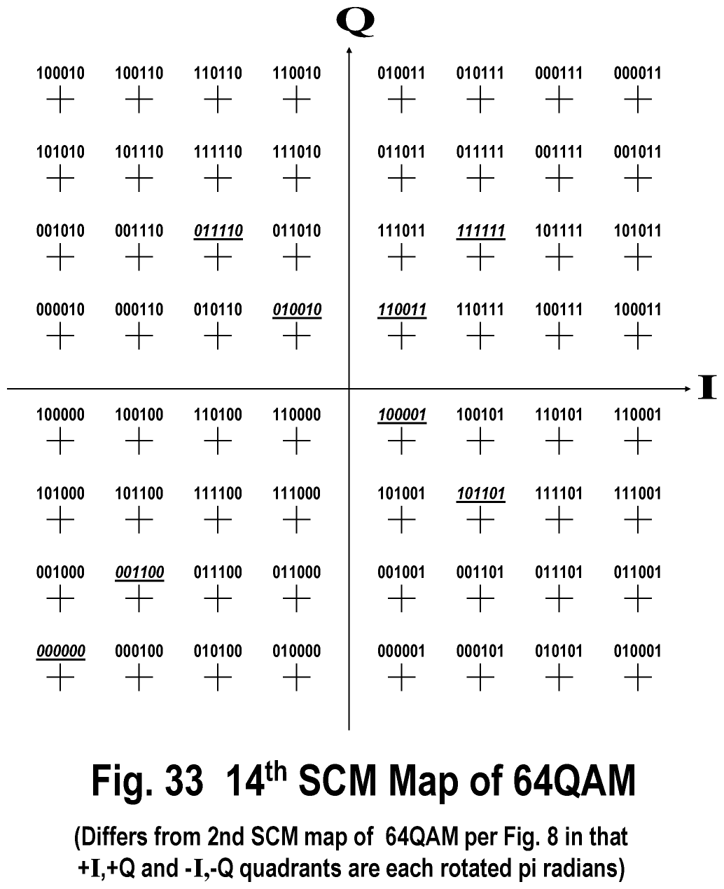

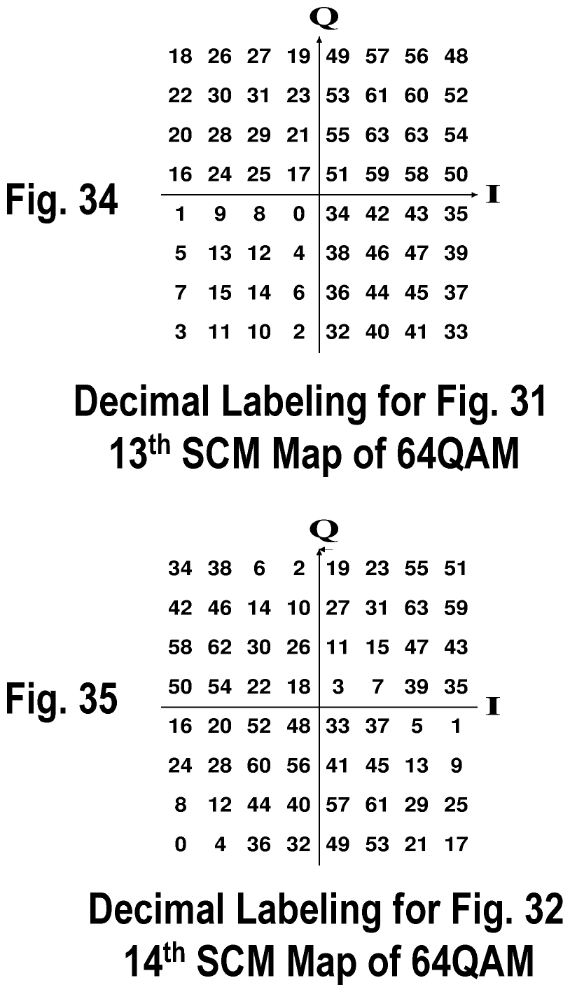

FIG. 28 and FIG. 29 are eleventh and twelfth SCM maps of 64QAM symbol constellations, respectively, which maps have preferred labeling diversity from each other. The FIG. 28 eleventh SCM map of 64QAM is constructed by (a) rotating the −I,−Q quadrant pi radians from that in the FIG. 8 first SCM map of 64QAM, (b) rotating the +I,+Q quadrant rotated pi radians from that in the FIG. 8 first SCM map of 64QAM, and (c) using a −I,+Q quadrant and a +I, −Q quadrant similar to those in the FIG. 8 first SCM map of 64QAM. The FIG. 29 twelfth SCM map of 64QAM is constructed by (a) using a −I,−Q quadrant and a +I,+Q quadrant similar to those in the FIG. 9 second SCM map of 64QAM, (b) rotating the −I,+Q quadrant from that in the FIG. 9 second SCM map of 64QAM, and (c) rotating the +I, −Q quadrant pi radians from that in the FIG. 9 second SCM map of 64QAM. FIGS. 30 and 31 present decimal labeling for the FIG. 28 eleventh SCM map of 64QAM and for the FIG. 29 twelfth SCM map of 64QAM, respectively. Note that (a) the LPLs in the four outermost sub-quadrants of the FIG. 28 eleventh SCM map of 64QAM appear in the four innermost sub-quadrants of the FIG. 29 twelfth SCM map of 64QAM and (b) the LPLs in the four outermost sub-quadrants of the FIG. 29 twelfth SCM map of 64QAM appear in the four innermost sub-quadrants of the FIG. 28 eleventh SCM map of 64QAM. Accordingly, these eleventh and twelfth SCM maps of 64QAM support low PAPR in a DCM-COFDM signal employing them.

FIG. 32 and FIG. 33 are thirteenth and fourteenth SCM maps of 64QAM symbol constellations, respectively, which maps have preferred labeling diversity from each other. The FIG. 32 thirteenth SCM map of 64QAM is constructed by (a) rotating the −I,+Q quadrant pi radians from that in the FIG. 8 first SCM map of 64QAM, (b) rotating the +I,−Q quadrant rotated pi radians from that in the FIG. 8 first SCM map of 64QAM, and (c) using a +I,+Q quadrant and a −I, −Q quadrant similar to those in the FIG. 8 first SCM map of 64QAM. The FIG. 33 fourteenth SCM map of 64QAM is constructed by (a) using a +I,+Q quadrant and a −I,−Q quadrant similar to those in the FIG. 9 second SCM map of 64QAM, (b) rotating the −I,+Q quadrant from that in the FIG. 9 second SCM map of 64QAM, and (c) rotating the +I, −Q quadrant pi radians from that in the FIG. 9 second SCM map of 64QAM. FIGS. 34 and 35 present decimal labeling for the FIG. 32 thirteenth SCM map of 64QAM and for the FIG. 33 fourteenth SCM map of 64QAM, respectively. Note that (a) the LPLs in the four outermost sub-quadrants of the FIG. 32 thirteenth SCM map of 64QAM appear in the four innermost sub-quadrants of the FIG. 33 fourteenth SCM map of 64QAM and (b) the LPLs in the four outermost sub-quadrants of the FIG. 33 fourteenth SCM map of 64QAM appear in the four innermost sub-quadrants of the FIG. 32 thirteenth SCM map of 64QAM. Accordingly, these thirteenth and fourteenth SCM maps of 64QAM support low PAPR in a DCM-COFDM signal employing them.

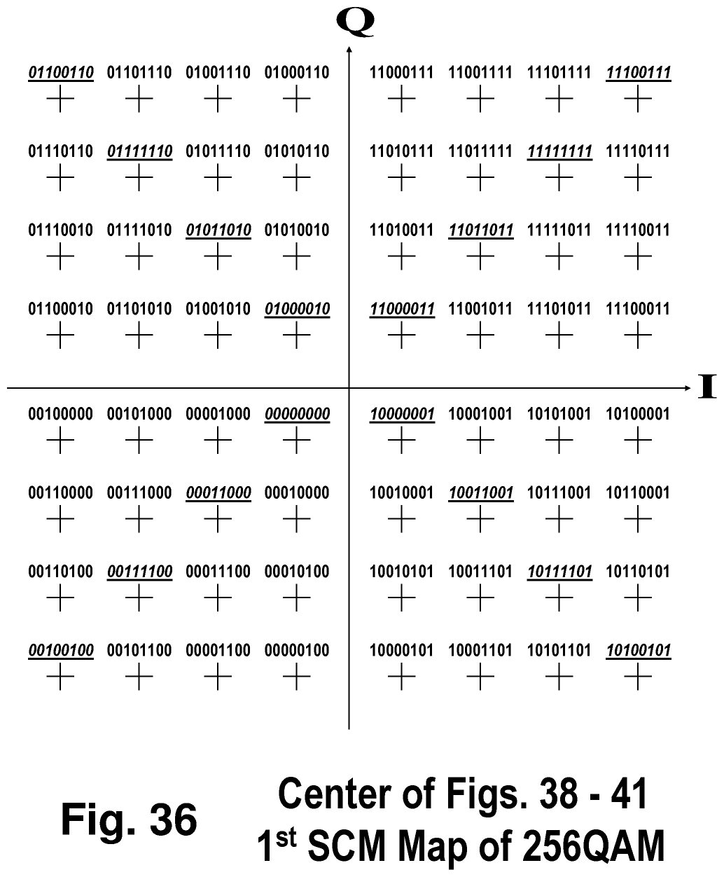

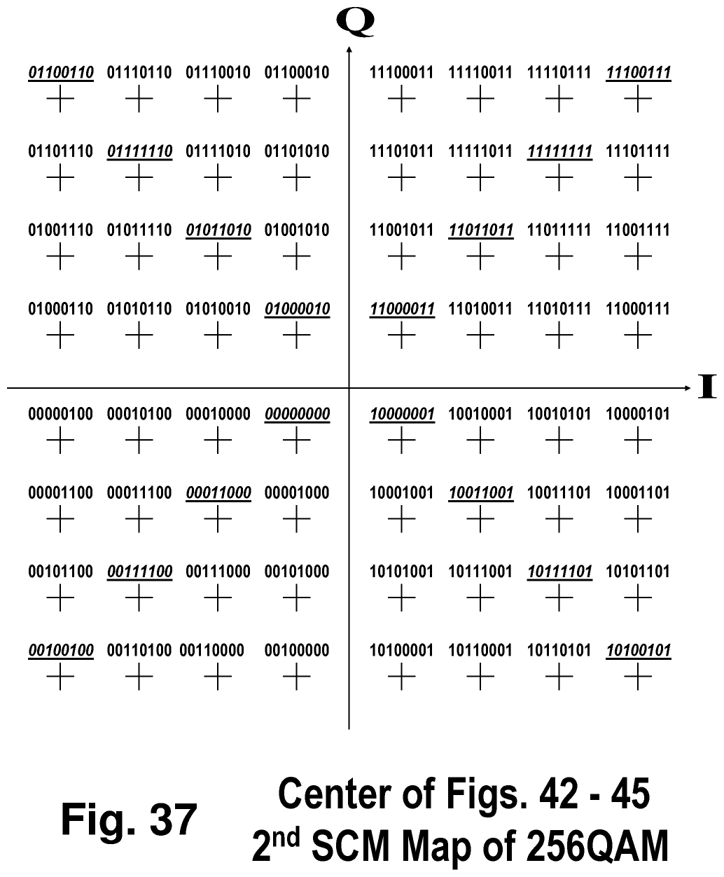

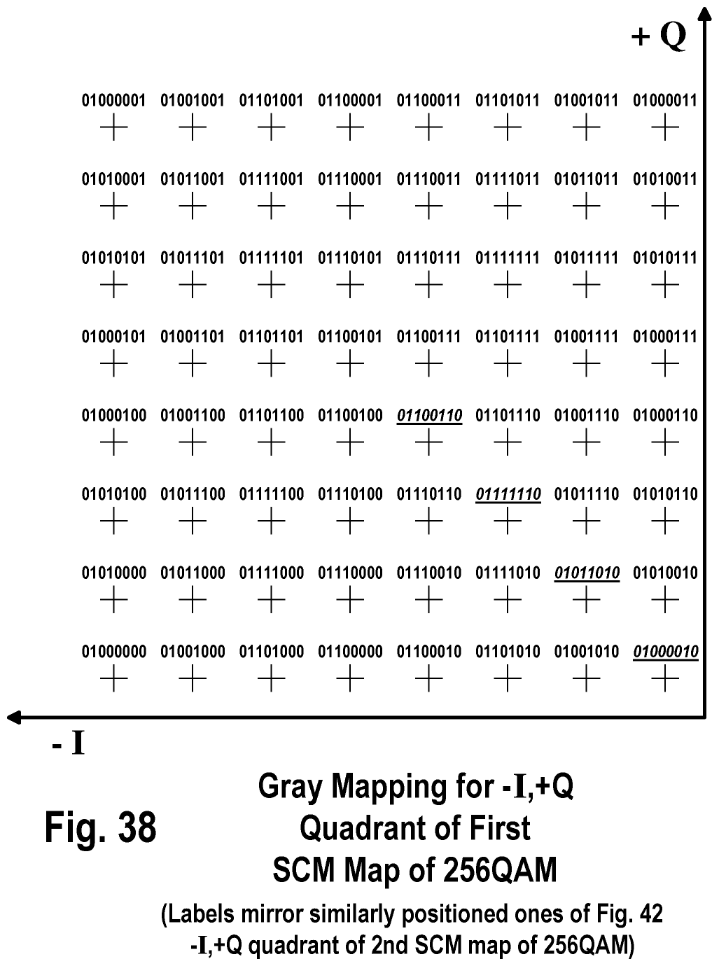

FIG. 36 depicts the central portion of a first SCM map of square 256QAM symbol constellations depicted in full in FIGS. 38, 39, 40 and 41. FIG. 37 depicts the central portion of a second SCM map of square 256QAM symbol constellations depicted in full in FIGS. 42, 43, 44 and 45. The LPLs in each of these first and second SCM maps of 256QAM mirror the correspondingly positioned LPLs in the other of these SCM maps, insofar as order of bits in them is concerned. So, palindromic LPLs will be similarly positioned in both of these SCM maps. One of these first and second SCM maps of 256QAM is directly employed by one of the QAM mappers 71 and 72 in a physical layer pipe in some DCM-COFDM transmitter apparatuses embodying aspects of the invention. The other of the first and second SCM maps of 256QAM is not directly employed by either of the QAM mappers 71 and 72 QAM mappers 71 and 72, but provides the basis from which a further SCM map of 25 4QAM is derived. This further SCM map of 256QAM is directly employed by the other of the QAM mappers 71 and 72, the QAM mapper that does not directly employ either of the first and second SCM maps of 64QAM.

The palindromic label 00000000 is applied to the lattice point located in the innermost corner of the −I,−Q quadrant in each of the first and second SCM maps of 256QAM. The palindromic labels 01000010, 11000011 and 10000001 are applied sequentially to successive lattice points located diagonally next within that −I,−Q quadrant. The 00100100 label is applied to the lattice point located in the innermost corner of the −I,+Q quadrant in each of the first and second SCM maps of 256QAM. The palindromic labels 01100110, 11100111 and 10100101 are applied sequentially to successive lattice points located diagonally next within that −I,+Q quadrant. The 00111100 label is applied to the lattice point located in the innermost corner of the +I,+Q quadrant in each of the first and second SCM maps of 256QAM. The palindromic labels 01111110, 11111111 and 10111101 are applied sequentially to successive lattice points located diagonally next within that +I,+Q quadrant. The 00011000 label is applied to the lattice point located in the innermost corner of the +I,−Q quadrant in each of the first and second SCM maps of 256QAM. The palindromic labels 01011010, 11011011 and 10011001 are applied sequentially to successive lattice points located diagonally next within that +I,−Q quadrant.

In an SCM map of 256QAM there are 64 lattice points in each quadrant and 16 lattice points in each of the four sub-quadrants within a quadrant. I. e., the quadrant considered as a bin for LPLs has eight columns and eight rows of them, twice the number of columns and twice the number of rows as a sub-quadrant.

FIGS. 38, 39, 40 and 41 depict respective quadrants of the first SCM map of square 256QAM symbol constellations. When reading an LPL of the first SCM map of 256QAM from left to right, the odd-occurring bits relate to the column of lattice points wherein resides the lattice point that LPL describes, and the even-occurring bits relate to the row of lattice points wherein resides the lattice point that LPL describes. In the Gray mapping of each quadrant of the first SCM map of 256QAM, the leftmost two bits of LPLs identify that particular quadrant within which the lattice points are located, and the rightmost two bits of LPLs specify which of four sub-quadrants within that particular quadrant each lattice point is located within.

FIGS. 42, 43, 44 and 45 depict respective quadrants of the second SCM map of square 256QAM symbol constellations. When reading an LPL of the second SCM map of 256QAM from left to right, the odd-occurring bits relate to the row of lattice points wherein resides the lattice point that LPL describes, and the even-occurring bits relate to the column of lattice points wherein resides the lattice point that LPL describes. In the Gray mapping of each quadrant of the second SCM map of 256QAM, the rightmost two bits of LPLs identify that particular quadrant within which the lattice points are located, and the leftmost two bits of LPLs specify which of four sub-quadrants within that particular quadrant each lattice point is located within.

Maximal ratio combining (MRC) of the leftmost pairs of bits in corresponding LPLs from the first and second SCM maps of 256QAM results in pairs of bits with lowest likelihood of being in error caused by each of the dual-mapped 256QAM signal being accompanied by a same reasonably low level of AWGN. MRC of the rightmost pairs of bits in corresponding LPLs from the first and second SCM maps of 256QAM results in pairs of bits with similar lowest likelihood of being in error caused by each of the dual-mapped 256QAM signals being accompanied by that same reasonably low level of AWGN. These similar lowest likelihoods of error, caused by accompanying AWGN of prescribed reasonably low level, will be lower than the likelihood of the pair of bits descriptive of the quadrants of individually mapped 16QAM signals being in error caused by accompanying AWGN of that prescribed reasonably low level.

The bits three-in-from-left within the LPLs of the first SCM map of 256QAM relate to bins four columns wide in which the LPLs reside. The bits three-in-from-left within the LPLs of the second SCM map of 256QAM relate to bins two rows deep in which the LPLs reside. MRC of the pairs of three-in-from-left bits in corresponding LPLs from the first and second SCM maps of 256QAM results in bits with BER caused by AWGN that is similar to, albeit perhaps somewhat smaller than, the BER of the bits in SCM-mapped 16QAM that relate to the sub-quadrants in which LPLs reside. These BERs are not as small as the BERs of any of the bits in Gray-mapped 16QAM, however, all of which bits have similar likelihood of error caused by AWGN of reasonably low level.

The bits four-in-from-left within the LPLs of the first SCM map of 256QAM relate to bins two rows deep in which the LPLs reside. The bits four-in-from-left within the LPLs of the second SCM map of 256QAM relate to bins four columns wide in which the LPLs reside. MRC of the pairs of four-in-from-left bits in corresponding LPLs from the first and second SCM maps of 256QAM results in bits with BER caused by AWGN that is similar to, albeit perhaps somewhat smaller than, the BER of the bits in SCM-mapped 16QAM that relate to the sub-quadrants in which LPLs reside. These BERs are not as small as the BERs of the bits in Gray-mapped 16QAM, though.

The bits four-in-from-right within the LPLs of the first SCM map of 256QAM relate to bins two columns wide in which the LPLs reside. The bits four-in-from-right within the LPLs of the second SCM map of 256QAM relate to bins four rows deep in which the LPLs reside. MRC of the pairs of four-in-from-right bits in corresponding LPLs from the first and second SCM maps of 256QAM results in bits with BER caused by AWGN that is similar to, albeit perhaps somewhat smaller than, the BER of the bits in SCM-mapped 16QAM that relate to the sub-quadrants in which LPLs reside. These BERs are not as small as the BERs of the bits in Gray-mapped 16QAM, though.

The bits three-in-from-right within the LPLs of the first SCM map of 256QAM relate to bins four rows deep in which the LPLs reside. The bits three-in-from-right within the LPLs of the second SCM map of 256QAM relate to bins two columns wide in which the LPLs reside. MRC of the pairs of three-in-from-right bits in corresponding LPLs from the first and second SCM maps of 256QAM results in bits with BER caused by AWGN that is similar to, albeit perhaps somewhat smaller than, the BER of the bits in SCM-mapped 16QAM that relate to the sub-quadrants in which LPLs reside. These BERs are not as small as the BERs of the bits in Gray-mapped 16QAM, though.

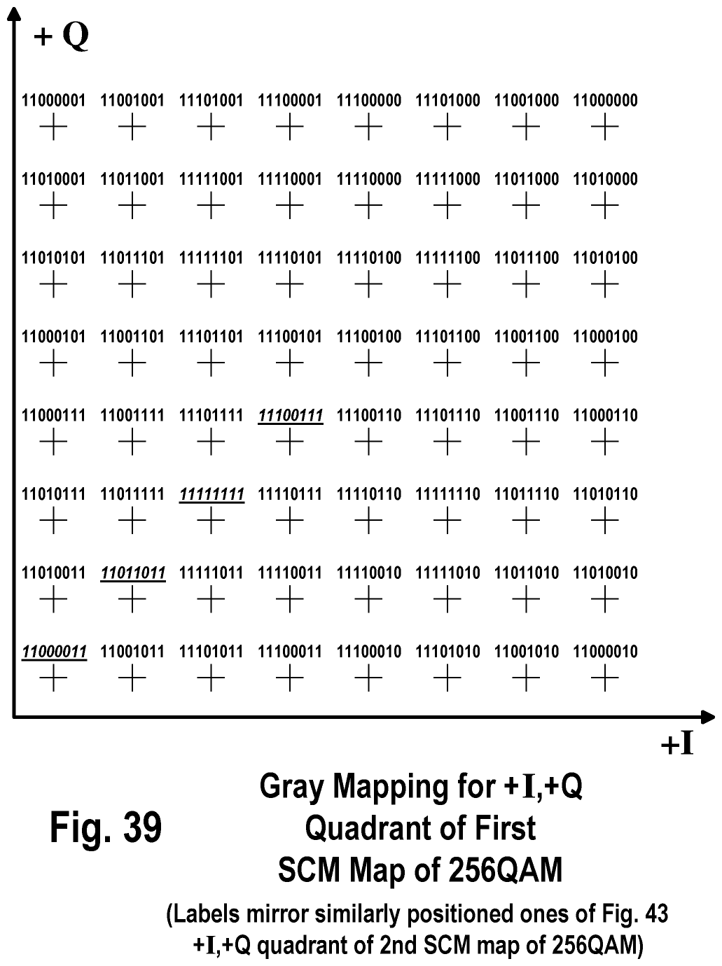

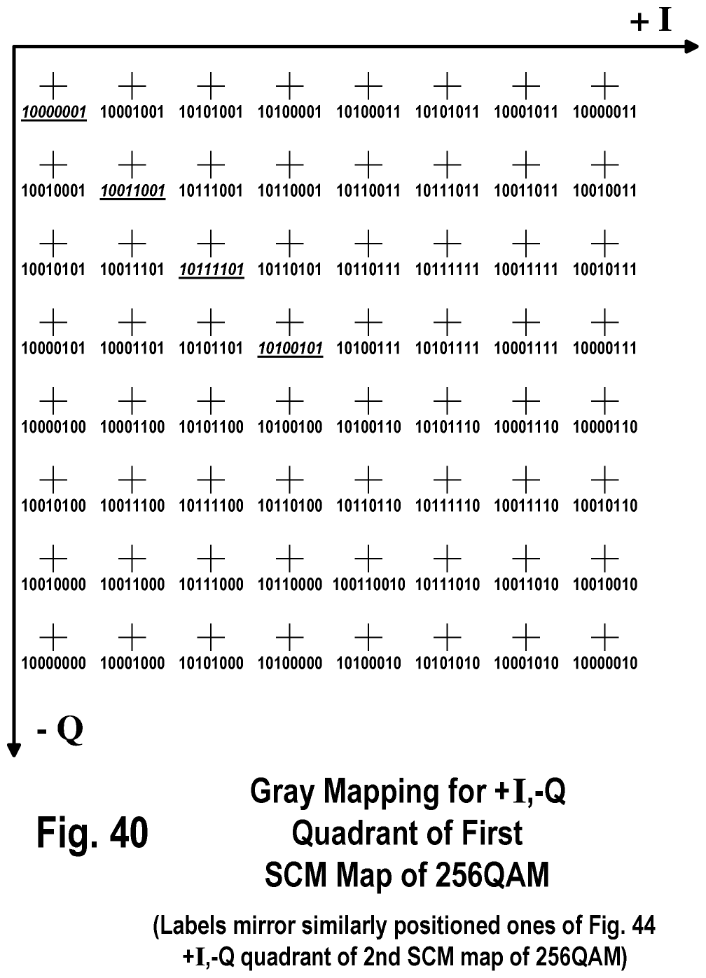

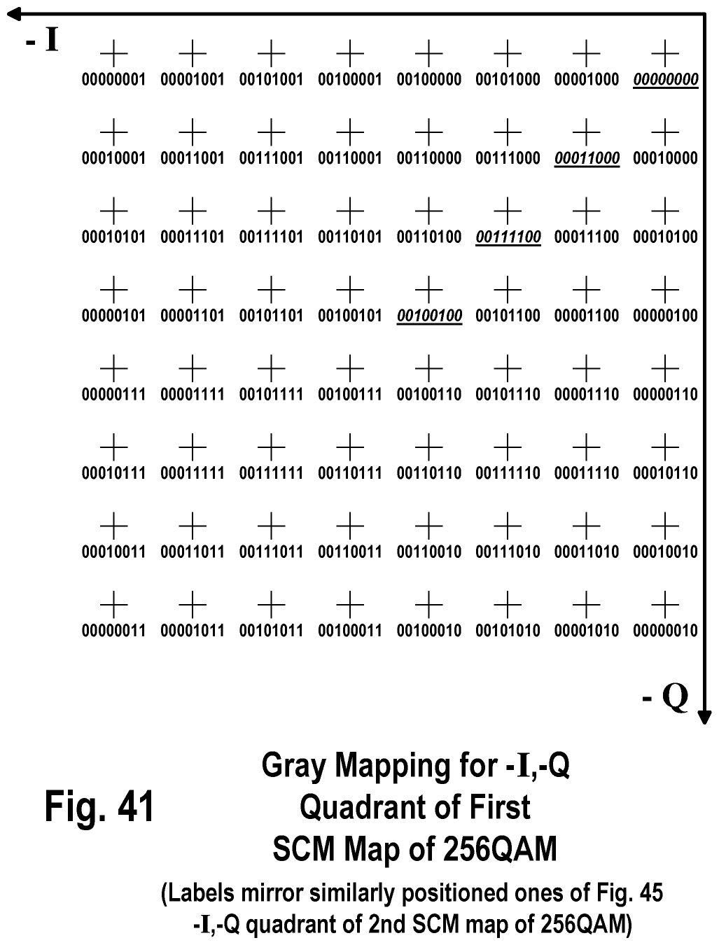

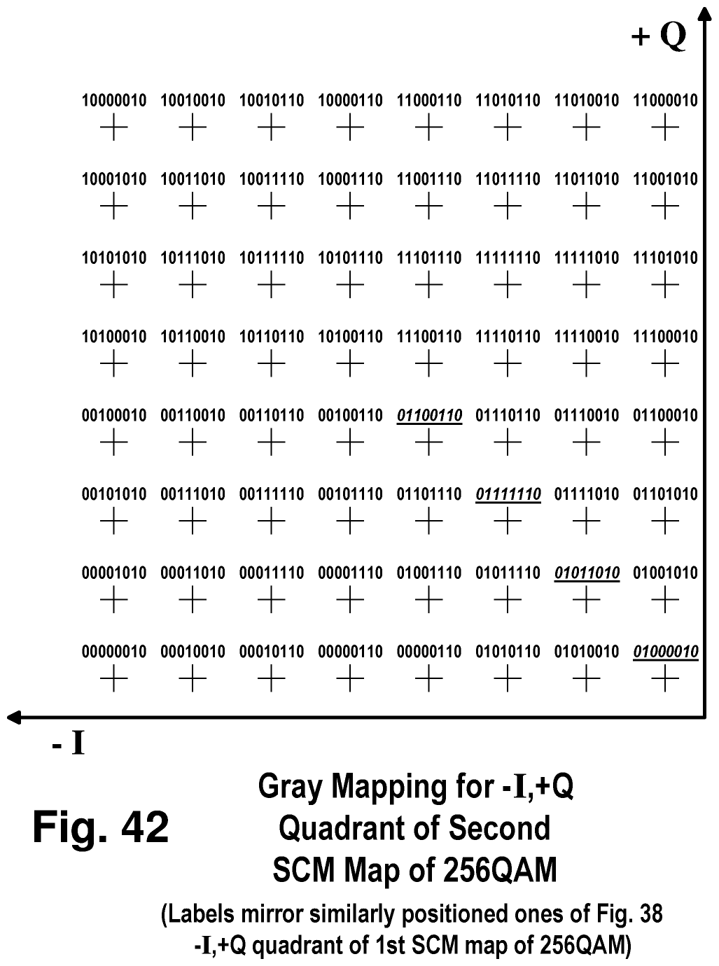

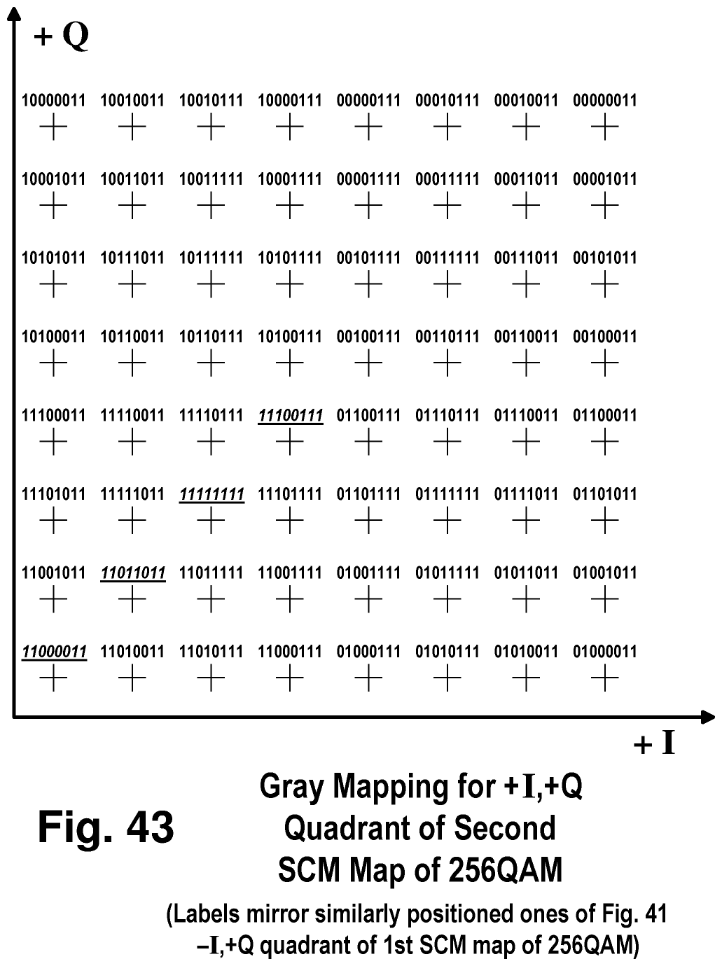

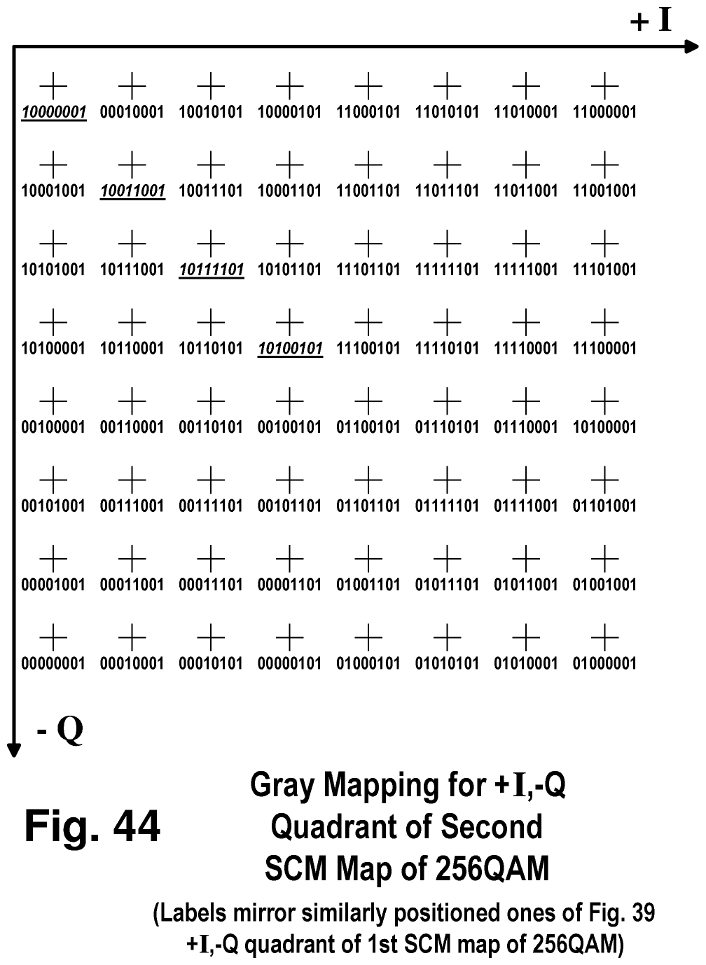

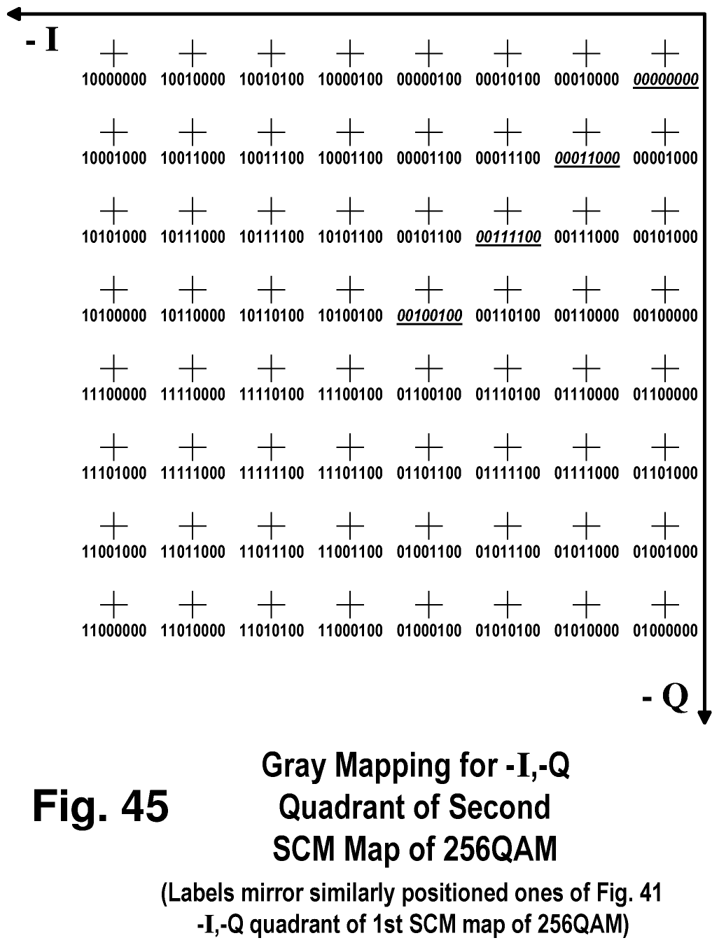

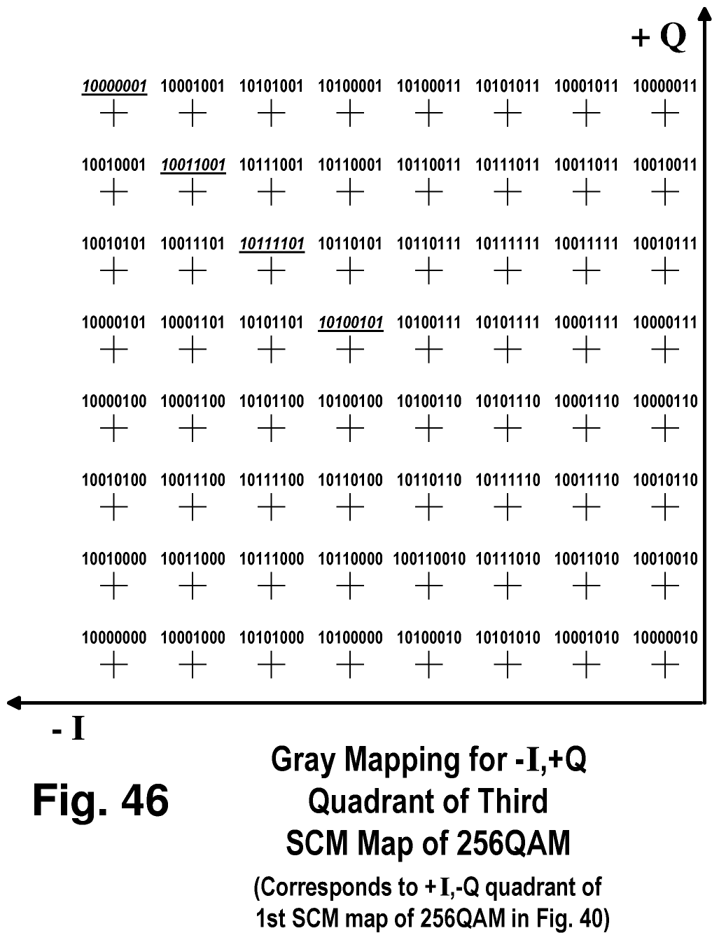

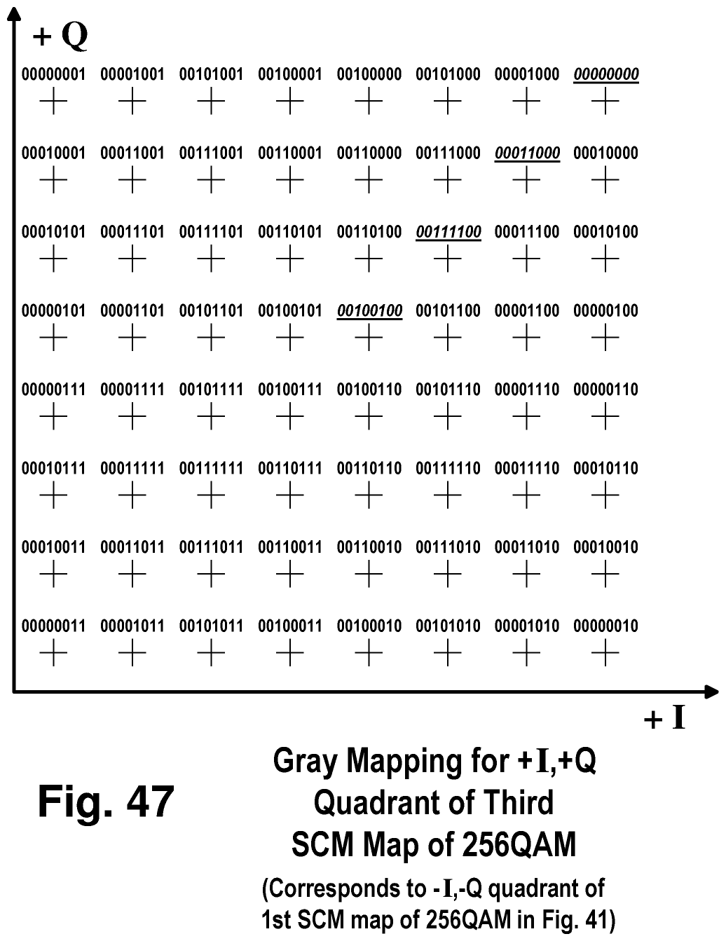

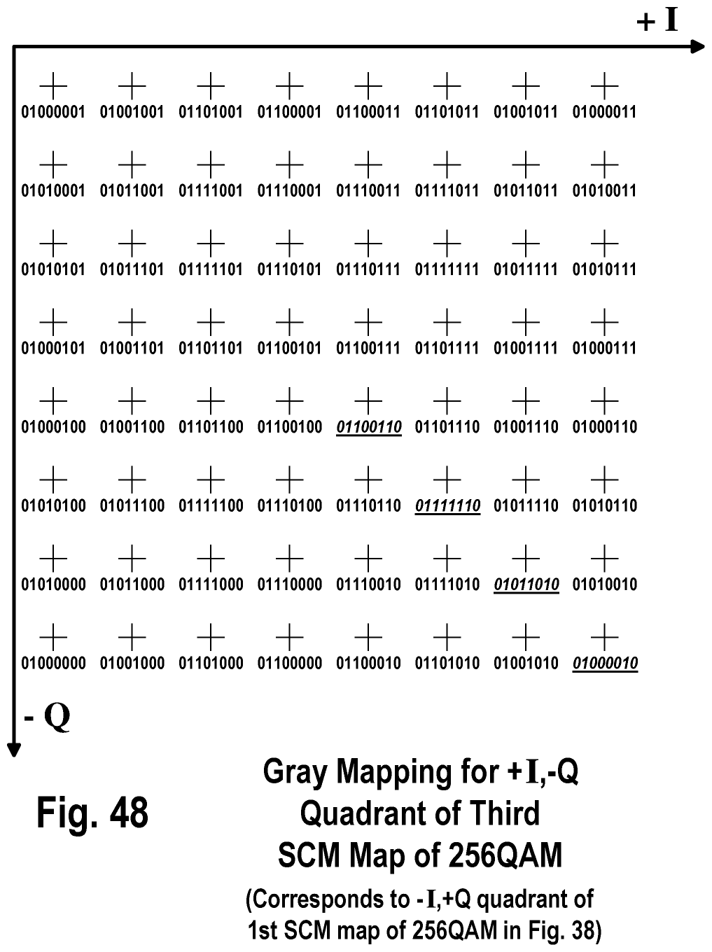

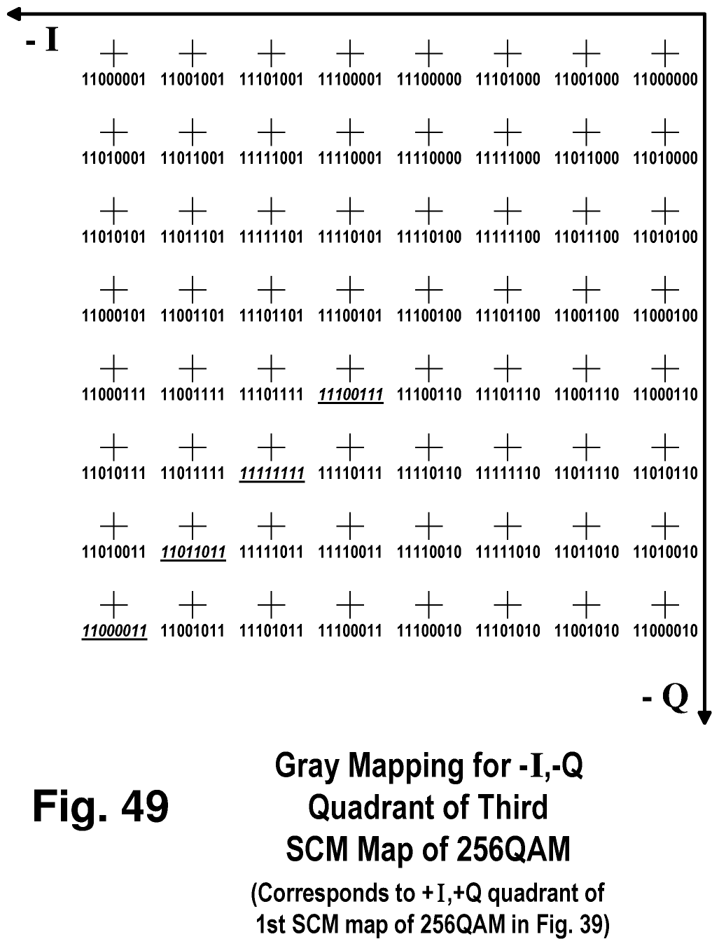

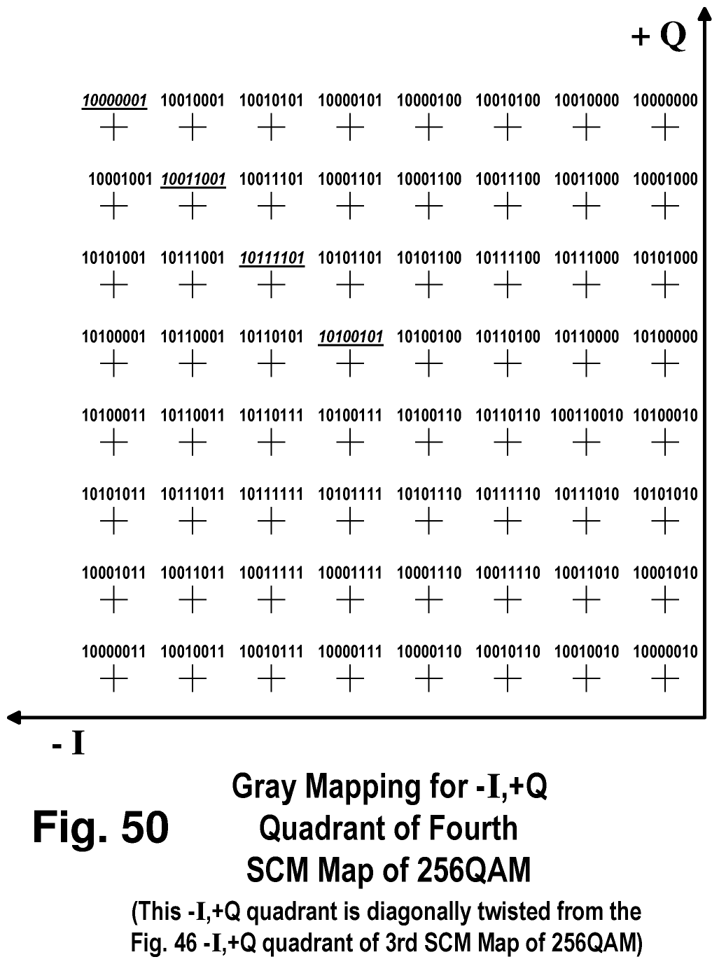

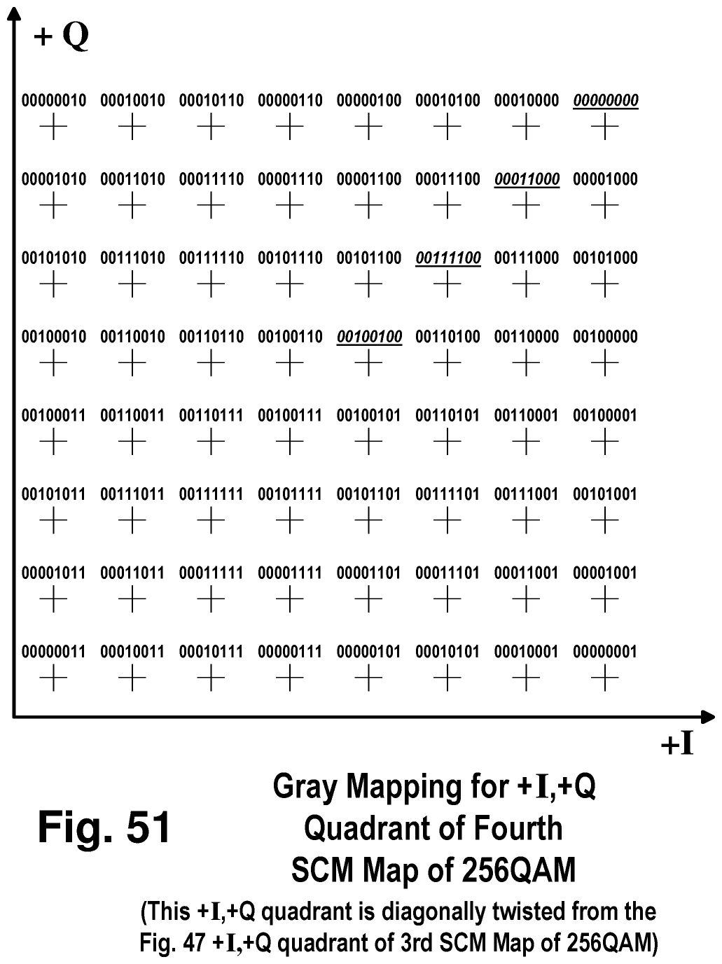

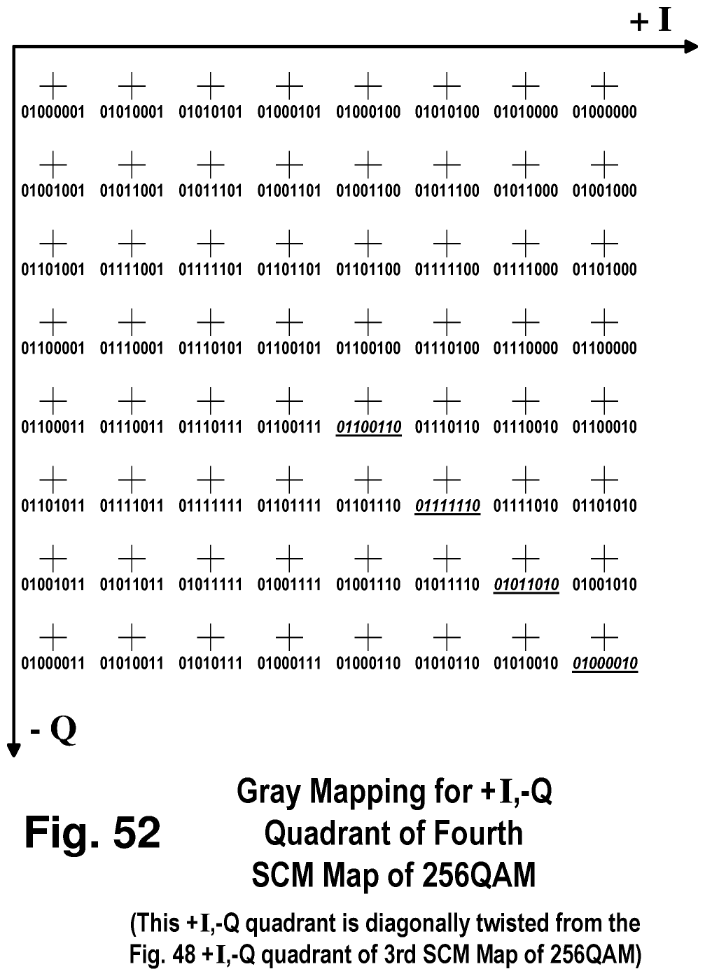

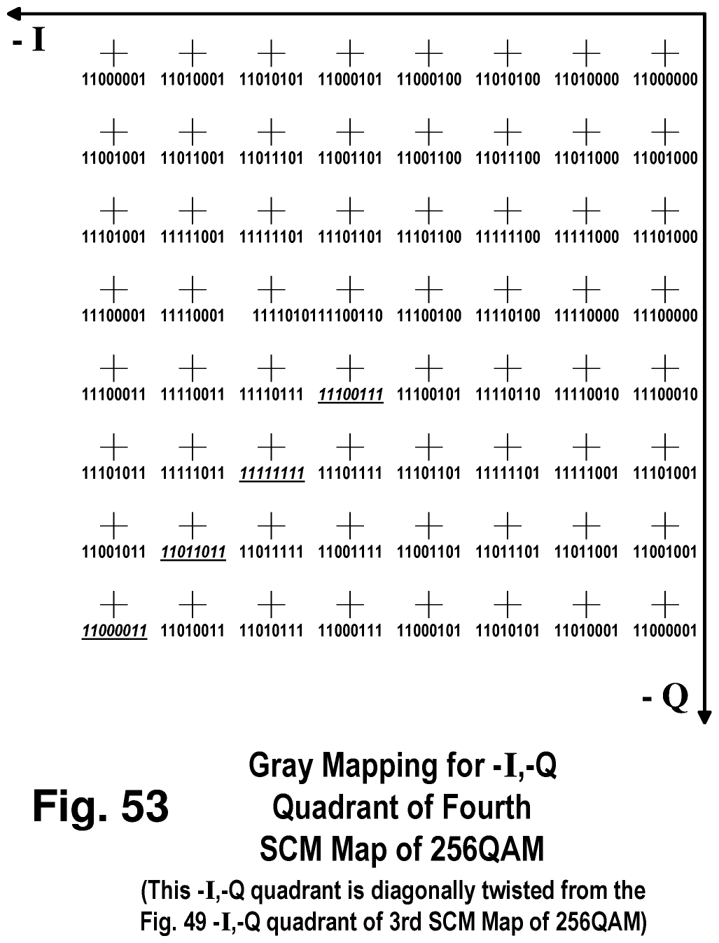

FIGS. 46, 47, 48 and 49 depict respective quadrants of a third SCM map of square 256QAM symbol constellations. The lattice points in the FIG. 46 −I,+Q quadrant of the third SCM map of 256QAM are labeled like correspondingly positioned lattice points in the FIG. 40 +I, −Q quadrant of the first SCM map of 256QAM. The lattice points in the FIG. 47 +I,+Q quadrant of the third SCM map of 256QAM are labeled like correspondingly positioned lattice points in the FIG. 41 −I,−Q quadrant of the first SCM map of 256QAM. The lattice points in the FIG. 48 +I, −Q quadrant of the third SCM map of 256QAM are labeled like correspondingly positioned lattice points in the FIG. 38 −I,+Q quadrant of the first SCM map of 256QAM. The lattice points in the FIG. 47 −I,−Q quadrant of the third SCM map of 256QAM are labeled like correspondingly positioned lattice points in the FIG. 39 +I,+Q quadrant of the first SCM map of 256QAM.

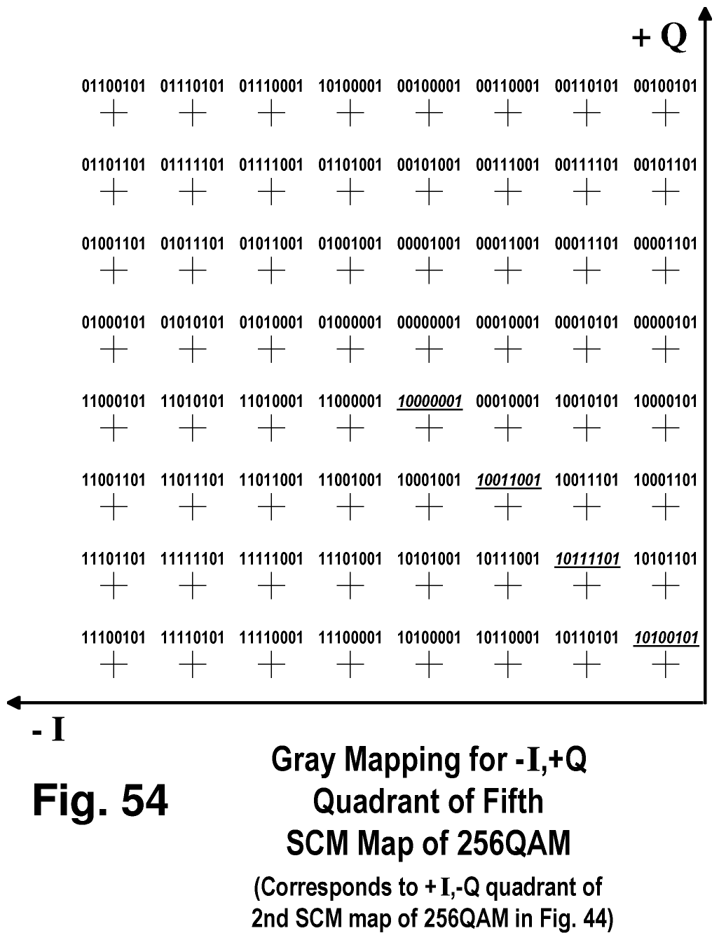

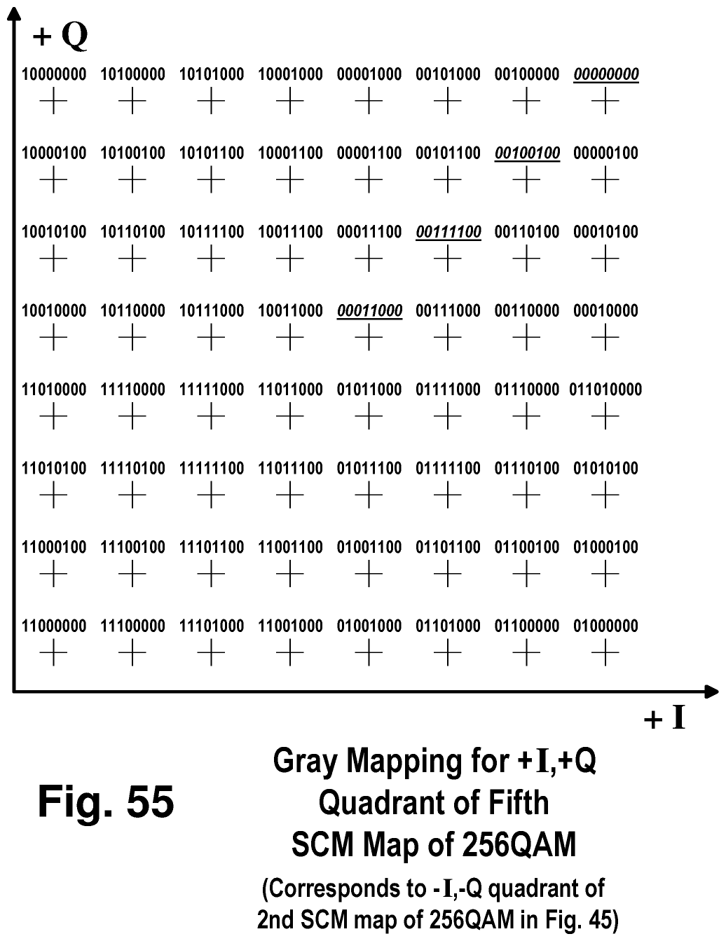

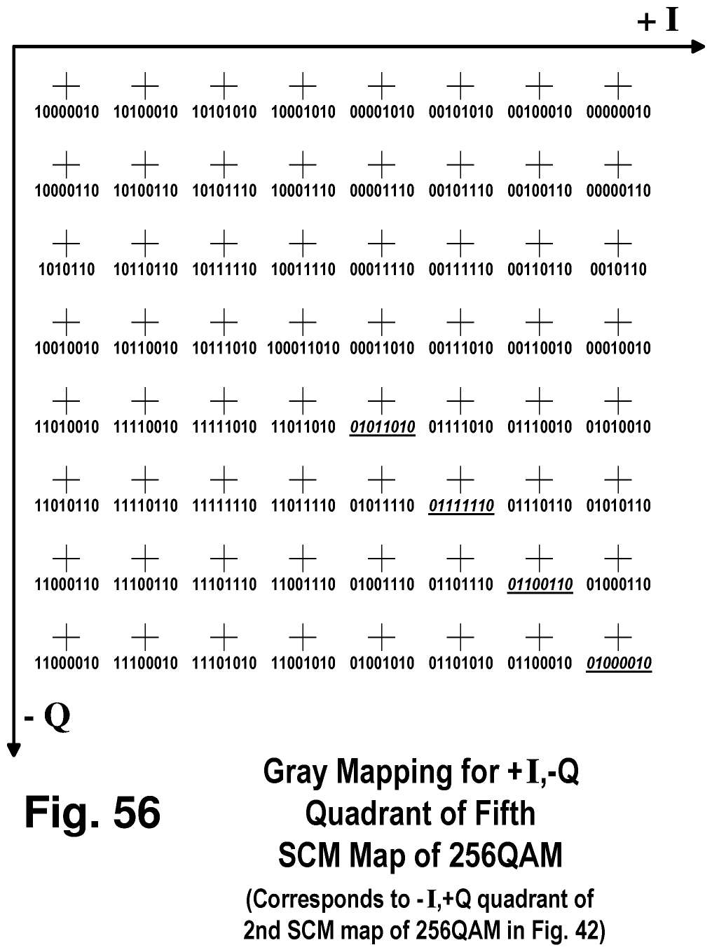

FIGS. 50, 51, 52 and 53 depict respective quadrants of a fourth SCM map of square 256QAM symbol constellations. The LPLs in the quadrants of FIGS. 50, 51, 52 and 53 are diagonally twisted from the LPLs in the quadrants of the third SCM map of 256QAM respectively depicted in FIGS. 46, 47, 48 and 49.

Using either of the third or fourth SCM maps of 256QAM together with the first SCM map of 256QAM to provide labeling diversity for DCM supports a 2.99 dB reduction in PAPR. However, SNR for reception over an AWGN channel will not be as good as for using the same SCM mapping of 16QAM for the DCM (though no more than 3 dB worse). Similar results obtain using either of the third or fourth SCM maps of 256QAM together with a seventh SCM map of 256QAM to provide labeling diversity for DCM, which seventh SCM map of 256QAM reverses the orders of palindromic LPLs in each quadrant from the orders of palindromic LPLs in corresponding quadrants of the first SCM map of 256QAM. Gray mapping of each of the quadrants in the seventh SCM map of 256QAM suits the reversed order of palindromic labels in its innermost sub-quadrant.

Using either of the third or fourth SCM maps of 256QAM together with the second map of 256QAM to provide labeling diversity for DCM supports a 2.99 dB reduction in PAPR also, but the SNR for reception over an AWGN channel will be significantly improved. Similar results obtain using either of the third or fourth SCM maps of 256QAM together with an eighth SCM map of 256QAM to provide labeling diversity for DCM, which eighth SCM map of 256QAM reverses the orders of palindromic LPLs in each quadrant from the orders of palindromic LPLs in corresponding quadrants of the second SCM map of 256QAM. Gray mapping of each of the quadrants in the eighth SCM map of 256QAM suits the reversed order of palindromic labels in its innermost sub-quadrant.

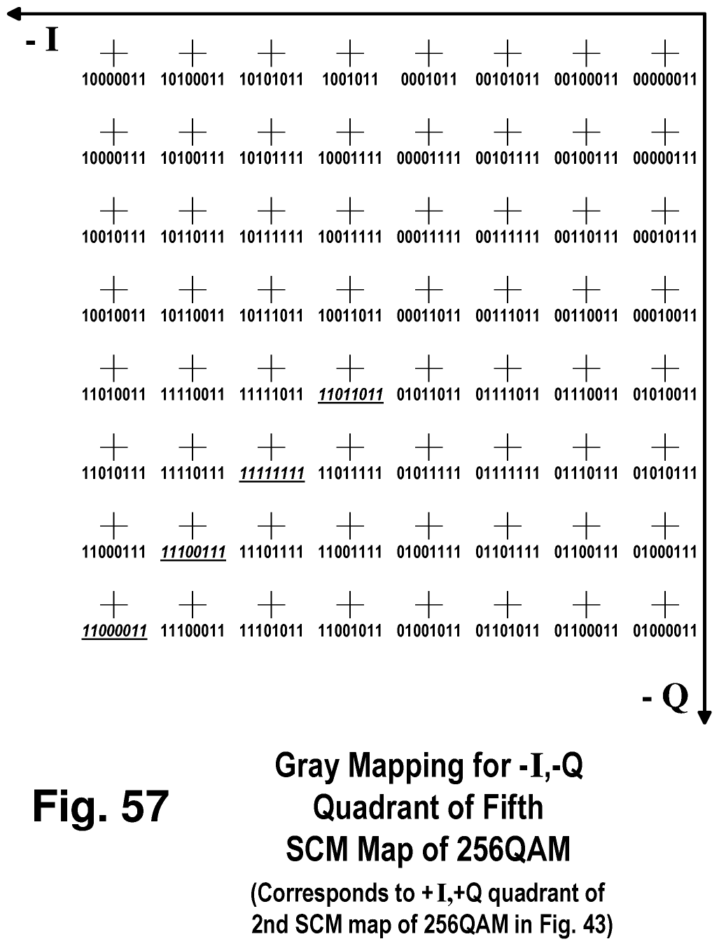

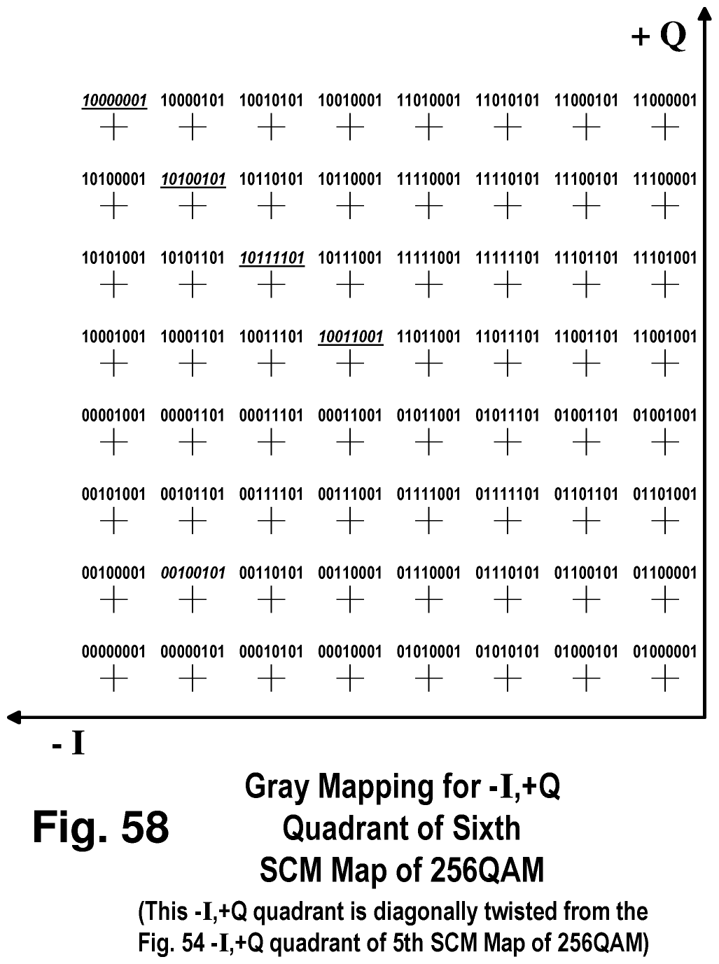

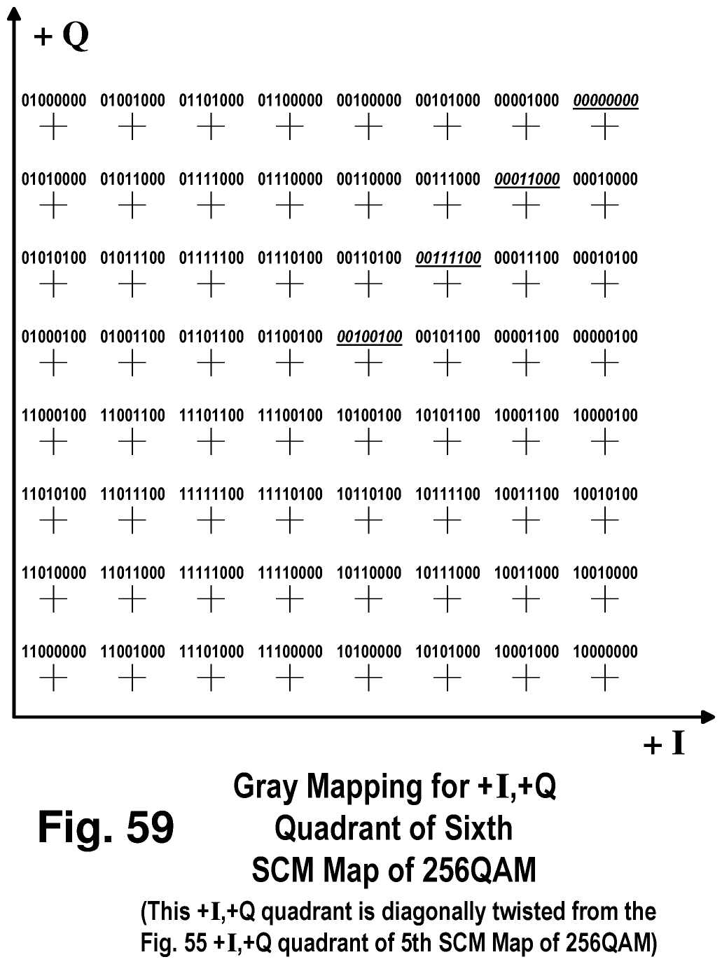

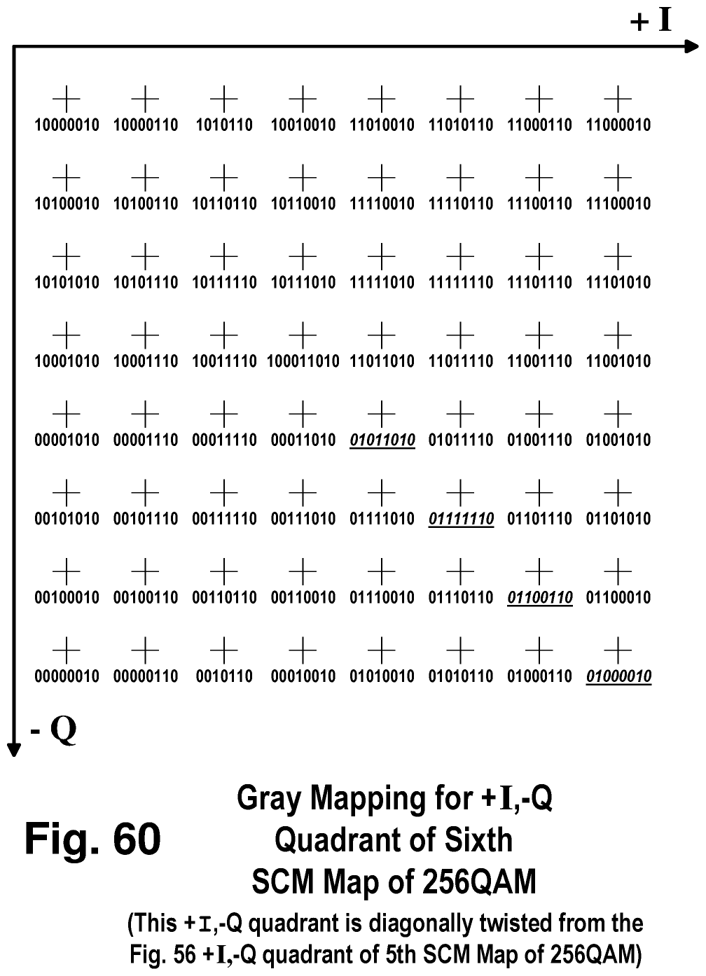

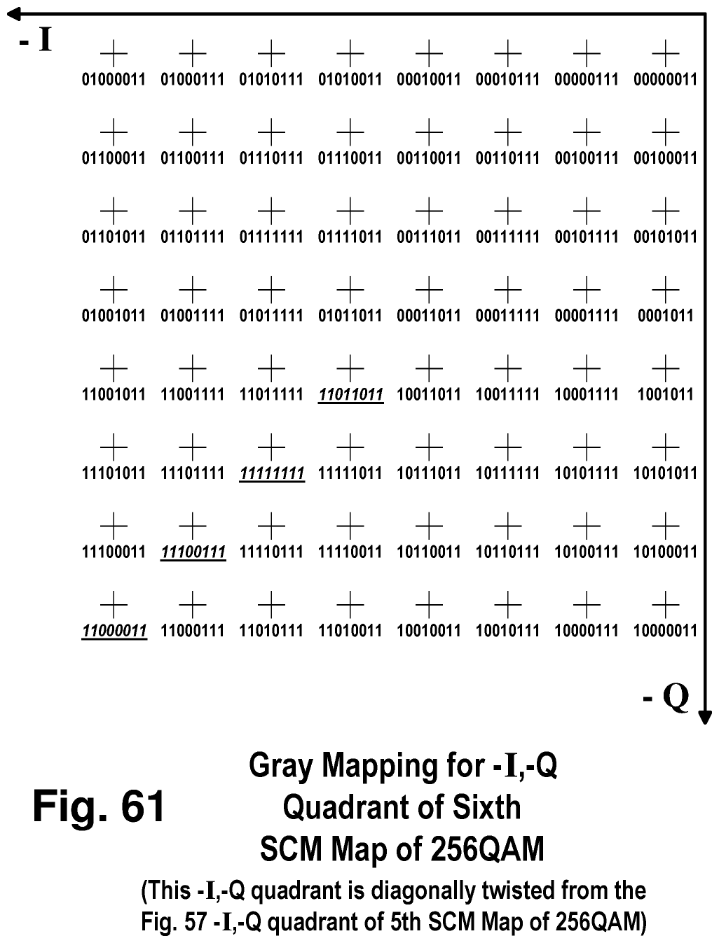

FIGS. 54, 55, 56 and 57 depict respective quadrants of a fifth SCM map of square 256QAM symbol constellations. The lattice points in the FIG. 54 −I,+Q quadrant of the SCM map of 256QAM are labeled like correspondingly positioned lattice points in the FIG. 44 +I, −Q quadrant of the second SCM map of 256QAM. The lattice points in the FIG. 55 +I,+Q quadrant of the fifth SCM map of 256QAM are labeled like correspondingly positioned lattice points in the FIG. 45 −I,−Q quadrant of the second SCM map of 256QAM. The lattice points in the FIG. 56 +I, −Q quadrant of the fifth SCM map of 256QAM are labeled like correspondingly positioned lattice points in the FIG. 42 −I,+Q quadrant of the second SCM map of 256QAM. The lattice points in the FIG. 57 −I,−Q quadrant of the fifth SCM map of 256QAM are labeled like correspondingly positioned lattice points in the FIG. 43 +I,+Q quadrant of the second SCM map of 256QAM.

FIGS. 58, 59, 60 and 61 depict respective quadrants of a sixth Gray map of square 256QAM symbol constellations. The LPLs in the quadrants of FIGS. 58, 59, 60 and 61 are diagonally twisted from the LPLs in the quadrants of the fifth Gray map of 256QAM respectively depicted in FIGS. 54, 55, 56 and 57.

Using either of the fifth or sixth SCM maps of 256QAM together with the second map of 256QAM to provide labeling diversity for DCM supports a 2.99 dB reduction in PAPR. However, SNR for reception over an AWGN channel will not be as good as for using the same SCM mapping of 16QAM for the DCM (though no more than 3 dB worse). Similar results obtain using either of the fifth or sixth SCM maps of 256QAM together with the above-postulated eighth map of 256QAM to provide labeling diversity for DCM.

Using either of the fifth or sixth SCM maps of 256QAM together with the first map of 256QAM to provide labeling diversity for DCM supports a 2.99 dB reduction in PAPR also, but the SNR for reception over an AWGN channel will be significantly improved. Similar results obtain using either of the fifth or sixth SCM maps of 256QAM together with the above-postulated seventh map of 256QAM to provide labeling diversity for DCM.

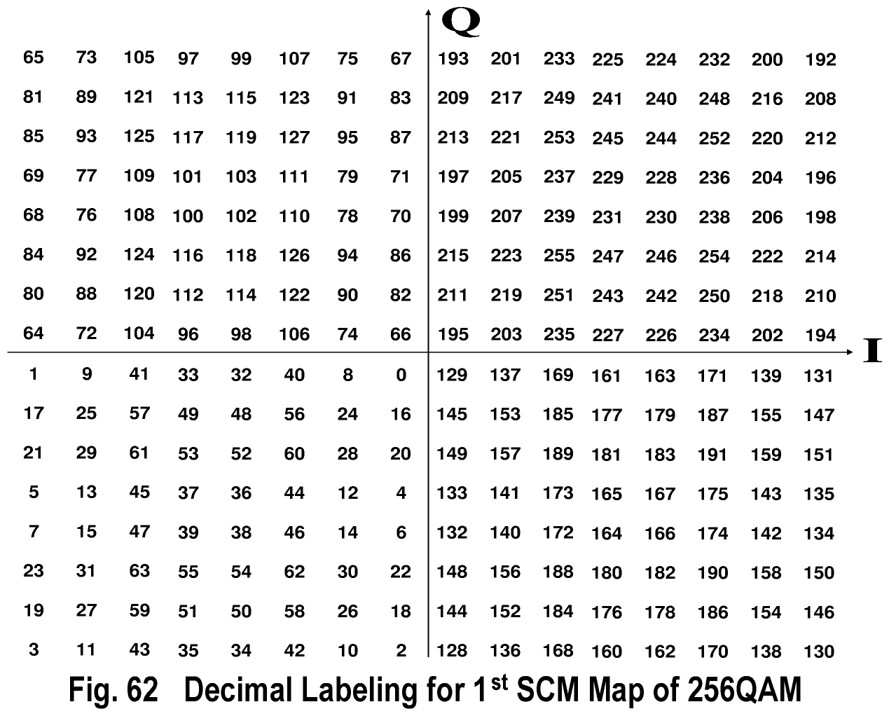

FIG. 62 presents decimal labeling for the first SCM map of 256QAM, the four quadrants of which map are depicted in FIGS. 38, 39, 40 and 41 respectively. Each of the four quadrants of the FIG. 62 first SCM map of 256QAM symbol constellations can be subdivided into four sub-quadrants with 16 LPLs in each of those sub-quadrants.

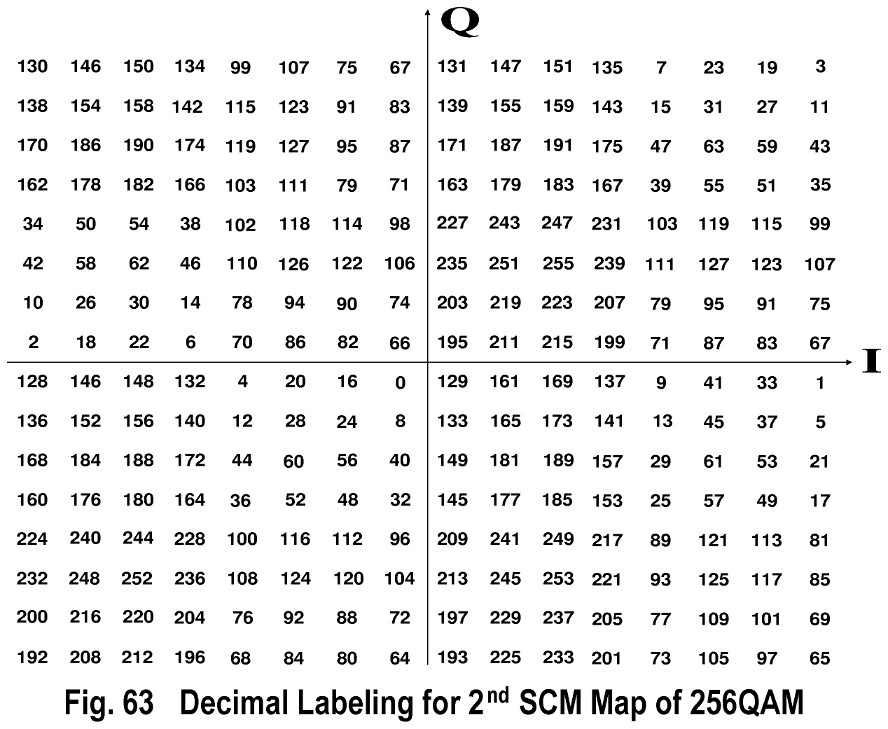

FIG. 63 presents decimal labeling for the second SCM map of 256QAM, the four quadrants of which map are depicted in FIGS. 42, 43, 44 and 45 respectively. Each of the four quadrants of the FIG. 63 second SCM map of 256QAM symbol constellations can be subdivided into four sub-quadrants with 16 LPLs in each of those sub-quadrants.

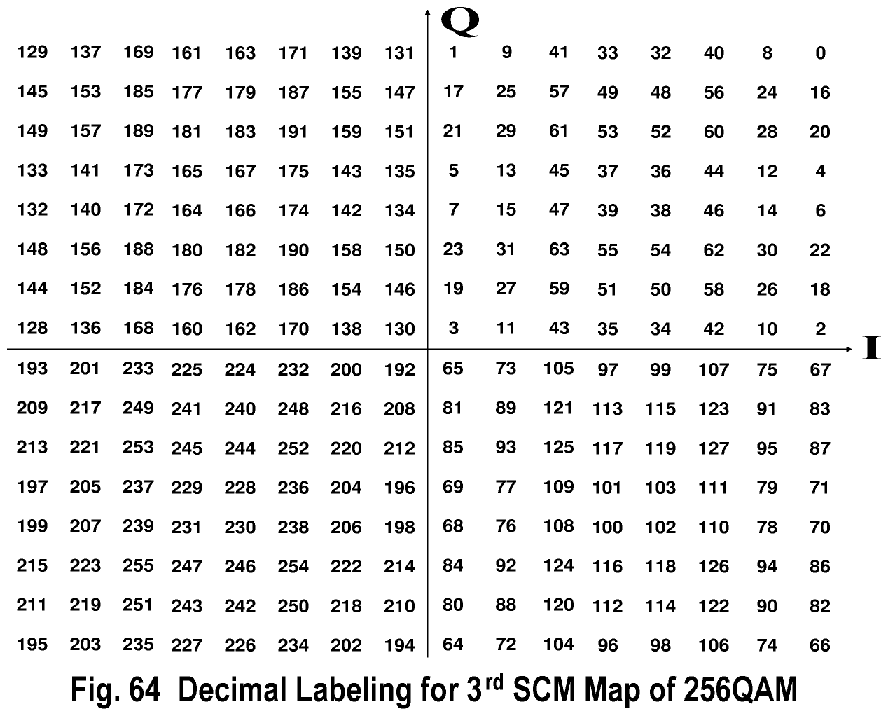

FIG. 64 presents decimal labeling for the third SCM map of 256QAM, the four quadrants of which map are depicted in FIGS. 46, 47, 48 and 49 respectively. Each of the four quadrants of the FIG. 64 third SCM map of 256QAM symbol constellations can be subdivided into four sub-quadrants with 16 LPLs in each of those sub-quadrants. Averaging of high energies of LPLs in the four outermost sub-quadrants of the FIG. 64 third SCM map with low energies of similar LPLs in the four innermost sub-quadrants of the FIG. 63 second SCM map contributes to keeping PAPR low in the DCM-COFDM signal. Averaging of high energies of LPLs in the four outermost sub-quadrants of the FIG. 63 second SCM map with low energies of similar LPLs in the four innermost sub-quadrants of the FIG. 64 third SCM map also contributes to keeping PAPR low in the DCM-COFDM signal. The energies in the eight flanking sub-quadrants of the FIG. 63 second SCM map and the energies in the eight flanking sub-quadrants of the FIG. 64 third SCM map all tend toward the average. So, these energies do not boost the PAPR of the DCM-COFDM signal significantly, if at all.

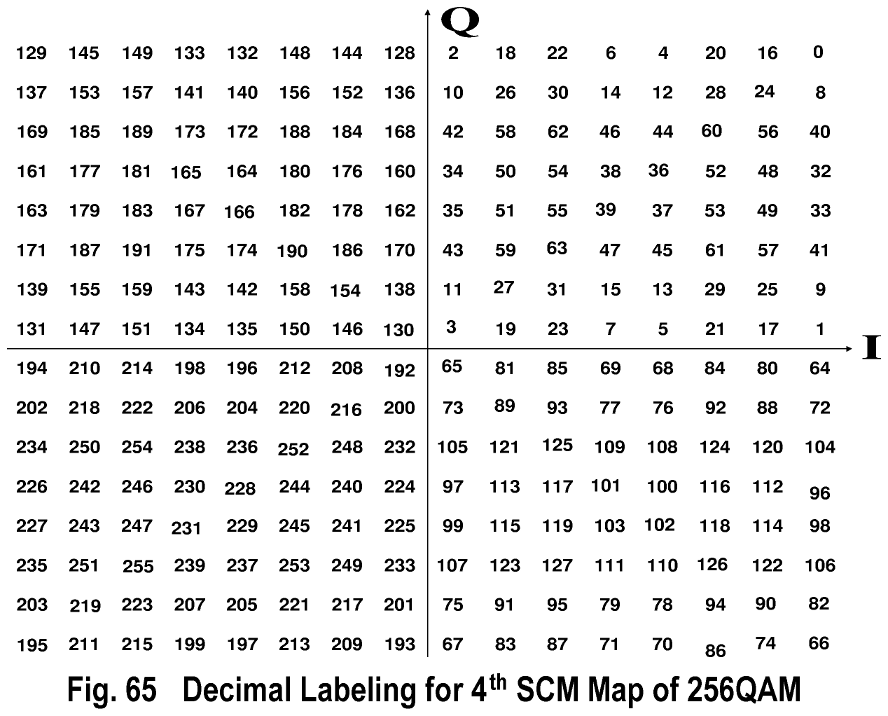

FIG. 65 presents decimal labeling for the fourth SCM map of 256QAM symbol constellations, the four quadrants of which are depicted in FIGS. 50, 51, 52 and 53 respectively. Each of the four quadrants of the FIG. 65 fourth SCM map of 256QAM can be subdivided into four sub-quadrants with 16 LPLs in each of those sub-quadrants. Averaging of high energies of LPLs in the four outermost sub-quadrants of the FIG. 65 fourth SCM map with low energies of similar LPLs in the four innermost sub-quadrants of the FIG. 63 second SCM map contributes to keeping PAPR low in the DCM-COFDM signal. Averaging of high energies of LPLs in the four outermost sub-quadrants of the FIG. 63 second SCM map with low energies of similar LPLs in the four innermost sub-quadrants of the FIG. 65 fourth SCM map also contributes to keeping PAPR low in the DCM-COFDM signal. The energies in the eight flanking sub-quadrants of the FIG. 63 second SCM map and the energies in the eight flanking sub-quadrants of the FIG. 65 fourth SCM map all tend toward the average. So, these energies do not boost the PAPR of the DCM-COFDM signal significantly, if at all.

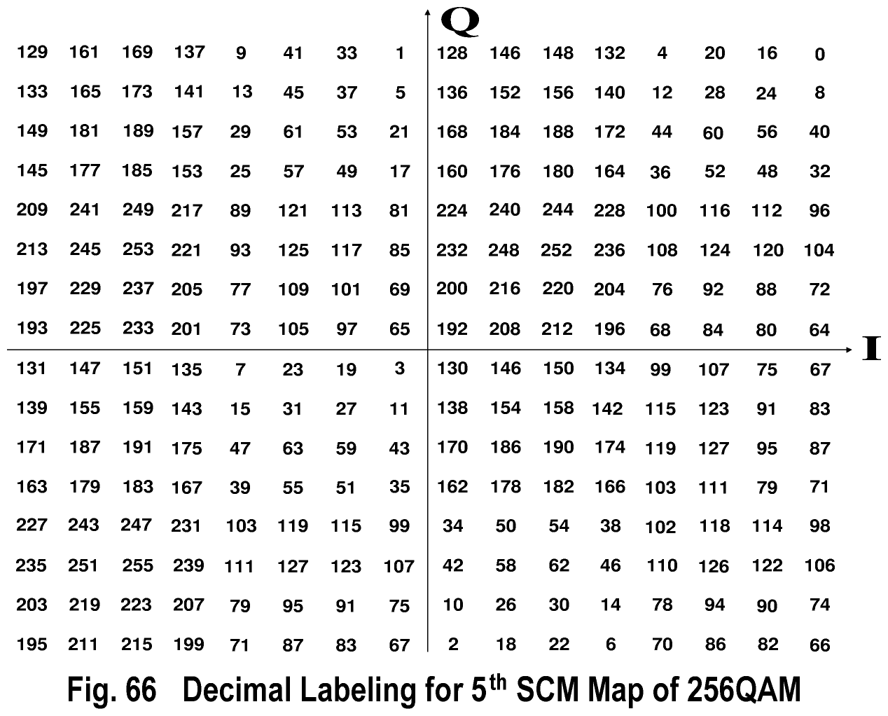

FIG. 66 presents decimal labeling for the fifth SCM map of 256QAM, the four quadrants of which map are depicted in FIGS. 54, 55, 56 and 57 respectively. Each of the four quadrants of the FIG. 66 fifth SCM map of 256QAM can be subdivided into four sub-quadrants with 16 LPLs in each of those sub-quadrants. Averaging of high energies of LPLs in the four outermost sub-quadrants of the FIG. 66 fifth SCM map with low energies of similar LPLs in the four innermost sub-quadrants of the FIG. 62 first SCM map contributes to keeping PAPR low in the DCM-COFDM signal. Averaging of high energies of LPLs in the four outermost sub-quadrants of the FIG. 66 fifth SCM map with low energies of similar LPLs in the four innermost sub-quadrants of the FIG. 66 fifth SCM map also contributes to keeping PAPR low in the DCM-COFDM signal. The energies in the eight flanking sub-quadrants of the FIG. 62 first SCM map and the energies in the eight flanking sub-quadrants of the FIG. 66 fifth SCM map all tend toward the average. So, these energies do not boost the PAPR of the DCM-COFDM signal significantly, if at all.

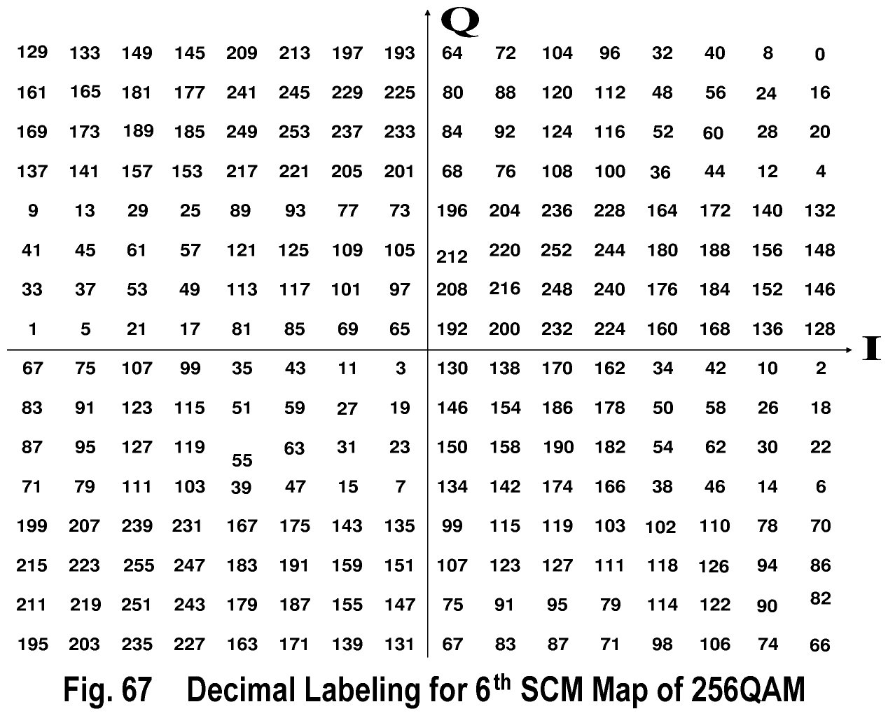

FIG. 67 presents decimal labeling for the sixth SCM map of 256QAM, the four quadrants of which map are depicted in FIGS. 58, 59, 60 and 61 respectively. Each of the four quadrants of the FIG. 67 sixth SCM map of 256QAM can be subdivided into four sub-quadrants with 16 LPLs in each of those sub-quadrants. Averaging of high energies of LPLs in the four outermost sub-quadrants of the FIG. 67 sixth SCM map with low energies of similar LPLs in the four innermost sub-quadrants of the FIG. 62 first SCM map contributes to keeping PAPR low in the DCM-COFDM signal. Averaging of high energies of LPLs in the four outermost sub-quadrants of the FIG. 62 first SCM map with low energies of similar LPLs in the four innermost sub-quadrants of the FIG. 67 sixth SCM map also contributes to keeping PAPR low in the DCM-COFDM signal. The energies in the eight flanking sub-quadrants of the FIG. 62 first SCM map and the energies in the eight flanking sub-quadrants of the FIG. 67 sixth SCM map all tend toward the average. So, these energies do not boost the PAPR of the DCM-COFDM signal significantly, if at all.

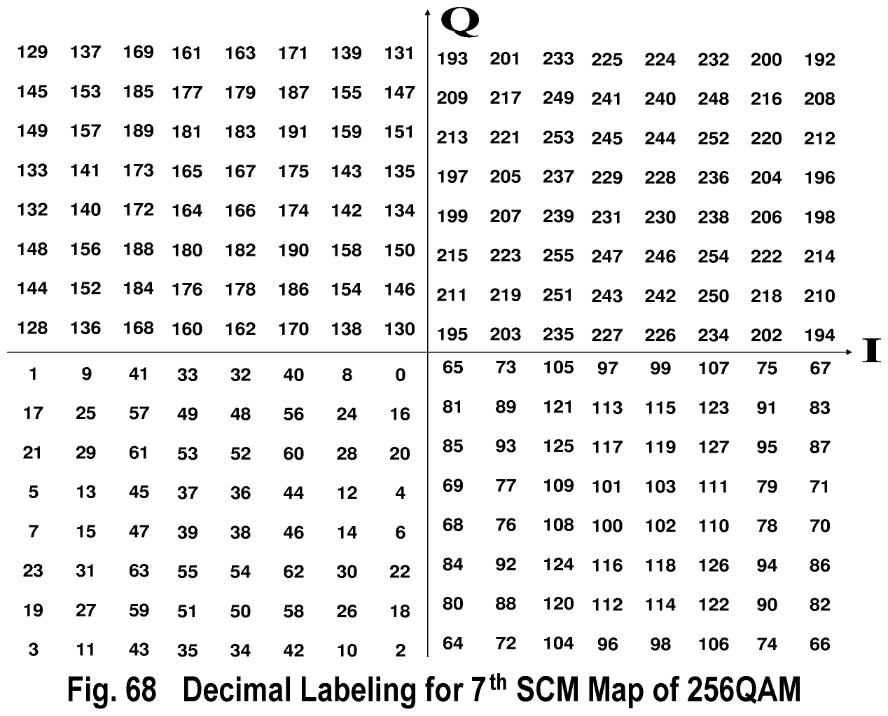

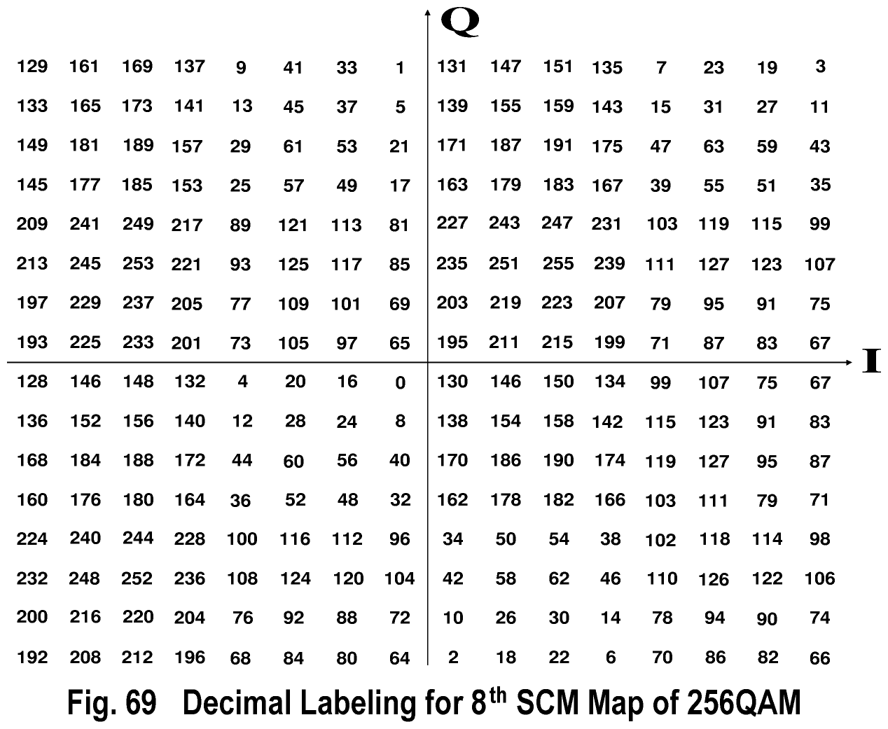

FIGS. 68 and 69 present respective decimal labeling for seventh and eighth SCM maps of 256QAM, which maps have preferred labeling diversity from each other. The four quadrants of each of these seventh and eighth SCM maps of 256QAM can be subdivided into four sub-quadrants with 16 LPLs in each of those sub-quadrants. Averaging of high energies of LPLs in the four outermost sub-quadrants of the FIG. 68 seventh SCM map with low energies of similar LPLs in the four innermost sub-quadrants of the FIG. 69 eighth SCM map contributes to keeping PAPR low in the DCM-COFDM signal. Averaging of high energies of LPLs in the four outermost sub-quadrants of the FIG. 69 eighth SCM map with low energies of similar LPLs in the four innermost sub-quadrants of the FIG. 68 seventh SCM map also contributes to keeping PAPR low in the DCM-COFDM signal. The energies in the eight flanking sub-quadrants of the FIG. 68 seventh SCM map and the energies in the eight flanking sub-quadrants of the FIG. 69 eighth SCM map all tend toward the average. So, these energies do not boost the PAPR of the DCM-COFDM signal significantly, if at all.

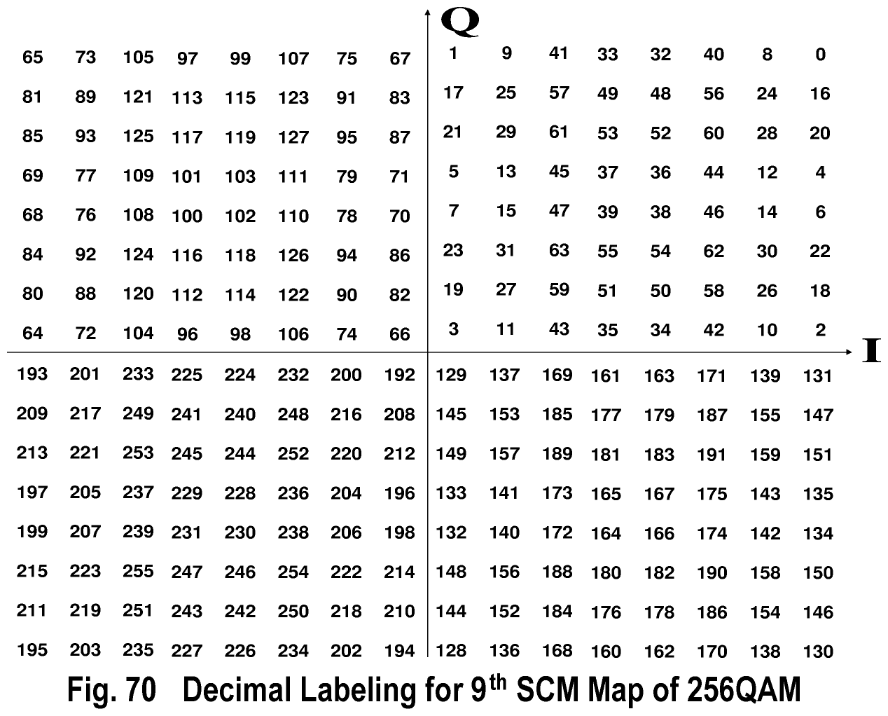

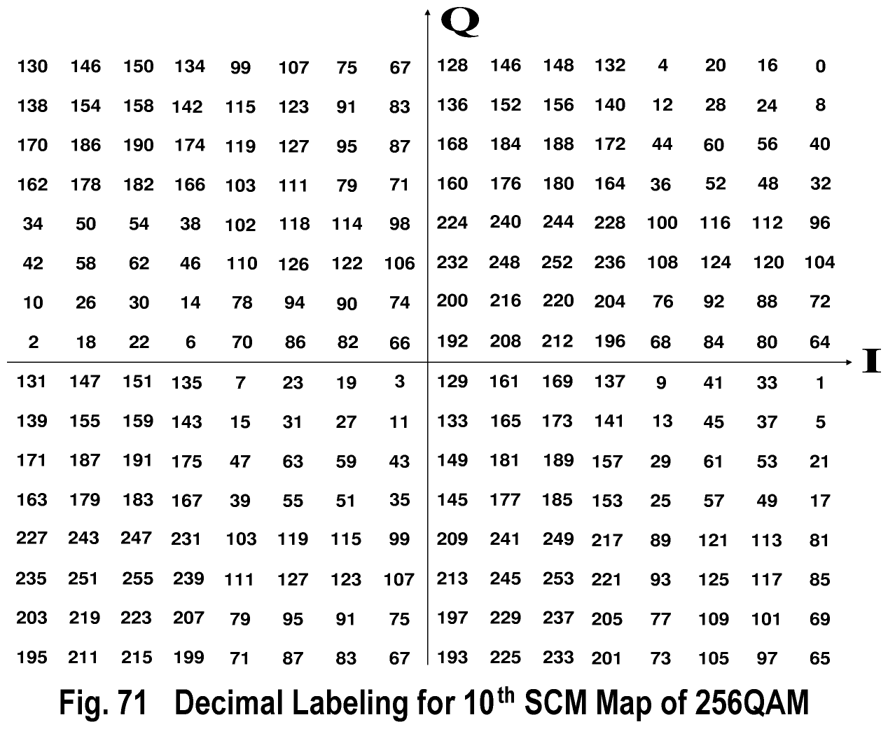

FIGS. 70 and 71 present respective decimal labeling for ninth and tenth SCM maps of 256QAM, which maps have preferred labeling diversity from each other. The four quadrants of each of these ninth and tenth SCM maps of 256QAM can be subdivided into four sub-quadrants with 16 LPLs in each of those sub-quadrants. Averaging of high energies of LPLs in the four outermost sub-quadrants of the FIG. 70 ninth SCM map with low energies of similar LPLs in the four innermost sub-quadrants of the FIG. 71 tenth SCM map contributes to keeping PAPR low in the DCM-COFDM signal. Averaging of high energies of LPLs in the four outermost sub-quadrants of the FIG. 71 tenth SCM map with low energies of similar LPLs in the four innermost sub-quadrants of the FIG. 70 ninth SCM map also contributes to keeping PAPR low in the DCM-COFDM signal. The energies in the eight flanking sub-quadrants of the FIG. 70 ninth SCM map and the energies in the eight flanking sub-quadrants of the FIG. 71 tenth SCM map all tend toward the average. So, these energies do not boost the PAPR of the DCM-COFDM signal significantly, if at all.

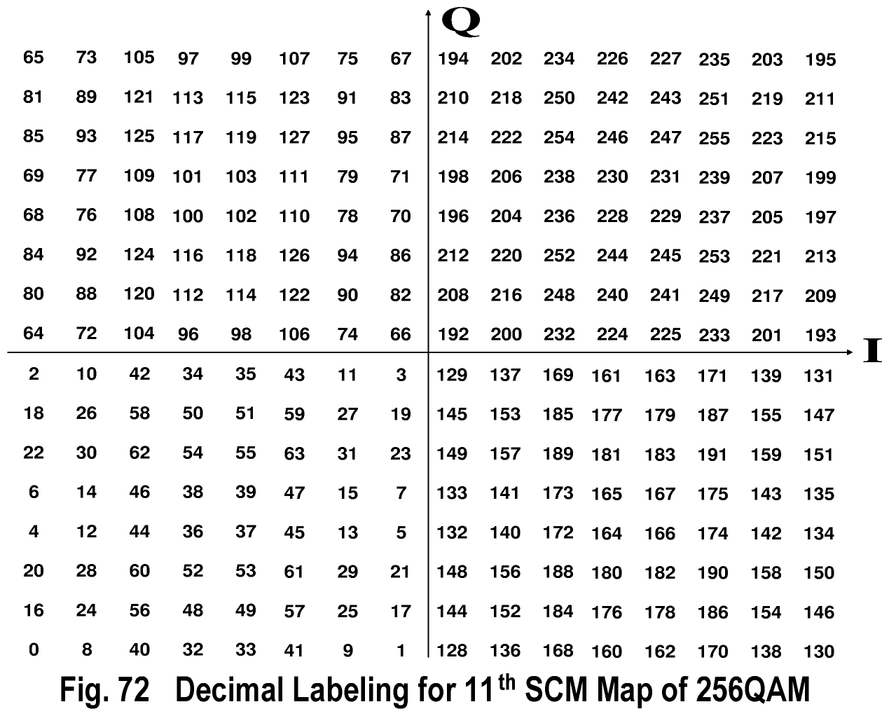

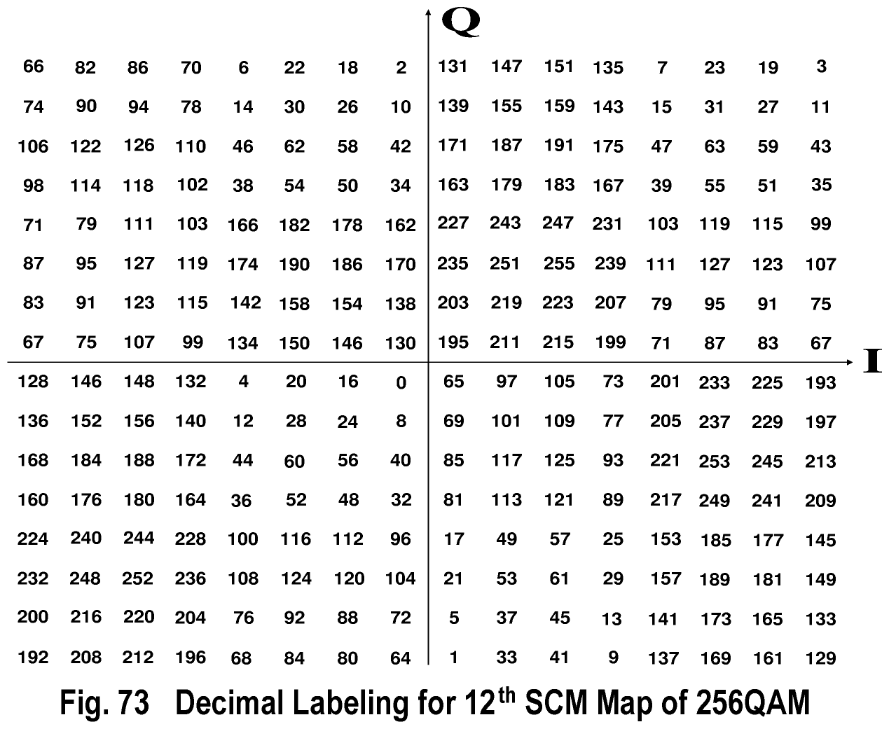

FIGS. 72 and 73 present respective decimal labeling for eleventh and twelfth SCM maps of 256QAM, which maps have preferred labeling diversity from each other. The four quadrants of each of these eleventh and twelfth SCM maps of 256QAM can be subdivided into four sub-quadrants with 16 LPLs in each of those sub-quadrants. Averaging of high energies of LPLs in the four outermost sub-quadrants of the FIG. 72 eleventh SCM map with low energies of similar LPLs in the four innermost sub-quadrants of the FIG. 73 twelfth SCM map contributes to keeping PAPR low in the DCM-COFDM signal. Averaging of high energies of LPLs in the four outermost sub-quadrants of the FIG. 73 twelfth SCM map with low energies of similar LPLs in the four innermost sub-quadrants of the FIG. 72 eleventh SCM map also contributes to keeping PAPR low in the DCM-COFDM signal. The energies in the eight flanking sub-quadrants of the FIG. 72 eleventh SCM map and the energies in the eight flanking sub-quadrants of the FIG. 73 twelfth SCM map all tend toward the average. So, these energies do not boost the PAPR of the DCM-COFDM signal significantly, if at all.

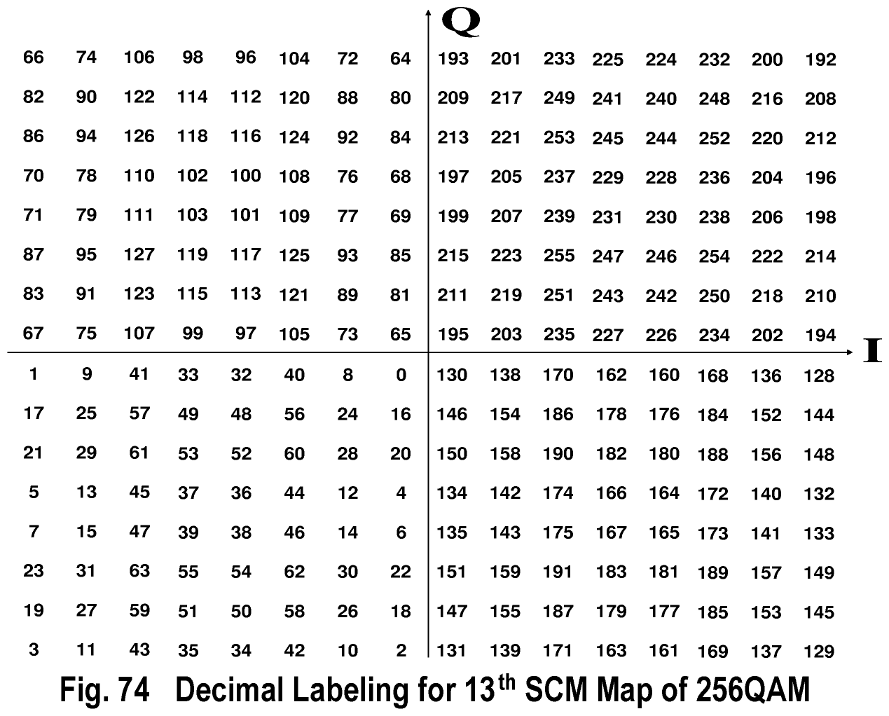

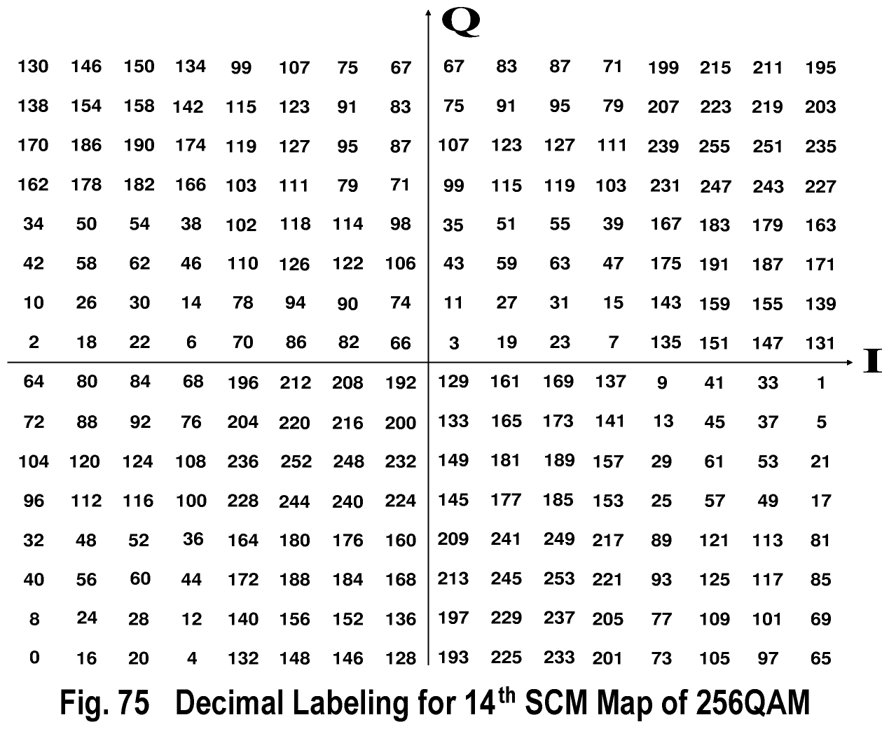

FIGS. 74 and 75 present respective decimal labeling for thirteenth and fourteenth SCM maps of 256QAM, which maps have preferred labeling diversity from each other. The four quadrants of each of these thirteenth and fourteenth SCM maps of 256QAM can be subdivided into four sub-quadrants with 16 LPLs in each of those sub-quadrants. Averaging of high energies of LPLs in the four outermost sub-quadrants of the FIG. 74 thirteenth SCM map with low energies of similar LPLs in the four innermost sub-quadrants of the FIG. 75 fourteenth SCM map contributes to keeping PAPR low in the DCM-COFDM signal. Averaging of high energies of LPLs in the four outermost sub-quadrants of the FIG. 75 fourteenth SCM map with low energies of similar LPLs in the four innermost sub-quadrants of the FIG. 74 thirteenth SCM map also contributes to keeping PAPR low in the DCM-COFDM signal. The energies in the eight flanking sub-quadrants of the FIG. 74 thirteenth SCM map and the energies in the eight flanking sub-quadrants of the FIG. 75 fourteenth SCM map all tend toward the average. So, these energies do not boost the PAPR of the DCM-COFDM signal significantly, if at all.

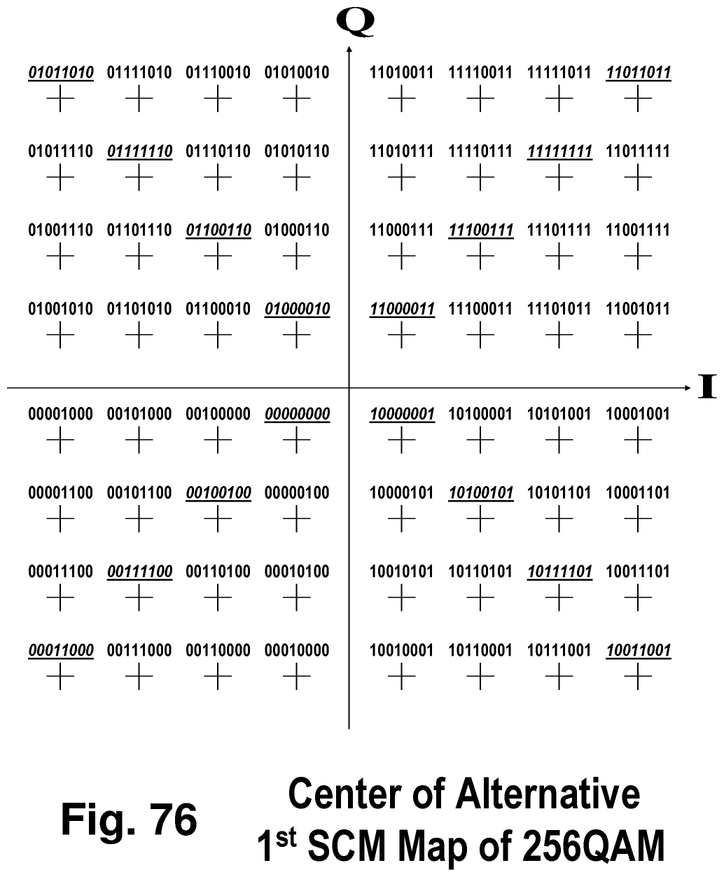

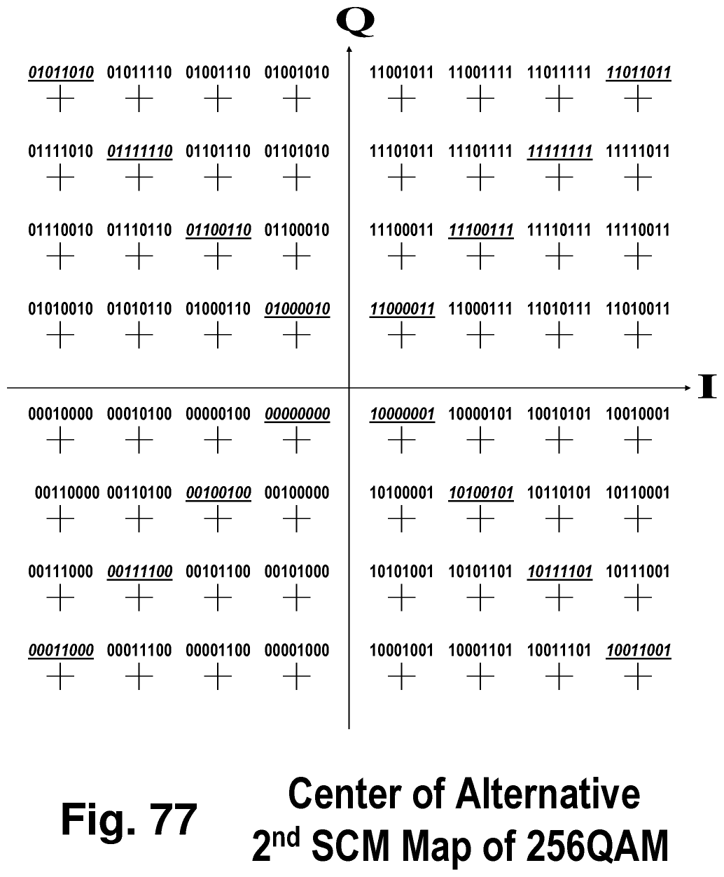

FIG. 76 depicts the central portion of another first SCM map of square 256QAM alternative to the FIG. 36 first SCM map of square 256QAM. FIG. 77 depicts the central portion of another second SCM map of square 256QAM symbol constellations alternative to the FIG. 37 second SCM map of square 256QAM symbol constellations. The innermost sub-quadrants of the −I, +Q quadrants of the alternative first and second SCM maps of 256QAM depicted in FIGS. 76 and 77 contain a palindromic LPLs sequence 01000010, 01100110, 01111110 and 01011010 instead of the LPLs sequence 01000010, 01011010, 01111110 and 01100110 contained in the innermost sub-quadrants of the −I, +Q quadrants of the first and second SCM maps of square 256QAM depicted in FIGS. 36 and 37. The innermost sub-quadrants of the +I, +Q quadrants of the alternative first and second SCM maps of 256QAM depicted in FIGS. 76 and 77 contain a palindromic LPLs sequence 11000011, 11100111, 11111111 and 11011011 instead of the LPLs sequence 11000011, 11011011, 11111111 and 11100111 contained in the innermost sub-quadrants of the +I, +Q quadrants of the first and second SCM maps of square 256QAM depicted in FIGS. 36 and 37. The innermost sub-quadrants of the +I, −Q quadrants of the alternative first and second SCM maps of 256QAM depicted in FIGS. 76 and 77 contain a palindromic LPLs sequence 10000001, 10100101, 10111101 and 10011001 instead of the LPLs sequence 10000001, 10011001, 10111101 and 10100101 contained in the innermost sub-quadrants of the +I, −Q quadrants of the first and second SCM maps of square 256QAM depicted in FIGS. 36 and 37. The innermost sub-quadrants of the −I, −Q quadrants of the alternative first and second SCM maps of 256QAM depicted in FIGS. 76 and 77 contain a palindromic LPLs sequence 00000000, 00100100, 00111100 and 00011000 instead of the LPLs sequence 00000000, 00011000, 00111100 and 00100100 contained in the innermost sub-quadrants of the −I, −Q quadrants of the first and second SCM maps of square 256QAM depicted in FIGS. 36 and 37.

The design of first and second SCM maps of square QAM symbol constellations of any size having 2^{(N+1)} LPLs, N being an integer greater than unity, proceeds as follows. Each of the 2^{(N+1)} LPLs will have 2N bits. There will be 2^{N} palindromic LPLS to be arranged in four sequences, for mapping into respective innermost sub-quadrants of the four quadrants of each of those first and second SCM maps of square QAM symbol constellations having 2^{(N+1)} LPLs. A respective sequence of 2N-bit palindromic LPLS is mapped along a diagonal axis of each of the four innermost sub-quadrants of each SCM map, which diagonal axis reaches from a point of origin between the four quadrants of that SCM map. The 2N-bit palindromic LPLS closest to the point of origin central to the four quadrants of each of those first and second SCM maps will differ in two of its bits from the 2N-bit palindromic LPLs closest to the point of origin in the same map, to conform to the characteristics of SCM mapping.

Each sequence of palindromic LPLS in an innermost sub-quadrant of one of the quadrants of each of the first and second SCM maps of square 2^{(N+1)} QAM must support Gray mapping of LPLs within that innermost sub-quadrant. The Gray maps of the four innermost sub-quadrants of each of the first and second SCM maps should support SCM map requirements of only two bits differing between adjoining LPLs in adjoining quadrants. This requirement imposes restrictions on the ordering of palindromic LPLS in adjoining sub-quadrants of those adjoining quadrants. Bits other than the pair that change between adjoining sub-quadrants need to be similarly arranged in the four innermost sub-quadrants of each of the first and second SCM maps, with regard to departure from the central point of the group of those four innermost sub-quadrants. To support SCM map requirements of only two bits differing between adjoining LPLs in adjoining quadrants, the Gray mappings of the four innermost sub-quadrants of each of the first and second SCM maps need to be twisted properly around their diagonal axes reaching from the point of origin central to the group of those four innermost sub-quadrants. The mapping of the innermost sub-quadrant of each quadrant of each of the first and second SCM maps provides a basis for mapping the other sub-quadrants of that quadrant, as detailed in the four paragraphs following, thereby to Gray map that quadrant.

The −I,+Q quadrant as depicted in the upper left corner of the SCM map has its innermost sub-quadrant mirrored upwards and also mirrored to its left as initial steps in generating respective flanking sub-quadrants of that −I,+Q quadrant. As an initial step in generating the outermost sub-quadrant of that −I,+Q quadrant, either its upper flanking sub-quadrant is mirrored to its left, or the left flanking sub-quadrant in that −I,+Q quadrant is mirrored upwards. (The results of the foregoing two alternatives are identical.) As the final step in generating the outermost sub-quadrant of that −I,+Q quadrant, the two bits in LPLs that identify its innermost sub-quadrant are each ones complemented so as to identify its outermost sub-quadrant. As the final step in generating the sub-quadrant flanking the outermost sub-quadrant of that −I,+Q quadrant on the right, one and only one of the two bits in LPLs that identify its innermost sub-quadrant is ones complemented, so as to identify that flanking sub-quadrant uniquely. As the final step in generating the sub-quadrant in that flanking its innermost sub-quadrant on the left, the other of the two bits in LPLs that identify its innermost sub-quadrant is ones complemented, so as to identify that flanking sub-quadrant uniquely.

The +I,+Q quadrant as depicted in the upper right corner of the SCM map has its innermost sub-quadrant mirrored upwards and also mirrored to its right as initial steps in generating respective flanking sub-quadrants of that +I,+Q quadrant. As an initial step in generating the outermost sub-quadrant of that +I,+Q quadrant, either its upper flanking sub-quadrant is mirrored to its right, or the right flanking sub-quadrant in that +I,+Q quadrant is mirrored upward. (The results of the foregoing two alternatives are identical.) As the final step in generating the outermost sub-quadrant of that +I,+Q quadrant, the two bits in LPLs that identify its innermost sub-quadrant are each ones complemented so as to identify its outermost sub-quadrant. As the final step in generating the sub-quadrant flanking the outermost sub-quadrant of that +I,+Q quadrant on the left, one and only one of the two bits in LPLs that identify its innermost sub-quadrant is ones complemented, so as to identify that flanking sub-quadrant uniquely. This bit is chosen so as not to cause dissimilarity in the bits of a row of bits shared with the −I,+Q quadrant. As the final step in generating the sub-quadrant in that +I,+Q quadrant flanking its innermost sub-quadrant on the right, the other of the two bits in LPLs that identify its innermost sub-quadrant is ones complemented, so as to identify that flanking sub-quadrant uniquely.

The +I,−Q quadrant as depicted in the lower right corner of the SCM map has its innermost sub-quadrant mirrored downwards and also mirrored to its right as initial steps in generating respective flanking sub-quadrants of that +I,−Q quadrant. As an initial step in generating the outermost sub-quadrant of that +I,−Q quadrant, either its lower flanking sub-quadrant is mirrored to its right, or its right flanking sub-quadrant is mirrored downwards. (The results of the foregoing two alternatives are identical.) As the final step in generating the outermost sub-quadrant of that +I,−Q quadrant, the two bits in LPLs that identify the innermost sub-quadrant of that +I,−Q quadrant are each ones complemented so as to identify the outermost sub-quadrant of that +I,−Q quadrant. As the final step in generating the sub-quadrant in that +I,−Q quadrant flanking its innermost sub-quadrant on the right, the other of the two bits in LPLs that identify its innermost sub-quadrant is ones complemented, so as to identify that flanking sub-quadrant uniquely. This bit is chosen so as not to cause dissimilarity in the bits of a column of bits shared with the +I,+Q quadrant. As the final step in generating the sub-quadrant flanking the outermost sub-quadrant of that +I,−Q quadrant on its left, one and only one of the two bits in LPLs that identify its innermost sub-quadrant is ones complemented, so as to identify that flanking sub-quadrant uniquely.

The −I,−Q quadrant as depicted in the lower left corner of the SCM map has its innermost sub-quadrant mirrored downwards and also mirrored to its left as initial steps in generating respective flanking sub-quadrants of that −I,−Q quadrant. As an initial step in generating the outermost sub-quadrant of that −I,−Q quadrant, either the lower flanking sub-quadrant in that −I,−Q quadrant is mirrored to its left, or the left flanking sub-quadrant in that −I,−Q quadrant is mirrored downwards. (The results of the foregoing two alternatives are identical.) As the final step in generating the outermost sub-quadrant of that −I,−Q quadrant, the two bits in LPLs that identify its innermost sub-quadrant are each ones complemented so as to identify its outermost sub-quadrant. As the final step in generating the sub-quadrant flanking the outermost sub-quadrant of that −I,−Q quadrant at the right, one and only one of the two bits in LPLs that identify its innermost sub-quadrant is ones complemented, so as to identify that flanking sub-quadrant uniquely. This bit is chosen so as not to cause dissimilarity in the bits of a row of bits shared with the +I,−Q quadrant. As the final step in generating the sub-quadrant in that −I,−Q quadrant flanking its innermost sub-quadrant on the left, the other of the two bits in LPLs that identify the innermost sub-quadrant of that −I,+Q quadrant is ones complemented, so as to identify that flanking sub-quadrant uniquely.

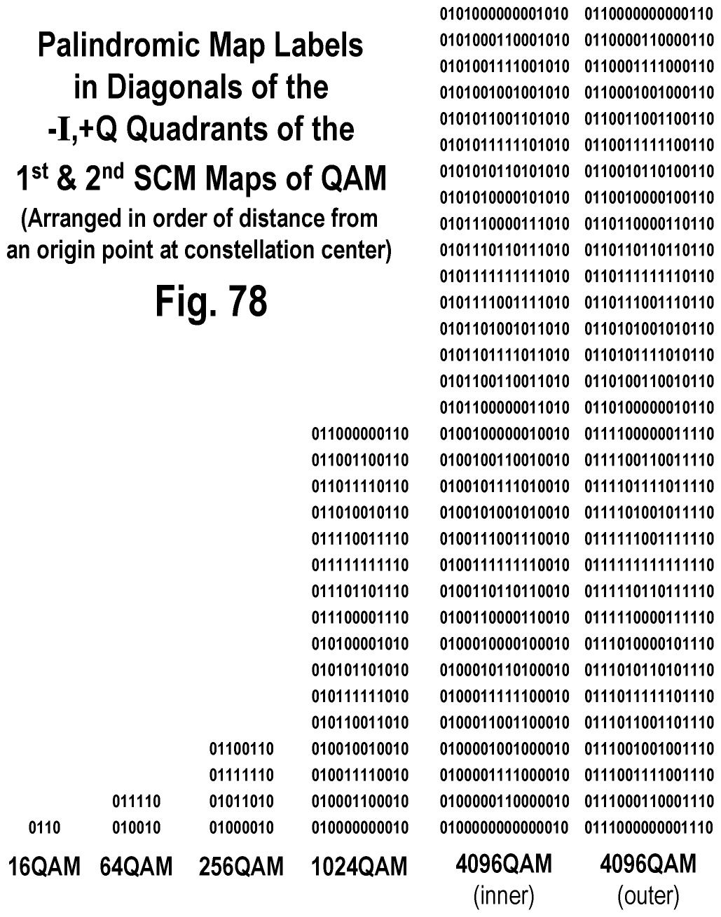

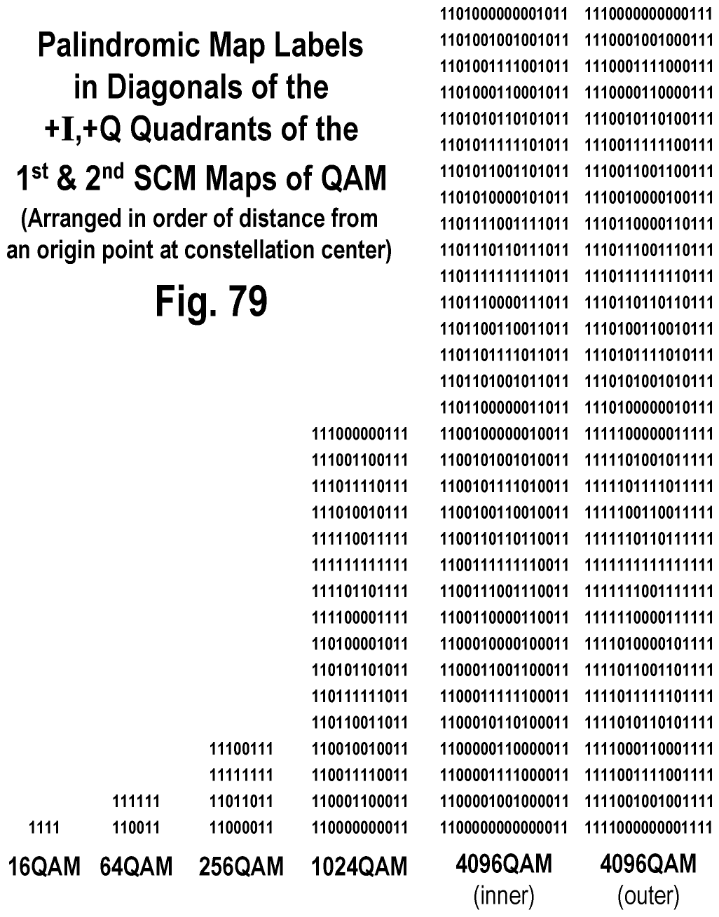

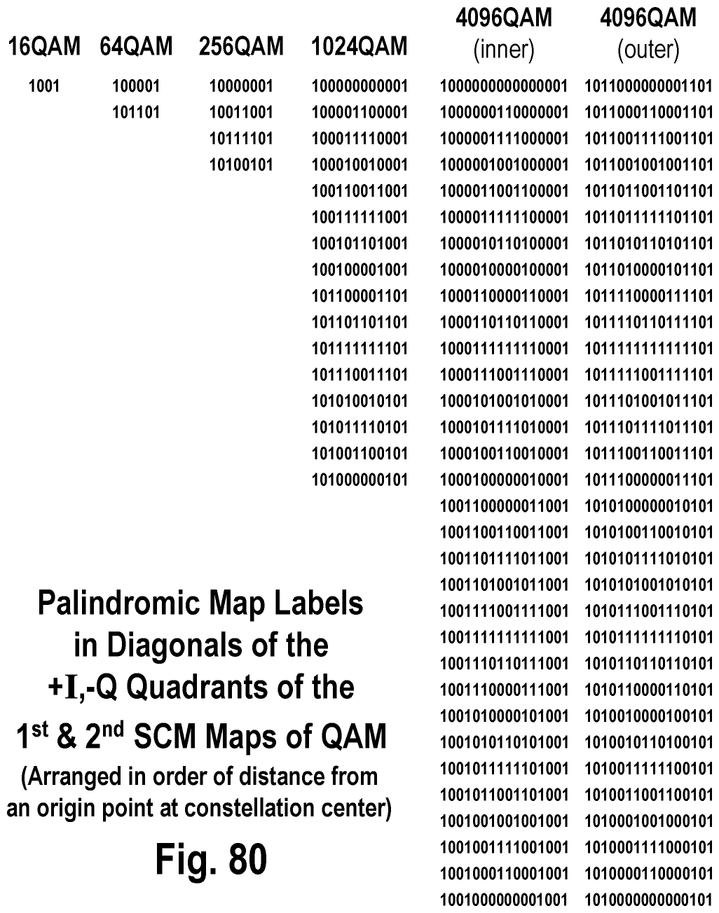

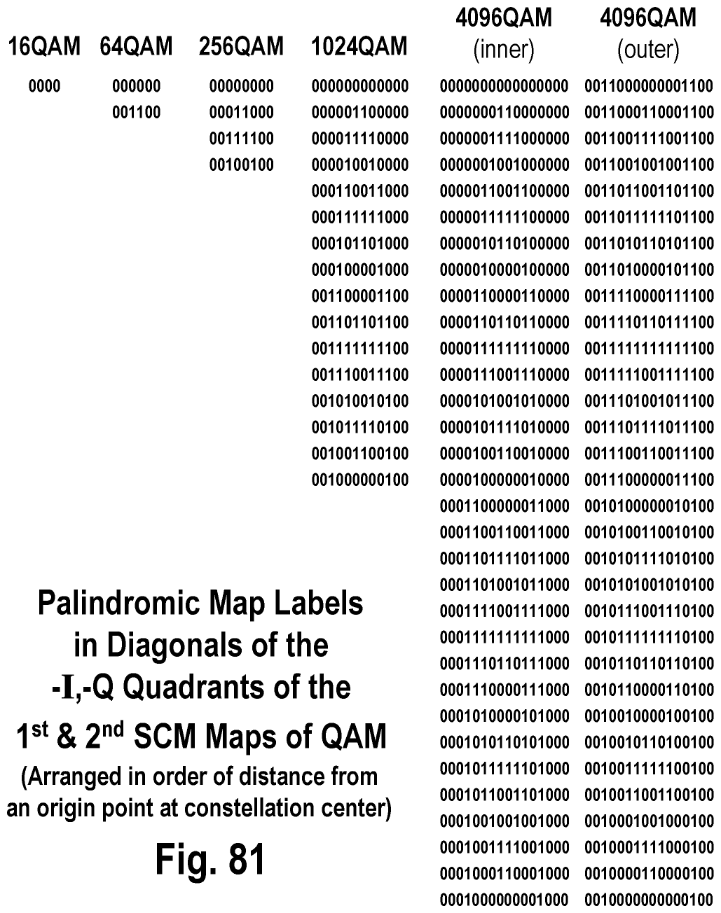

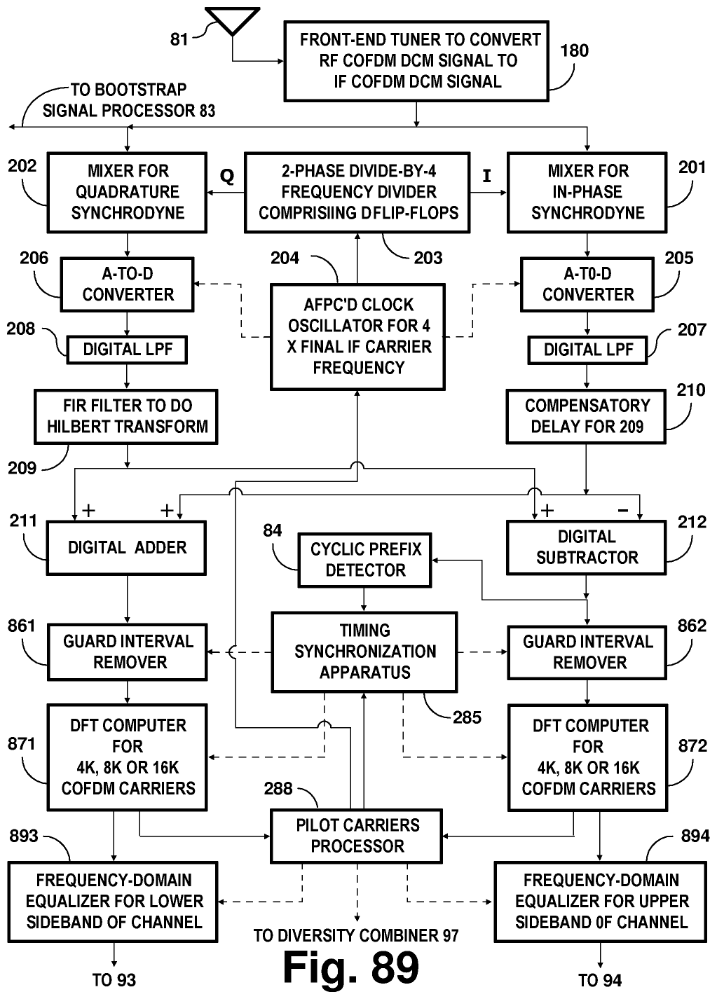

FIG. 78 lists sequences of palindromic map labels in diagonals of the −I,+Q quadrants of first and second SCM maps of 16QAM, 64QAM, 256QAM, 1024QAM and 4096QAM. FIG. 79 lists sequences of palindromic map labels in diagonals of the +I,+Q quadrants of first and second SCM maps of 16QAM, 64QAM, 256QAM, 1024QAM and 4096QAM. FIG. 80 lists sequences of palindromic map labels in diagonals of the +I,−Q quadrants of first and second SCM maps of 16QAM, 64QAM, 256QAM, 1024QAM and 4096QAM. FIG. 81 lists sequences of palindromic map labels in diagonals of the −I,−Q quadrants of first and second SCM maps of 16QAM, 64QAM, 256QAM, 1024QAM and 4096QAM. These sequences of palindromic map labels that FIGS. 89, 90, 91 and 93 list for the innermost sub-quadrants of first and second SCM maps of any one of these sizes of QAM symbol constellation are compatible with each other. In accordance with the teaching supra in regard to 256QAM, other compatible sequences of palindromic map labels for diagonals of the innermost sub-quadrants of first and second SCM maps of QAM symbol constellations exist.

FIG. 82 shows the initial portion of a receiver designed for iterative-diversity reception of COFDM signals as transmitted at VHF or UHF by a DTV transmitter, such as the one depicted in FIGS. 3, 4 and 5. A front-end tuner 80 of the receiver selects its input signal from one of the radio-frequency (RF) signals captured by a reception antenna 81. The front-end tuner 80 can be of a double-conversion type composed of initial single-conversion super-heterodyne receiver circuitry for converting the selected RF single-sideband COFDM signal to an intermediate-frequency (IF) single-sideband COFDM signal followed by circuitry for performing a final conversion of that IF COFDM signal to baseband single-sideband COFDM signal. The initial conversion circuitry typically comprises a tunable RF amplifier for RF single-sideband COFDM signal incoming from the reception antenna, a tunable first local oscillator, a first mixer for heterodyning the amplified RF single-sideband COFDM signal with local oscillations from the first local oscillator to obtain the IF single-sideband COFDM signal, and an intermediate-frequency (IF) amplifier for the IF single-sideband COFDM signal. Typically, the front-end tuner 80 further includes a synchronous demodulator for performing the final conversion from IF single-sideband COFDM signal to baseband single-sideband COFDM signal and an analog-to-digital converter for digitizing that baseband signal. Synchronous demodulation circuitry typically comprises a final local oscillator with automatic frequency and phase control (AFPC) of its oscillations, a second mixer for synchrodyning amplified IF single-sideband COFDM signal with local oscillations from the final local oscillator to obtain the baseband single-sideband COFDM signal, and a low-pass filter for suppressing image signal accompanying the baseband single-sideband COFDM signal. In some designs of the front-end tuner 80, synchronous demodulation is performed in the analog regime before subsequent analog-to-digital conversion of the resulting complex baseband single-sideband COFDM signal. In other designs of the front-end tuner 80, analog-to-digital conversion is performed before synchronous demodulation is performed in the digital regime.

Simply stated, the front-end tuner 80 converts RF single-sideband COFDM signal received at its input port to digitized samples of baseband single-sideband COFDM signal supplied from its output port. Typically, the digitized samples of the real component of the baseband single-sideband COFDM signal are alternated with digitized samples of the imaginary component of that baseband signal for arranging the complex baseband single-sideband COFDM signal in a single stream of digital samples. FIG. 82 depicts an AFPC generator 82 for generating the automatic frequency and phase control (AFPC) signal for controlling the final local oscillator within the front-end tuner 80.

The output port of the front-end tuner 80 is connected for supplying digitized samples of baseband single-sideband COFDM signal to the respective input ports of a bootstrap signal processor 83 and a cyclic prefix detector 84. The cyclic prefix detector 84 differentially combines the digitized samples of baseband single-sideband COFDM signal with those samples as delayed by the duration of an effective COFDM symbol. Nulls in the difference signal so generated should occur, marking the guard intervals of the baseband single-sideband COFDM signal. The nulls are processed to reduce any corruption caused by noise and to generate better-defined indications of the phasing of COFDM symbols. The output port of the cyclic prefix detector 84 is connected to supply these indications to a first of two input ports of timing synchronization apparatus 85.

A first of two output ports of the timing synchronization apparatus 85 is connected for supplying gating control signal to the control input port of a guard-interval-removal unit 86, the signal input port of which is connected for receiving digitized samples of baseband COFDM signal from the output port of the front-end tuner 80. The output port of the guard-interval-removal unit 86 is connected for supplying the input port of discrete-Fourier-transform computer 87 with windowed portions of the baseband single-sideband COFDM signal that contain effective COFDM samples. A second of the output ports of the timing synchronization apparatus 85 is connected for supplying the DFT computer 87 with synchronizing information concerning the effective COFDM samples.

The indications concerning the phasing of COFDM symbols that the cyclic prefix detector 84 supplies to the timing synchronization apparatus 85 are sufficiently accurate for initial windowing of a baseband single-sideband COFDM signal that the guard-interval-removal unit 86 supplies to the DFT computer 87. A first output port of the DFT computer 87 is connected for supplying demodulation results for at least all of the pilot carriers in parallel to the input port of a pilot carriers processor 88, and a second output port of the DFT computer 87 is connected for supplying demodulation results for each of the COFDM carriers to the input port of a frequency-domain channel equalizer 89. The processor 88 selects the demodulation results concerning pilot carriers for processing, part of which processing generates weighting coefficients for channel equalization filtering in the frequency domain. A first of four output ports of the processor 88 that are explicitly shown in FIG. 82 is connected for supplying these weighting coefficients (via wiring depicted as a dashed-line connection) to the frequency-domain channel equalizer 89, which uses those weighting coefficients for adjusting its responses to the demodulation results for each of the COFDM carriers.

A second of the output ports of the pilot carriers processor 88 that are explicitly shown in FIG. 82 is connected for supplying more accurate window-positioning information to the second input port of the timing synchronization apparatus 85. This window-positioning information is an adjustment generated by a feedback loop that seeks to minimize the noise accompanying pilot carriers, which noise increases owing to intercarrier interference from adjoining modulated carriers when window positioning is not optimal.

A third of the output ports of the pilot carriers processor 88 explicitly shown in FIG. 82 is connected for forwarding unmodulated pilot carriers to the input port of the AFPC generator 82. The real components of the unmodulated pilot carriers are multiplied by their respective imaginary components in the AFPC generator 82. The resulting products are summed and low-pass filtered to develop the AFPC signal that the AFPC generator 82 supplies to the front-end tuner 80 for controlling the final local oscillator therein. Other methods to develop AFPC signals for the final local oscillator in the front-end tuner 80 are also known, variants of which can replace or supplement the method described above.

E.g., the complex digital samples from the tail of each half OFDM symbol are multiplied by the conjugates of corresponding digital samples from the cyclic prefix of the half OFDM symbol. The resulting products are summed and low-pass filtered to develop the AFPC signal that the AFPC generator 82 supplies to the front-end tuner 80 for controlling the final local oscillator therein. This method is a variant of a known method to develop AFPC signals in receivers for double-sideband COFDM signals described in U.S. Pat. No. 5,687,165 titled “Transmission system and receiver for orthogonal frequency-division multiplexing signals, having a frequency-synchronization circuit”, which was granted to Flavio Daffara and Ottavio Adami on 11 Nov. 1997.

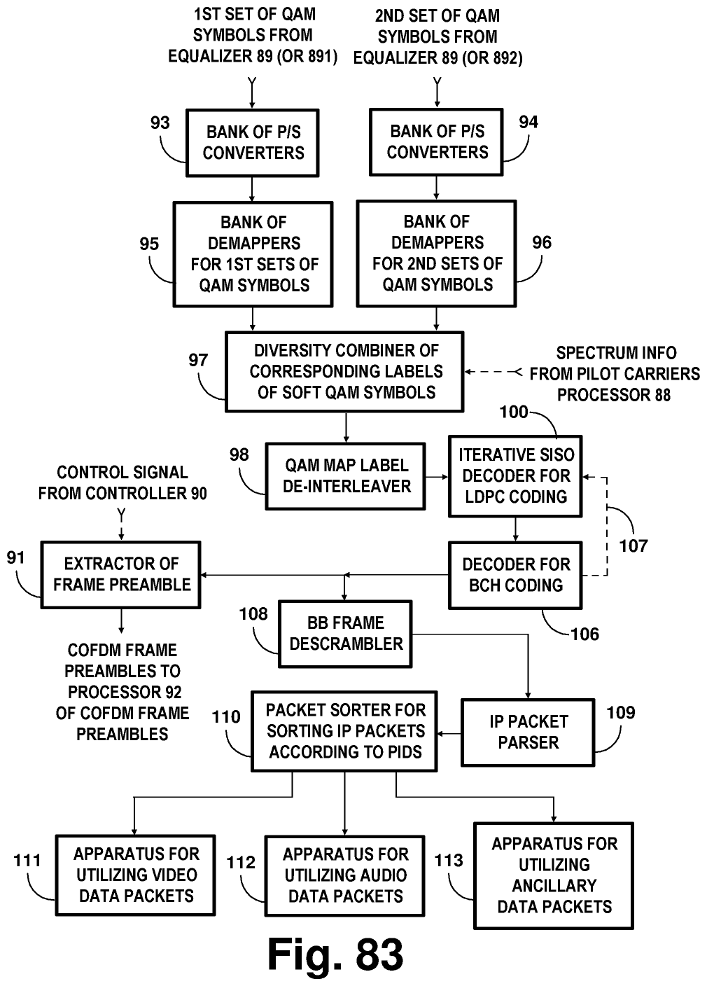

FIG. 82 indicates that a fourth of the output ports of the pilot carriers processor 88 is connected to a diversity combiner 97 (depicted in FIG. 83). Through such connection the pilot carriers processor 88 furnishes information concerning the frequency spectrum of each successive COFDM symbol, which the diversity combiner 97 can use to determine how it will combine its input signals to generate its output signal.

The DFT computer 87 is configured so it can demodulate any one of 8K, 16K and 32K options as to the number of OFDM carriers. The correct option is chosen responsive to an instruction from a controller 90 that generates a number of instructions used to configure the COFDM receiver to suit the broadcast standard used transmissions currently received. To keep the drawings from being too cluttered to be easily understood, they do not explicitly illustrate the multitudinous connections from the controller 90 to the elements of the receiver controlled by respective instructions from the controller 90.

As noted supra, the second output port of the DFT computer 87 is connected to supply demodulated complex digital samples of the complex coordinates of QAM symbol constellations in parallel to the input port of the frequency-domain channel equalizer 89. To implement a simple form of frequency-domain channel equalization, the pilot carriers processor 88 measures the amplitudes of the demodulated pilot carriers to determine basic weighting coefficients for various portions of the frequency spectrum. The pilot carriers processor 88 then interpolates among the basic weighting coefficients to generate respective weighting coefficients supplied to the frequency-domain channel equalizer 89 with which to multiply the complex coordinates of QAM symbol constellations supplied from the DFT computer 87. Various alternative types of frequency-domain channel equalizer are also known.

An extractor 91 of COFDM frame preambles selects them from COFDM frames of decoded data supplied from a decoder 106 for BCH coding, which decoder 106 is depicted in FIG. 83. The output port of the extractor 91 of COFDM frame preambles connects to the input port of a processor 92 of the COFDM frame preambles. The controller 90 is connected for responding to elements of COFDM frame preambles forwarded to a second of its input ports from an output port of the COFDM frame preambles processor 92.

The controller 90 is connected for responding to elements of the bootstrap signal forwarded to a first of its input ports from an output port of the bootstrap signal processor 83. The controller 90 supplies COFDM data frame information to the pilot carriers processor 88, which data frame information can be generated responsive to baseband bootstrap signal that the bootstrap signal processor 88 supplies to the controller 90. Since the bootstrap signal is not always received acceptably free of error, it is good design to provide a source alternative to the bootstrap signal processor 83 for supplying the controller 90 back-up information as to the nature of received DTV signal. Such a source is necessary if bootstrap signal is not transmitted or if the receiver does not include a bootstrap signal processor. Accordingly the response of a decoder 106 for BCH coding, which decoder 106 is depicted in FIG. 83, is supplied to input port of an extractor 91 of FEC frame preambles from the decoder 106 response. If the frame preamble at the beginning of each COFDM data frame is repeated, the extractor 91 readily detects when frame preambles occur by correlating successive COFDM symbols in the response from the decoder 106 in accordance with the well-known Schmidl-Cox method. The output port of the extractor 91 of FEC frame preambles is connected for supplying them to the input port of a processor 92 of COFDM frame preambles. The output port of the processor 92 of COFDM frame preambles is connected for supplying an input port of the controller 90 with information as to the nature of received DTV signal, the interconnection between which ports may comprise a plurality of separate connections. FIG. 82 shows a connection from the controller 90 to the extractor 91 of FEC frame preambles through which connection the controller 90 can supply the extractor 91 a control signal including predictions of when FEC frame preambles are expected to occur.

Responsive to information supplied from the bootstrap signal processor 83 or from the processor 92 of COFDM frame preambles, the controller 90 prescribes the basic sample rate and the size of I-FFT that the controller 90 instructs the DFT computer 87 to use in its operation regarding DTV signal. The controller 90 instructs the channel equalizer 89 and the banks 93 and 83 of parallel-input/serial-output converters to configure themselves to suit the size of DFT that the controller 90 instructs the DFT computer 87 to generate.

The frequency-domain channel equalizer 89 is connected for supplying complex coordinates of the QAM symbol constellations from the lower-frequency half COFDM symbol, in parallel and in forward spectral order, to the bank 93 of parallel-to-serial (P/S) converters. One of these P/S converters as selected by the controller 90 supplies the complex coordinates of a first set of QAM symbol constellations extracted from the lower-frequency halves of successive COFDM symbols. The frequency-domain channel equalizer 89 is further connected for supplying complex coordinates of the QAM symbol constellations from the higher-frequency half COFDM symbol, in parallel and in forward spectral order, to the bank 94 of parallel-to-serial (P/S) converters. One of these P/S converters as selected by the controller 90 supplies the complex coordinates of a second set of QAM symbol constellations extracted from the higher-frequency halves of successive COFDM symbols. “Forward spectral order” refers to the complex coordinates of each successive QAM symbol constellation from a half COFDM symbol having been conveyed by the COFDM carrier next higher in frequency than that having conveyed its predecessor QAM symbol. Each of the banks 93 and 83 of P/S converters comprises respective P/S converters that are appropriate for half the number of OFDM carriers that can convey data in a COFDM symbol of prescribed size. The pair of P/S converters selected for current reception is determined by a control signal that the controller 90 supplies in common to each of the banks 93 and 83 of P/S converters.

The first sets of QAM symbol constellations are those that originate from the first mapping procedures in the COFDM transmitter apparatus and are supplied from the output port of the bank 93 of P/S converters to the input port of a bank 95 of demappers for the first sets of QAM symbol constellations, as depicted in FIG. 83. The second sets of QAM symbol constellations are those that originate from the second mapping procedures in the COFDM transmitter apparatus and are supplied from the output port of the bank 94 of P/S converters to the input port of a bank 96 of demappers for the second sets of QAM symbol constellations, as depicted in FIG. 83. Each of the banks 95 and 96 of demappers comprises a respective set of QAM demappers for different sizes of QAM symbol constellations e.g., one for square 16QAM, one for square 64QAM, one for square 256QAM, and possibly one(s) for larger-size square QAM or for APSK. The pair of demappers selected for current reception is determined by a control signal that the controller 90 supplies in common to each of the banks 95 and 96 of QAM demappers.

The pairs of QAM demappers in the banks 95 and 96 of demappers could be paired Gray demappers, paired SCM demappers, paired natural demappers, paired anti-Gray demappers, paired “optimal” demappers of various types or some mixture of those types of paired demappers. However, if the demapping results from the antiphase-energy QAM demappers are to be maximal-ratio combined at bit level to improve effective SNR for AWGN reception, it is strongly recommended that QAM symbol constellations be Gray mapped or SCM mapped. SCM mapping is preferred since it better lends itself to reducing PAPR of DCM-COFDM signals using square QAM symbol constellations than does Gray mapping. It is practical for each of the QAM demappers to constitute a plurality of read-only memories (ROMs), one for each bit of map labeling, addressed by the complex coordinates descriptive of the current QAM symbol. Each ROM is read to provide a “hard” bit followed by a confidence factor indicating how likely that bit is to be correct. Customarily these confidence factors are expressed as logarithm of likelihood ratios (LLRs).

The confidence factors are usually based, at least insubstantial part, on judgments of the distance of the complex coordinates descriptive of the current QAM symbol from the edges of the bin containing the “hard” bit. The confidence factors can be further based on whether or not the bin containing the “hard” bit is at an edge of the current QAM symbol constellation and, if so, whether the complex coordinates descriptive of that current QAM symbol closely approach that edge or even pass beyond it. The confidence factor that the “hard” bit is correct is increased if the complex coordinates descriptive of that current QAM symbol closely approach a symbol constellation edge or even pass beyond it. This increase applies to all bits in the map label. This effect obtains if mapping of QAM symbol constellations is Gray mapping or is SCM mapping.

FIG. 83 depicts a portion of a DCM-COFDM signal receiver wherein (a) a selected one of a bank 95 of demappers for a first set of QAM symbols performs the step S6A of the FIG. 2 method, (b) a selected one of a bank 96 of demappers for a second set of QAM symbols performs the step S6B of the FIG. 2 method, and (c) a diversity combiner 97 performs the step S7 of the FIG. 2 method. In actual practice, a pair of respective demappers for first and second sets of QAM symbols and a diversity combiner for their demapping results may be subsumed within a read-only memory, rather than appearing as separate elements. This should be taken into consideration when considering the scope of patent claims in accordance with the doctrine of equivalents.

FIG. 83 shows connections from the output ports of the banks 95 and 96 of demappers to respective input ports of a diversity combiner 97 of corresponding soft QAM labels operative at bit level. Each soft QAM label is composed of a plurality of “soft” bits. Each of these “soft” bits constitutes a “hard” bit and a confidence factor that that “hard” bit has been correctly decided; this confidence factor is conventionally expressed as a logarithm of likelihood ratio (LLR) that the bit is correct. This information is utilized in subsequent soft decoding procedures of the FEC coding reproduced in interleaved form from the diversity combiner 97. The output port of the diversity combiner 97 serially supplies soft bits of successive QAM labels to the input port of a bit de-interleaver 98 as soft bits of interleaved LDPC coding.

FIG. 83 shows the read-output port of the QAM map label de-interleaver 98 connected to the input port of an iterative soft-input/soft-output (SISO) decoder 100 for LDPC coding. FIG. 83 further shows the output port of the decoder 100 connected for supplying the results of its decoding LDPC coding to the input port of a decoder 106 of BCH coding. FIG. 83 shows a control connection 107 from the decoder 106 of BCH coding back to the decoder 100 of LDPC coding, through which connection 107 the decoder 106 sends an indication of when it has decoded a correct BCH codeword. This indication signals the decoder 100 of LDPC coding that it can discontinue iterative decoding before reaching a limit on the maximum number of iterations permitted, which early discontinuation of iterative decoding conserves power consumption by the receiver. The output port of the decoder 106 is connected for supplying the results of its decoding BCH coding to the input port of a BB Frame descrambler 108, which includes a de-jitter buffer and null-packet re-inserter that are not explicitly shown in FIG. 83.

FIG. 83 shows the output port of the BB Frame descrambler 108 connected to supply IP packets to the input port of an internet-protocol packet parser 109. The output port of the IP packet parser 109 is connected to supply IP packets to a packet sorter 110 for sorting IP packets according to their respective packet identifiers (PIDs) to one of the respective input ports of apparatus 111 for utilizing video data packets, apparatus 112 for utilizing audio data packets, and apparatus 113 for utilizing ancillary data packets.

FIG. 83 depicts a single SISO decoder 100 for LDPC coding in cascade connection with a single decoder 106 for BCH coding thereafter. In actual practice there are apt to be at least two such cascade connections available, suitable to respective different sizes of FEC code blocks, with one of these cascade connections selected for supplying decoded data to the input port of the BB frame descrambler 108 in accordance with instructions from the controller 90. Alternatively, decoders for other types of FEC coding replace the decoders 100 and 106 in other receiver apparatus embodying aspects of the invention. For example, a cascade connection of decoders for concatenated RS and turbo coding is used instead of the cascade connection of decoders 100 and 106.

Not all COFDM communication systems will concatenate BCH coding and LDPC coding. Cyclic redundancy check (CRC) coding can be used instead of BCH coding for detecting the successful conclusion of LDPC decoding. In such case, the general structure of COFDM receiver apparatus depicted in FIGS. 82 and 83 is modified to replace the decoder 106 for BCH coding with a decoder for CRC coding. However, unlike the decoder 106 for BCH coding, the decoder for CRC coding will be incapable of correcting remnant errors from iterative decoding of LDPC coding. LDPC coding that lends itself to being successfully decoded in a few iterations will allow the decoder 106 to be replaced by direct connection from the SISO decoder 100 to the input port of the BB Frame descrambler 108. The LDPC block coding that has customarily been used in DTV broadcasting can be replaced with LDPC convolutional coding. Forward-error-correction coding can be used that does not incorporate LDPC coding at all. The techniques for PAPR reduction using single-time retransmission can be applied if multi-level coding (MLC) is used, rather than bit-interleaved coded modulation (BICM). If MLC be used, there is less reason to consider replacing uniform QAM of OFDM carriers with non-uniform QAM than there is for BICM. (Incidentally, convolutional LDPC coding is better adapted to MLC than is block LDPC coding.)

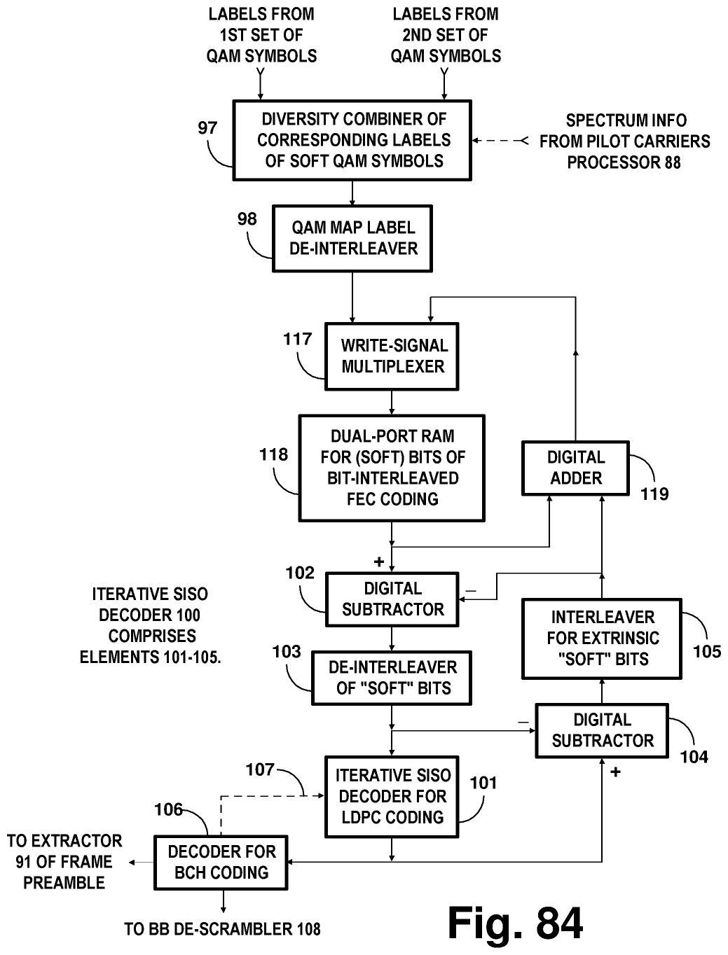

FIG. 84 is a detailed schematic diagram of modifications made to the receiver apparatus shown in FIG. 83. FIG. 84 depicts the iterative SISO decoder 100 for bit-interleaved LDPC coding in further detail as comprising an iterative SISO decoder 101 for LDPC coding, a digital subtractor 102, a de-interleaver 103 of “soft” bits, a digital subtractor 104 and an interleaver 105 for extrinsic “soft” bits. FIG. 84 further depicts a write-signal multiplexer 117, a dual-port random-access memory 118 and a digital adder 119 arranged to cooperate with demappers of QAM symbols to perform soft-demapping and soft-decoding procedures iteratively in accordance with the “turbo” principle. U.S. Pat. No. 6,353,911 titled “Iterative demapping” granted 5 Mar. 2002 to Stefan ten Brink provides generic description of an arrangement for performing such soft-demapping and soft-decoding procedures, which arrangement includes an adaptive QAM demapper. A question that arises with regard to a receiver which includes two QAM demappers, one for the lower subband of an DCM-COFDM signal and the other for its upper subband, concerns how adaptive demapping can be implemented.

FIG. 84 shows the output port of the diversity combiner 97 connected via the QAM map label de-interleaver 98 to a first of two input ports of the write-signal multiplexer 117. The output port of the multiplexer 117 connects to the write-input port of the dual-port random-access memory 118. The diversity combiner 97 periodically supplies soft bits of time-interleaved LDPC-coded data to the input port of the QAM map label de-interleaver 98. The de-interleaver 98 response is supplied to a first input port of the write-signal multiplexer 117, thence to be written into the dual-port RAM 118 via its write-input port. The read-output port of the dual-port RAM 118 connects to a first addend-input port of the digital adder 119, the second addend-input port of which adder 119 is connected for receiving a bit-interleaved extrinsic error signal. The sum output port of the adder 119 connects to the second of the two input ports of the write-signal multiplexer 117.

The read-output port of the dual-port RAM 118 is further connected for supplying a posteriori soft demapping results to the minuend-input port of the digital subtractor 102. The subtrahend-input port of the digital subtractor 102 is connected for receiving the bit-interleaved extrinsic error signal from the output port of the interleaver 105 for extrinsic “soft” bits. The difference output port of the digital subtractor 102 connects to the input port of the de-interleaver 103 for bit-interleaved soft bits. The output port of the de-interleaver 103 connects to the input port of the soft-input/soft-output (SISO) decoder 101 for LDPC coding and further connects to the subtrahend input port of the digital subtractor 104. The minuend input port of the subtractor 104 is connected to receive the soft bits of decoding results from the output port of the SISO decoder 101. The subtractor 104 generates soft extrinsic data bits by comparing the soft output bits supplied from the SISO decoder 101 with soft input bits supplied to the SISO decoder 101. The output port of the subtractor 104 is connected to supply these soft extrinsic data bits to the input port of the bit-interleaver 105, which is complementary to the de-interleaver 103. The output port of the bit-interleaver 105 is connected for feeding back bit-interleaved soft extrinsic data bits to the second addend-input port of the digital adder 119, therein to be additively combined with previous a posteriori soft demapping results read from the dual-port RAM 118 to generate updated a priori soft demapping results to write over the previous ones temporarily stored within that memory 118.

More specifically, the RAM 118 is read concurrently with memory within the bit-interleaver 105, and the soft bits read out in LLR form from the memory 118 are supplied to the first input port of the digital adder 119. The adder 119 adds the interleaved soft extrinsic bits fed back via the interleaver 105 to respective ones of the soft bits of a posteriori soft demapping results read from the RAM 118 to generate updated a priori soft demapping results supplied from the sum output port of the adder 119 to the write-input port of the RAM 118 via the write signal multiplexer 117. The soft bits of previous a posteriori demapping results temporarily stored in the RAM 118 are each written over after its being read and before another soft bit is read.

The output port of the bit-interleaver 105 is also further connected for feeding back bit-interleaved soft extrinsic data bits to the subtrahend input port of the subtractor 102. The subtractor 102 differentially combines the bit-interleaved soft extrinsic data bits fed back to it with respective ones of soft bits of the a posteriori demapping results read from the RAM 118, to generate soft extrinsic data bits for the adaptive soft demapper from the difference-output port of the subtractor 102 for application to the input port of the de-interleaver 103. As thus far described, the SISO decoder 101 and the adaptive soft demapper (comprising elements 97, 98 and 117-119) are in a turbo loop connection with each other, and the turbo cycle of demapping QAM constellations and decoding LDPC can be iterated many times to reduce bit errors in the BCH coding that the SISO decoder 101 finally supplies from its output port to the input port of the decoder 106 for BCH coding. Successful correction of BCH codewords can be used for terminating iterative demapping and decoding of LDPC coding after fewer turbo cycles than the maximum number permitted.

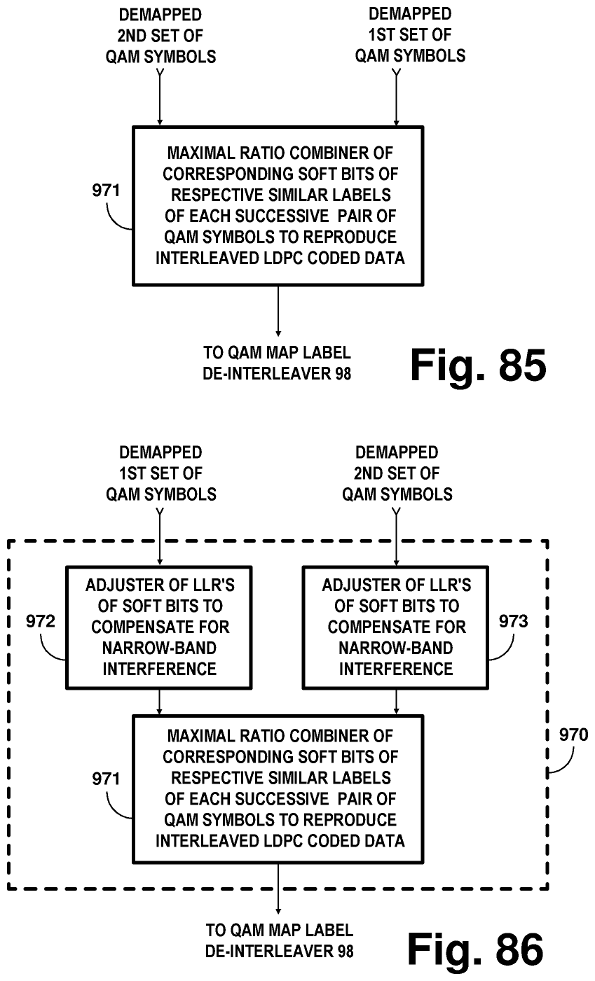

FIG. 85 depicts a soft-bit maximal ratio combiner 971 that is a representative specific structure for the diversity combiner 97. The output port of the soft-bit maximal ratio combiner 971 corresponds to the output port of diversity combiner 97, connecting to the input port of the QAM map label de-interleaver 98. A first of the two input ports of the maximal-ratio combiner 971 is connected to receive the demapped first set of QAM symbols, and the second of the two input ports of the maximal-ratio combiner 971 is connected to receive the demapped second set of QAM symbols. Thus, soft-bit maximal-ratio combining at bit level is performed after QAM demapping, rather than before. Maximal-ratio combining soft bits of corresponding QAM-lattice-point labels improves SNR of reception over an AWGN channel, by as much as 8.5 dB.

Each of the banks 95 and 96 of demappers of QAM symbols comprises a plurality of read-only memories (ROMs), one ROM for each bit of a particular size of QAM map label, which ROMs each receive as input address thereto the complex coordinates descriptive of a current one of a succession of QAM symbols. Each ROM considers the QAM modulation to range over a square arrangement of square “bins”, each of which bins has a respective map label associated therewith. Each ROM generates a respective “soft” bit, a bit metric composed of the more likely one of the “hard” bits 1 and 0 accompanied by a confidence factor. Customarily, the confidence factor is expressed in digitized numerical form as a logarithm of likelihood ratio (LLR) indicating how likely the accompanying decision as to the “hard” bit is correct. The soft-bit maximal-ratio combiner 971 considers 1 and 0 “hard” bits as sign bits when combining the LLRs of each successive pair of “soft” bits in a signed addition. The sign bit of the resultant sum determines the “hard” bit in the “soft” bit response from the maximal-ratio combiner 971 and the rest of this resultant sum determines the LLR of the correctness of this “hard” bit in the “soft” bit response from the maximal-ratio combiner 971.

Each ROM in a demapper of QAM symbols, which ROM is associated with a particular bit of map labeling, can support soft-bit maximal-ratio combining (SBMRC) in the following manner. When the result from demodulating the QAM modulation addresses the center point of the square bin identified by a particular map label, LLR of the particular bit is a value associated with a high level of confidence that the bit is correct. The LLR of the particular bit is reduced from that value when the result from demodulating QAM modulation addresses a point in that square bin approaching a boundary between that square bin and an adjoining square bin associated with opposite hard-bit value. When such boundary is reached the level of confidence in the particular bit being correct is reduced to no more than half its level at the center point of the bin. The level of confidence in the particular bit being correct at the center point of a bin increases is proportional to bin size.

Maximal-ratio combining of frequency-diverse QAM signals is superior to other well-known types of diversity combining when those signals are afflicted by AWGN, atmospheric noise, Johnson noise within the receiver, or imperfect filtering of power from an alternating-current power source. However, maximal-ratio combining of frequency-diverse QAM signals performs less satisfactorily when one QAM signal is corrupted by burst noise or in-channel interfering signal and the other is not. These various conditions of unsatisfactory reception will cause errors in the reproduction of soft bits of FEC-coded data from the maximal-ratio combiner 971. The erroneous bits are dispersed by the QAM map label de-interleaver 98 and by a de-interleaver of soft “bits” within the iterative SISO decoder 100 for LDPC coding, which improves the chances for those erroneous bits to be corrected during the decoding of the forward-error-correction (FEC) coding by the decoders 100 and 106.

FIG. 86 depicts a more complex representative specific structure 970 for the diversity combiner 97, which structure 970 includes the maximal-ratio combiner 971. The structure 970 further includes an adjuster 972 of the LLRs of soft bits of the demapped first set of QAM symbols before their application to the first input port of the maximal-ratio combiner 971. The structure 970 also further includes an adjuster 973 of the LLRs of soft bits of the demapped second set of QAM symbols before their application to the second input port of the maximal-ratio combiner 971. The adjuster 972 reduces the LLRs of soft bits of the demapped first set of QAM symbols supplied to the maximal-ratio combiner 971 when the hard bit portions of those soft bits are well out of normal mapping range, so as to compensate for narrow-band interference or drop-outs in received signal strength. The adjuster 973 reduces the LLRs of soft bits of the demapped second set of QAM symbols supplied to the maximal-ratio combiner 971 when the hard bit portions of those soft bits are well out of normal mapping range, so as to compensate for narrow-band interference and/or for drop-outs in received signal strength. Designs for the adjusters 972 and 973 can, for example, employ techniques similar to those described by Pertti Alapuranen in U.S. Pat. No. 8,775,907 granted to him 8 Jul. 2014 and titled “Orthogonal frequency division multiplexing symbol diversity combiner for burst interference mitigation”.

When dual QAM mapping procedures are applied to a single-sideband COFDM signal, so its frequency spectrum is as illustrated in FIG. 7, the lower and upper half spectra can be detected by heterodyning them with beat-frequency oscillations of nominally the same frequency as a pilot tone at the juncture of those half spectra. These procedures treat the SSB amplitude-modulation signal as an independent-sideband (ISB) signal. These procedures are appreciably less likely to be affected by adjacent-channel interference than the previously described procedures that heterodyne the single-sideband COFDM signal with beat-frequency oscillations of nominally the same frequency as a pilot tone at an edge of the RF channel.

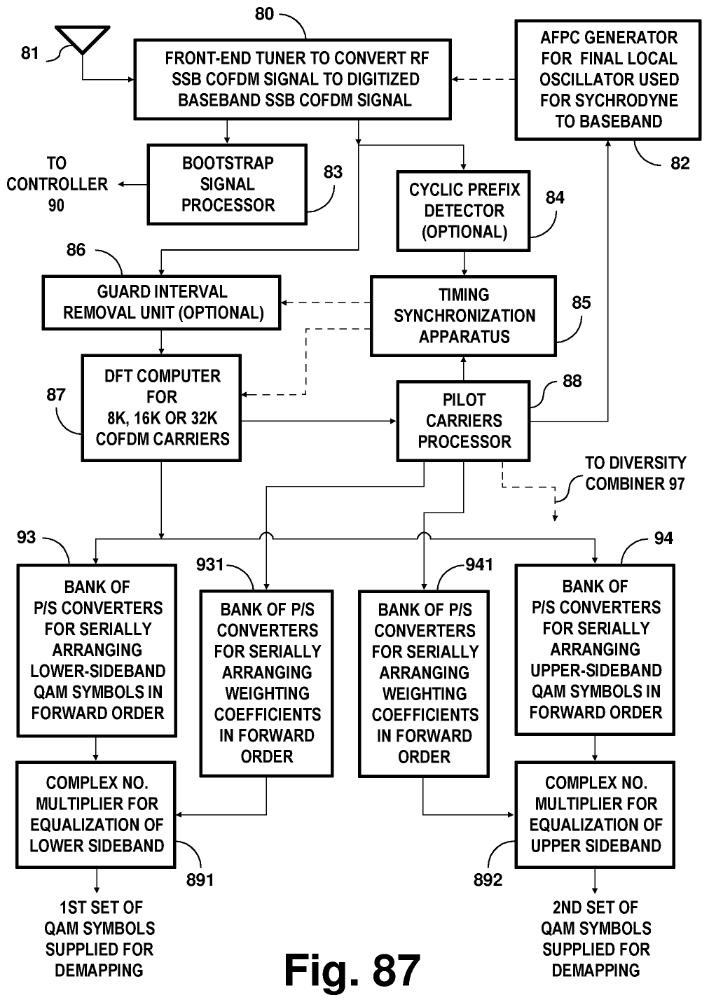

FIG. 87 depicts a variant of the FIG. 82 receiver structure. The channel equalizer 89 that performed multiplications on each of the QAM symbols supplied in parallel from the DFT computer 87 is omitted. A complex-number multiplier 891 performs frequency-domain channel equalization on each of the QAM symbols extracted from the lower subband of the DCM-COFDM signal by the DFT computer 87 after their serialization by a selected one of the parallel-to-serial (P/S) converters in the bank 93 of them. Another complex-number multiplier 892 performs frequency-domain channel equalization on each of the QAM symbols extracted from the upper subband of the DCM-COFDM signal by the DFT computer 87 after their serialization by a selected one of the parallel-to-serial (P/S) converters in the bank 94 of them. The first and second sets of QAM symbols supplied from the respective product output ports of the multipliers 891 and 892 are suitable input signals for subsequent demapping apparatus depicted in FIG. 83.

More particularly, the QAM symbols that the DFT computer 87 extracts from the lower subband of the DCM-COFDM signal are supplied, in parallel and in forward spectral order, directly to the parallel input ports of the selected one of the P/S converters in the bank 93 of them. The output port of that selected P/S converter responds to supply serialized QAM symbols from the lower subband of the DCM-COFDM signal to the multiplicand input port of the multiplier 891. The parallel input ports of a selected one of the parallel-to-serial (P/S) converters in a bank 931 of them receives, in parallel from the pilot carriers processor 88, the weighting coefficients for frequency-domain channel equalization of the lower subband of the DCM-COFDM signal. The output port of that selected P/S converter responds to supply serialized weighting coefficients for the lower subband of the DCM-COFDM signal to the multiplier input port of the complex-number multiplier 891. The multiplier 891 responds to its multiplicand and multiplier input signals to supply from its product output port an equalized first set of QAM symbols, suitable for subsequent demapping.

More particularly, the QAM symbols that the DFT computer 87 extracts from the upper subband of the DCM-COFDM signal are supplied, in parallel and in forward spectral order, directly to the parallel input ports of the selected one of the P/S converters in the bank 94 of them. The output port of that selected P/S converter responds to supply serialized QAM symbols from the upper subband of the DCM-COFDM signal to the multiplicand input port of the multiplier 892. The parallel input ports of a selected one of the parallel-to-serial (P/S) converters in a bank 941 of them receives, in parallel from the pilot carriers processor 88, the weighting coefficients for frequency-domain channel equalization of the upper subband of the DCM-COFDM signal. The output port of that selected P/S converter responds to supply serialized weighting coefficients for the lower subband of the DCM-COFDM signal to the multiplier input port of the complex-number multiplier 892. The multiplier 892 responds to its multiplicand and multiplier input signals to supply from its product output port an equalized second set of QAM symbols, suitable for subsequent demapping.

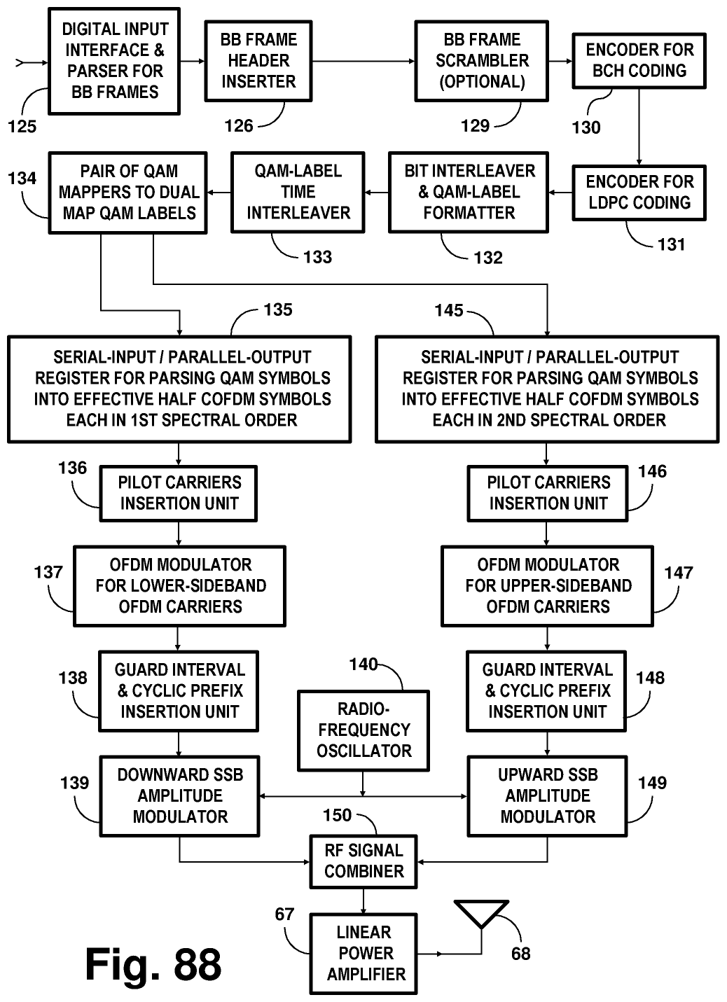

FIG. 88 depicts a transmitter structure for transmitting coded data twice, once in the lower subband of an independent-sideband COFDM signal and once in its upper subband. A digital input interface and parser for baseband frames 125 responds to a digital data stream supplied to its input port for supplying baseband data frames to a baseband frame header inserter 126. FIG. 88 shows the output port of the BB FRAME header inserter 126 connected to the input port of a BBFRAME scrambler 129, which data randomizes the BBFRAME supplied from the output port of the BBFRAME scrambler 129 to the input port of an encoder 130 for BCH coding. If the BBFRAME scrambler 129 is omitted, which omission is optional, the output port of the BBFRAME header inserter 126 can connect directly to the input port of an encoder 130 for BCH coding. FIG. 88 shows the output port of the encoder 130 connected to the input port of an encoder 131 for LDPC coding. FIG. 88 shows the output port of the encoder 131 connected to the input port of a bit-interleaver and QAM label formatter 132. The cascade connection of the encoder 130 for BCH coding and the encoder 131 for LDPC coding is apt to be replaced by means for implementing other forms of forward error-correction coding in some variants of the FIG. 88 structure.

FIG. 88 shows the output port of the bit-interleaver and QAM label formatter 132 connected to the input port of a QAM-label time interleaver 133 and the output port of the QAM-label time interleaver 133 connected to the input port(s) of a pair 134 of QAM mappers that map QAM labels differently, thereby to dual map those QAM labels. The QAM-label time interleaver 133 is omitted in some variants of the FIG. 88 structure in which the output port of the bit-interleaver and QAM label formatter 132 connects directly to the input port(s) of the pair 134 of QAM mappers.

A first of the pair 134 of QAM mappers supplies a first stream of complex coordinates of QAM symbols to a serial-input/parallel-output register 135. The SIPO register 135 parses the QAM symbols into effective half COFDM symbols, arranging the QAM symbols therein in a first spectral order following a cyclic prefix. The parallel output ports of the SIPO register 135 are connected to the parallel input ports of a pilot-carrier symbols insertion unit 136, which introduces pilot symbols for the lower- and upper-frequency edges of the complete half COFDM symbol and introduces pilot carrier symbols at suitable intervals between QAM symbols in each effective half COFDM symbol to generate the rest of a respective complete half COFDM symbol. The parallel output ports of the pilot-carrier symbols insertion unit 136 are connected to the parallel input ports of an OFDM modulator 137 for lower-subband OFDM carriers. The OFDM modulator 137 performs an I-FFT and supplies the results from its output port as amplitude-modulating signal to the modulating-signal input port of a downward single-sideband amplitude modulator 138, there to modulate radio-frequency carrier supplied from the output port of a radio-frequency oscillator 140 to a principal-carrier input port of the SSB amplitude modulator 138.

A second of the pair 134 of QAM mappers supplies a second stream of complex coordinates of QAM symbols to a serial-input/parallel-output register 145. The SIPO register 145 parses the QAM symbols into effective half COFDM symbols, arranging the QAM symbols therein in a second spectral order following a cyclic prefix. The parallel output ports of the SIPO register 145 are connected to the parallel input ports of a pilot-carrier symbols insertion unit 146, which introduces pilot symbols for the lower- and upper-frequency edges of the complete half COFDM symbol and introduces pilot carrier symbols at suitable intervals between QAM symbols in each effective half COFDM symbol to generate the rest of a respective complete half COFDM symbol. The parallel output ports of the pilot insertion unit 146 are connected to the parallel input ports of an OFDM modulator 147 for upper-subband OFDM carriers. The OFDM modulator 147 performs an I-FFT and supplies the results from its output port as amplitude-modulating signal to the modulating-signal input port of an upward single-sideband amplitude modulator 148, there to modulate radio-frequency carrier supplied from the output port of the radio-frequency oscillator 140 to a principal-carrier input port of the SSB amplitude modulator 148.

The pilot-carrier symbols insertion units 136 and 146 combine with the SIPO registers 135 and 145 so as to constitute a COFDM symbol generator for supplying respective halves of COFDM symbols to the OFDM modulators 137 and 147, which halves of COFDM symbols are respectively responsive to first and second sets of QAM symbols supplied from respective ones of the pair 134 of QAM mappers. First and second input ports of a radio-frequency signal combiner 150 are respectively connected for receiving the lower-frequency SSB amplitude-modulated RF signal from the output port of the amplitude modulator 138 and for receiving the upper-frequency SSB amplitude-modulated RF signal from the output port of the amplitude modulator 148. The RF oscillator 140, SSB amplitude modulator 138, SSB amplitude modulator 148 and RF signal combiner 150 combine to constitute a generator of DCM-COFDM radio-frequency signal. Owing to arrangements of first and second sets of successive QAM symbols in the frequency spectrum carried out by the preceding generator of COFDM symbols, the lower-frequency subband of this RF signal conveys the first set of successive QAM symbols and the upper-frequency subband of this RF signal conveys a second set of successive QAM symbols.” The output port of the RF signal combiner 150 is connected for supplying ISB signal to the input port of the linear power amplifier 67, which may be of Doherty type but need not be. The output port of the linear power amplifier 67 is connected for driving RF analog COFDM signal power to the transmission antenna 68. The effective COFDM symbols are caused to have spectral response as shown in FIG. 7 by (a) arranging the SIPO register 135 to parse QAM symbols in descending spectral order in each effective half COFDM symbol for the lower subband and (b) arranging the SIPO register 145 to parse QAM symbols in ascending spectral order in each effective half COFDM symbol for the upper subband.

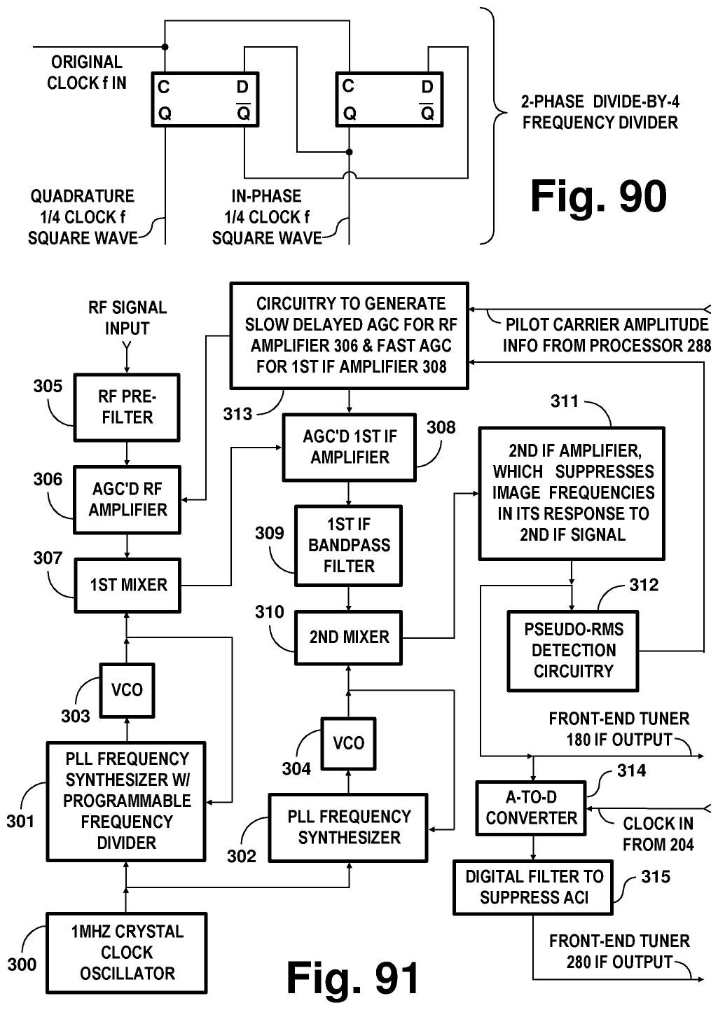

FIGS. 89 and 83 together depict receiver apparatus for independent-sideband (ISB) demodulation of COFDM signals using respective phase-shift methods to respond separately to the concurrent lower and upper subbands of DCM-COFDM signals. The receiver apparatus depicted in FIG. 90 applies the well-known phase-shift methods for demodulating SSB amplitude-modulation signals to demodulating the lower and upper subbands of DCM-COFDM signals to certain extent separately from each other. A reception antenna 81 captures the radio-frequency DCM-COFDM signal for application as input signal to a front-end tuner 180 of the receiver. The front-end tuner 180 converts a selected radio-frequency DCM-COFDM signal to an intermediate-frequency DCM-COFDM signal, which is supplied to the respective signal input ports of mixers 201 and 202.

U.S. Pat. No. 10,171,280 titled “Double-sideband COFDM signal receivers that demodulate unfolded frequency spectrum” issued 1 Jan. 2019 to A. L. R. Limberg based on an application filed 3 Jul. 2017. This patent alludes to its inventor's previous design for a COFDM signal receiver, which employed a beat-frequency oscillator (BFO) supplying in-phase (I) and quadrature-phase (Q) beat-frequency oscillations to the respective carrier input ports of analog mixers via a direct connection and via a −90° phase-shifter, respectively. As pointed out in U.S. Pat. No. 10,171,280 such practice is problematic in the following two respects. It is difficult to realize a phase-shifter with analog circuitry, which phase-shifter provides exact −90° phase shift despite change in BFO frequency. Also, maintaining the amplitudes of the beat-frequency oscillations to the respective carrier input ports of the two analog mixers the same is rather difficult.

The latter of these difficulties is avoided by mixers 201 and 202 being of switching type receiving I and Q square waves at their respective carrier input ports. Fundamental-frequency components of the I and Q square waves that are at quite exactly at 0° and −90° relative phasings, despite change in frequency, are supplied from a 2-phase divide-by-4 frequency divider 203 in response to rising edges of pulses from a clock oscillator 204. The frequency divider 203 can be constructed from two gated D flip flop-flops (or data latches) suitably connected as depicted in FIG. 90. The clock oscillator 204 is subject to automatic frequency and phase control (AFPC) that adjusts the frequency of clock pulses to be four times the final intermediate-frequency (IF) carrier of the COFDM signals. A voltage-controlled crystal oscillator (VCXO) supplying oscillations nominally at 44 MHz is perhaps the optimal choice for the clock oscillator 204. The mixer 201 is conditioned to perform an in-phase synchrodyne of intermediate-frequency DCM-COFDM signal to baseband, responsive to its carrier input port receiving leading in-phase (I) square wave from the frequency divider 203. The mixer 202 is conditioned to perform a quadrature-phase synchrodyne of intermediate-frequency DCM-COFDM signal to baseband, responsive to its carrier input port receiving lagging quadrature-phase (Q) square wave from the frequency divider 203.

An analog-to-digital converter 205 performs analog-to-digital conversion of baseband signal supplied from the output port of the mixer 201. The sampling of the mixer 201 output signal by the A-to-D converter 205 is timed by a first set of alternate clock pulses received from the clock oscillator 204. An analog-to-digital converter 206 performs analog-to-digital conversion of the baseband signal supplied from the output port of the mixer 202. The sampling of the mixer 202 output signal by the A-to-D converter 206 is timed by a second set of alternate clock pulses received from the clock oscillator 204. The digitized in-phase baseband signal supplied from the output port of the A-to-D converter 205 is supplied to the input port of a digital lowpass filter 207. The digitized quadrature-phase baseband signal supplied from the output port of the A-to-D converter 206 is supplied to the input port of a digital lowpass filter 208. The digital lowpass filters 207 and 208 are of similar design, each to supply a response to a respective subband which response is free of components of image signal remnant from the synchrodyning procedures. Preferably, that is, the design of the digital lowpass filters 207 and 208 provides a rapid roll-off of their higher-frequency responses, so as to suppress adjacent-channel interference (ACI).

The response of the digital lowpass filter 208 to quadrature-phase baseband signal is supplied to the input port of a finite-impulse-response digital filter 209 for Hilbert transformation. The response of the digital lowpass filter 207 to in-phase baseband signal is supplied to the input port of a clocked digital delay line 210 that affords delay to compensate for the latent delay through the FIR filter 209. The Hilbert transform response of the FIR filter 209 and the response of the digital delay line 210 are supplied to respective addend input ports of a digital adder 211 operative to recover, at baseband, the lower subband of the DCM-COFDM signal at its sum output port. The Hilbert transform response of the FIR filter 209 and the response of the digital delay line 210 are supplied respectively to the minuend input port and the subtrahend input port of a digital subtractor 212 operative to recover, at baseband, the upper subband of the DCM-COFDM signal at its difference output port.

The sum output port of the digital adder 211 connects to the input port of a guard interval remover 861. The output port of the guard interval remover 861 is connected for supplying the input port of a discrete-Fourier-transform (DFT) computer 871 with windowed portions of the baseband digitized lower subband of the DCM-COFDM signal that span respective COFDM symbol intervals. The complex coordinates of QAM symbols the DFT computer 871 extracts from lower subband carriers in each COFDM symbol sampling interval that convey coded data are supplied as parallel input signal to a frequency-domain channel equalizer 893 for just those QAM symbols connected for supplying equalized QAM symbols to the parallel inputs of the P/S converter 93 in the FIG. 83 portion of the television receiver.

Subsequent to the recovery of the digitized upper subband of the DCM-COFDM signal at baseband by phase shift method, it is supplied from the difference output port of the digital subtractor 212 to the input port of a guard interval remover 862. The output port of the guard interval remover 862 is connected for supplying the input port of a DFT computer 872 with windowed portions of the baseband digitized upper subband of the DCM-COFDM signal that span respective COFDM symbol intervals. The complex coordinates of QAM symbols the DFT computer 872 extracts from upper subband carriers in each COFDM symbol sampling interval that convey coded data are supplied as parallel input signal to a frequency-domain channel equalizer 894 for just those QAM symbols. Parallel output ports of the channel equalizer 894 are connected for supplying equalized QAM symbols to the parallel inputs of the P/S converter 94 in the FIG. 83 portion of the television receiver.

The DFT computers 871 and 872 are similar in construction, each configured so it can demodulate any one of 4K, 8K or 16K options as to half the nominal number of OFDM carriers. The correct option is chosen responsive to an instruction from a controller 90 that generates a number of instructions used to configure the COFDM receiver to suit the broadcast standard used transmissions currently received. The bootstrap signal processor 83, the controller 90, the extractor 91 of FEC frame preambles, and the processor 92 of COFDM frame preambles are not explicitly depicted in any of the FIGS. 84, 87, 89, 92, 93, 94, 96 and 97, but such elements are implicitly included in the structure of each of the DCM-COFDM receivers shown in part in these figures of the drawing.

The guard interval removers 861 and 862 are each constructed similarly to the guard interval remover 86 in the FIG. 82 receiver apparatus, removing guard intervals responsive to the occurrences of cyclic prefixes having been detected by a cyclic prefix detector 84. FIG. 89 shows the input port of the cyclic prefix detector 84 connected for detecting the occurrences of cyclic prefixes in the digitized upper subband of the DCM-COFDM signal supplied at baseband from the output port of the digital subtractor 212. Alternatively, the input port of the cyclic prefix detector 84 can instead be connected for detecting the occurrences of cyclic prefixes in the digitized lower subband of the DCM-COFDM signal supplied at baseband from the output port of the digital adder 211. The cyclic prefix detector 84 differentially combines the digitized samples of baseband COFDM signal with those samples as delayed by the duration of an effective COFDM symbol. Nulls in the difference signal so generated should occur, marking the guard intervals of the baseband COFDM signal. The nulls are processed to reduce any corruption caused by noise and to generate better-defined indications of the phasing of COFDM symbols. The output port of the cyclic prefix detector 84 is connected to supply these indications to a first of two input ports of timing synchronization apparatus 285. First and second output ports of the timing synchronization apparatus 285 are connected for supplying similar gating control signals to the control input ports of the guard interval removers 861 and 862. Third and fourth output ports of the timing synchronization apparatus 285 are connected for supplying indications of the phasing of COFDM symbols to the DFT computers 871 and 872 respectively.

The complex coordinates of QAM symbols extracted from pilot carriers in each COFDM symbol sampling interval are supplied as parallel input signal to a pilot carriers processor 288. The pilot carriers processor 288 responds to complex coordinates of QAM symbols extracted from lower-subband pilot carriers to generate weighting coefficients for the frequency-domain channel equalizer 893 to apply to QAM symbols extracted from the upper subband of the DCM-COFDM signal. A first of five output ports of the processor 288 that are explicitly shown in FIG. 89 is connected for supplying these weighting coefficients (via wiring depicted as a dashed-line connection) to the frequency-domain channel equalizer 893, which uses those weighting coefficients for adjusting its responses to the demodulation results for each of the lower-subband COFDM carriers that convey data. The pilot carriers processor 288 responds to complex coordinates of QAM symbols extracted from upper-subband pilot carriers to generate weighting coefficients for the frequency-domain channel equalizer 894 to apply to QAM symbols extracted from the upper subband of the DCM-COFDM signal. A second of the five output ports of the processor 288 that are explicitly shown in FIG. 89 is connected for supplying these weighting coefficients (via wiring depicted as a dashed-line connection) to the frequency-domain channel equalizer 894, which uses them for adjusting its responses to the demodulation results for each of the upper-subband COFDM carriers that convey data.

A third of the output ports of the pilot carriers processor 288 that are explicitly shown in FIG. 89 is connected for supplying more accurate window-positioning information to the second input port of the timing synchronization apparatus 285. This window-positioning information is an adjustment generated by a feedback loop that seeks to minimize the noise accompanying pilot carriers, which noise increases owing to intercarrier interference from adjoining modulated carriers when window positioning is not optimal. A fourth of the output ports of the pilot carriers processor 288 explicitly shown in FIG. 89 is connected for forwarding automatic frequency and phase control (AFPC) developed from unmodulated pilot carriers to the AFPC input port of the clock oscillator 204. The real components of the unmodulated pilot carriers are multiplied by their respective imaginary components in the pilot carriers processor 288. The processor 288 sums and low-pass filters the resulting products to develop the AFPC signal that the processor 288 supplies to the clock oscillator 204. Responsive to this AFPC signal, the clock oscillator 204 regulates the frequency of its oscillations to be four times the carrier frequency of the final IF signal that the front-end tuner 180 supplies to the input ports of the mixers 201 and 202. This AFPC signal controls the frequency and phase of the clock pulses that the clock oscillator 204 supplies to the 2-phase divide-by-4 frequency divider 203.

A fifth of the output ports of the pilot carriers processor 288 explicitly shown in FIG. 89 is connected for supplying a diversity combiner 97 (as depicted in FIG. 83 or in FIG. 84) with information concerning the frequency spectrum of each successive COFDM symbol.

FIG. 90 depicts two data latches i.e., gated D flip-flops connected to provide a two-phase divide-by-four frequency divider, such as the frequency divider 203 depicted in FIG. 89. The respective clock (C) input connections of the two data latches are each connected for receiving an original clock signal of frequency f, which clock signal is received from the clock oscillator 204 for the frequency divider 203 depicted in FIG. 89. Each of the two data latches has its own normal (Q) output connection and its own complementary (Q) output connection. There is wire connection from the complementary (Q) output connection of the data latch at left to the data (D) input connection of the data latch at right, and there is wire connection from the normal (Q) output connection of the data latch at right to the data (D) input connection of the data latch at left. The normal (Q) output connection of the data latch at right supplies a leading square wave having an “in-phase” fundamental frequency f/4, and the normal (Q) output connection of the data latch at left supplies a lagging square wave having a “quadrature-phase” fundamental frequency f/4 that lags the “in-phase” fundamental frequency by 90°.

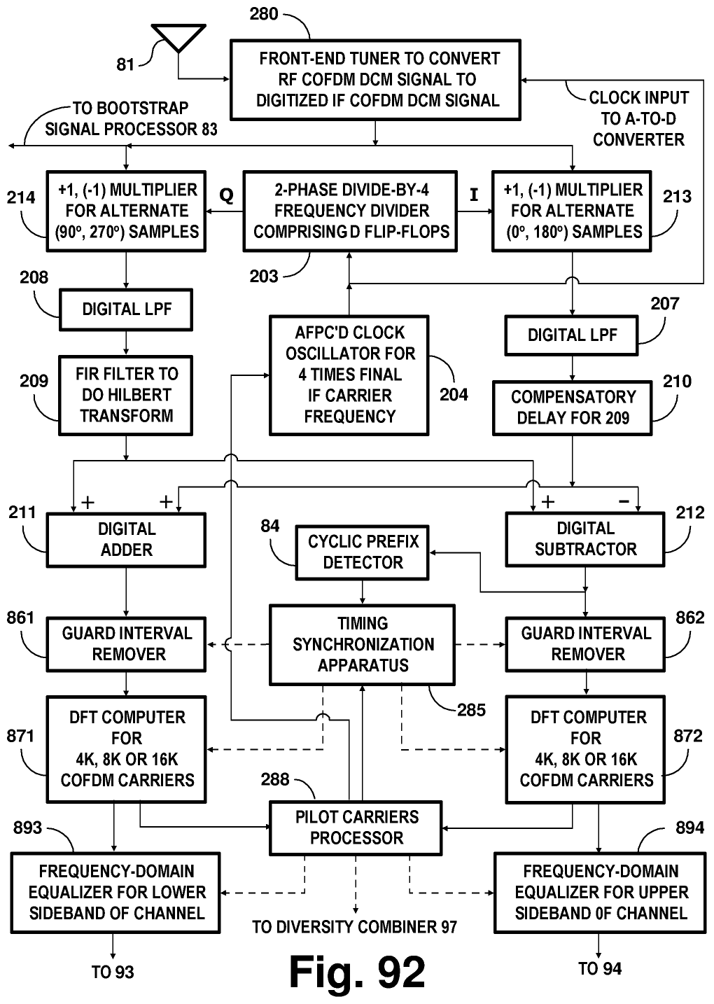

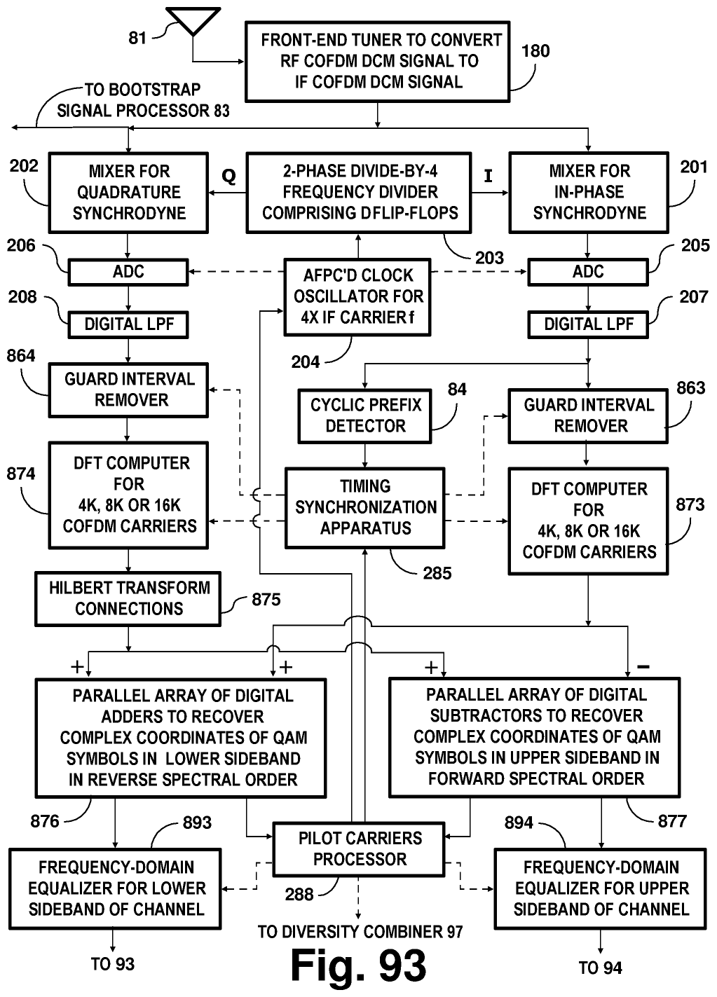

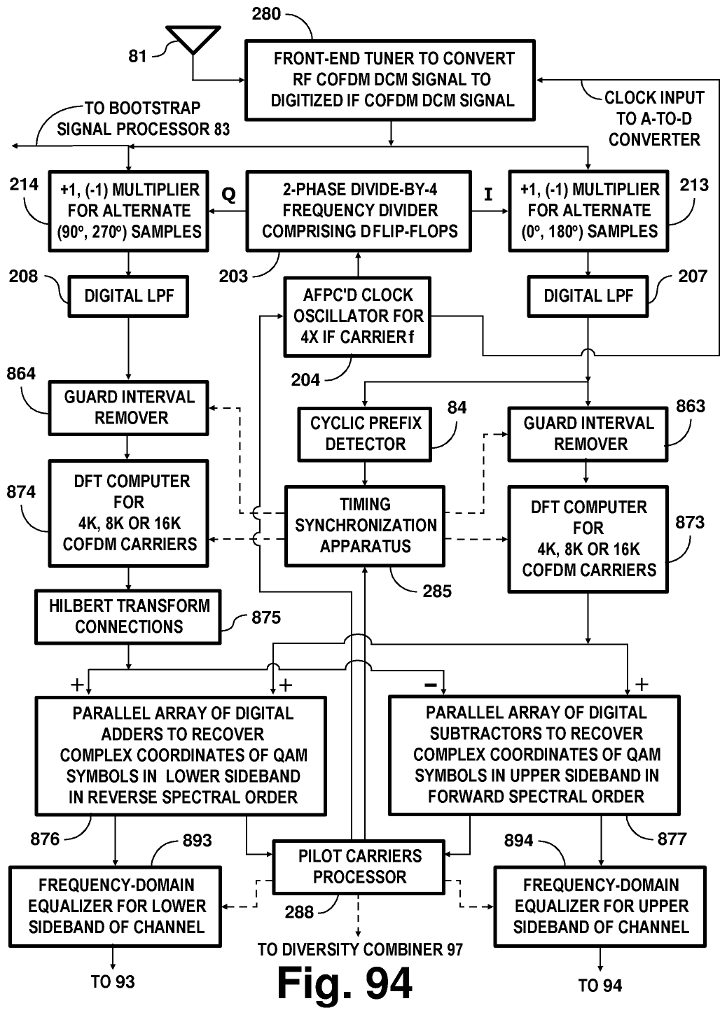

FIG. 91 depicts double-conversion front-end tuner structure suitable for the front-end tuner 180 depicted in FIGS. 89 and 93, and for the front-end tuner 280 depicted in FIGS. 92 and 94. Double-conversion front-end tuners are particularly advantageous over single-conversion front-end tuners when more television channels are more closely packed within the allocated television frequency spectrum. The structure is quite similar in general aspects to that described in U.S. Pat. No. 6,118,499 titled “Digital television signal receiver” granted to George Fang on 12 Sep. 2000. In a first frequency-conversion a selected radio-frequency DCM-COFDM signal is up-converted in frequency to first-intermediate-frequency DCM-COFDM signal at frequencies above the UHF television broadcasting band. The first-IF DCM-COFDM signal is suitable for surface-acoustic-wave (SAW) bandpass filtering. In a second frequency-conversion the bandpass-filtered first-IF DCM-COFDM signal is down-converted to second-intermediate-frequency DCM-COFDM signal at frequencies substantially below the conventional “final intermediate frequency” (e.g., 41 to 47 MHz in U.S. television receivers). The second-IF DCM-COFDM signal is at a sufficiently low frequency such that it can be directly sampled by an analog-to-digital converter after lowpass filtering to suppress image signal.

In FIG. 91 a crystal oscillator 300 is connected for supplying 1 MHz reference oscillations to phase-lock-loop frequency synthesizers 301 and 302. The PLL frequency synthesizer 301 is connected for supplying automatic frequency and phase control (AFPC) voltage to a voltage-controlled oscillator 303, which VCO 303 generates the first local oscillations used in the upward conversion of radio-frequency DCM-COFDM signal to first-IF DCM-COFDM signal. The PLL frequency synthesizer 302 is connected for supplying AFPC voltage to a voltage-controlled oscillator 304, which VCO 304 generates the second local oscillations used in the downward conversion of first-IF DCM-COFDM signal to second-IF DCM-COFDM signal.

The PLL frequency synthesizer 301 includes a programmable frequency divider, a clocked counter that counts the first local oscillations supplied to its counter input connection from the VCO 303. When the count reaches a selected large positive integer, the counter resets to zero count and generates a carry pulse supplied to an AFPC detector within the PLL frequency synthesizer 301. Responsive to carry pulses from the counter, that AFPC detector samples the 1 MHz oscillations from the crystal oscillator and integrates the response of such sampling to generate the AFPC voltage applied to the VCO 303. The crystal oscillator 300 is designed for supplying 1 MHz reference oscillations since it is the largest common submultiple of the central carrier frequencies of all the allocated TV broadcast channels in the U.S.A.

The PLL frequency synthesizer 302 includes a fixed frequency divider, a clocked counter that counts the second local oscillations supplied to its counter input connection from the VCO 304. When the count reaches a prescribed large positive integer, the counter resets to zero count and generates a carry pulse supplied to an AFPC detector within the PLL frequency synthesizer 302. Responsive to carry pulses from the counter, that AFPC detector samples the 1 MHz oscillations from the crystal oscillator and integrates the response of such sampling to generate the AFPC voltage applied to the VCO 304. Choosing the prescribed large positive integer at which the counter in the PLL frequency synthesizer 302 resets to zero count is preferably done so as to position the central carrier frequency of the second-IF DCM-COFDM signal at 11 MHz. This frequency is low enough that analog-to-digital conversion of the second-IF DCM-COFDM signal is practical. Also, the fourth harmonic of the central carrier frequency of the second-IF signal is at 44 MHZ, which is at the center of the 41-47 megahertz final IF signals commonly used in prior-art television receivers. Since these frequencies are not allocated for high-power RF transmissions, this reduces the possibility of strong interference with operation of the clock oscillator 204 depicted in FIGS. 89, 92, 93, 94, 96 and 97.

The input port of a pre-filter 305 is connected for receiving radio-frequency (RF) COFDM signal supplied by an antenna or a cable distribution system. (The pre-filter 305 is typically constructed either as a group of fixed frequency band pass filters, or as a tracking type of filter.) The pre-filter 305 reduces the bandwidth of the signal entering the subsequent radio-frequency amplifier 306, which RF amplifier 306 is subject to automatic gain control (AGC). The pre-filter 305 reduces the number of channels amplified by the AGC'd RF amplifier 306, thereby reducing the intermodulation interference generated by the amplifier 306 and subsequent circuits. In a pre-filter 305 comprising a group of fixed-frequency bandpass filters, the proper band is selected according to channel selection information supplied from a controller not explicitly depicted in FIG. 91. Alternatively, in a tracking type pre-filter, an analog control voltage is generated responsive to channel selection information supplied from the controller. The controller also supplies the channel selection information to the PLL frequency synthesizer 301 for determining the frequency division its programmable frequency divider affords to oscillations supplied thereto from the VCO 303.

The RF output of the pre-filter 305 is amplified or attenuated to a desired level by the AGC'd RF amplifier 306 and then supplied to a first mixer 307, there to be mixed with first local oscillations from the VCO 303. The signal at the output port of first mixer 307, resulting from the desired TV channel signal being multiplied by the VCO 303 oscillations, is defined as the first intermediate frequency signal. The frequency of this first-IF signal is the difference between the frequency of the VCO 303 first local oscillations and the frequency of the DCM-COFDM signal to be received. Since the mixer 307 shifts the spectrum of the desired TV channel to a frequency higher than the TV broadcast frequency, this operation is referred to as an up-conversion. The first-IF is chosen to be above all of the spectrum used by terrestrial or cable distribution TV broadcasting in the particular environment in which the tuner operates in. By this choice, the image frequency (the frequency which is the numerical sum of the VCO 303 signal and the first-IF frequency) generated in the up-conversion process can be rejected by the pre-filter 305. This choice of first intermediate frequencies also requires the frequency of the VCO 304 to be above the spectrum used by TV broadcasting, thereby avoiding other possible interference.

The first-IF output signal supplied from the mixer 307 is amplified by a narrow-band amplifier 308 and then supplied to a first-IF bandpass filter 309 such as a dielectric resonance filter, a strip-line filter or a SAW filter. The characteristics of the first-IF BPF 309 are designed, with consideration to the characteristics of subsequent digital filtering that will be used to suppress ACI (adjacent-channel interference). I.e., the bandwidth of the first-IF BPF 309 is no less than that of a single digital TV channel, and the passband group delay response is sufficiently linear so as not to cause adverse effects on subsequent demodulation of a second-intermediate-frequency (second-IF) DCM-COFDM signal. Furthermore, the first-IF BPF 309 is designed to have sufficient out-of-band attenuation at the image frequency range of the subsequent down-conversion process by a second mixer 310 so as not to introduce excessive image frequency interference to degrade the performance of the subsequent demodulation of the second-IF DCM-COFDM signal. (In alternative front-end tuner designs the positions of the first-IF amplifier 308 and the first-IF BPF 309 within their cascade connection are interchanged.)

The output signal from the first-IF BPF 309 principally consists of just the desired TV channel signal as up-converted, possibly accompanied by small amounts of up-converted adjacent-channel signals that have not been completely attenuated owing to the band-edge roll-off characteristics of BPF 309. This signal is supplied to a second mixer 310 to be mixed with second local oscillations, which are supplied from the VCO 304. The signal supplied from the output port of the mixer 310, resulting from the first-IF DCM-COFDM signal being multiplied by second local oscillations from the VCO 304, is defined as the second-intermediate-frequency (second-IF) DCM-COFDM signal. The frequency of this second-IF DCM-COFDM signal is the numerical difference between the frequency of second local oscillations from the VCO 304 and the somewhat lower frequencies of the first-IF DCM-COFDM signal. The second-IF DCM-COFDM signal supplied from the output port of the mixer 310 is amplified by a second IF amplifier 311 of such design as to suppress image signals that have frequencies almost twice that of the frequency of the second local oscillations above the UHF TV band. Since the mixer 310 shifts the first-IF signal to a lower frequency, this operation is referred to as a down-conversion.

The amplified second-IF DCM-COFDM signal supplied from the output port of the second IF amplifier 311 is applied to the input port of pseudo-RMS detection circuitry 312. The output port of the pseudo-RMS detection circuitry 312 is connected for supplying an approximation of the RMS (root-mean-square) voltage of the response from the second IF amplifier 311 to a first input port of circuitry 313 for generating respective automatic gain control (AGC) signals for the RF amplifier 306 and for the first-IF amplifier 308. The peak-to-average ratio (PAPR) of COFDM signals is very high, and occasional peak clipping of them is better design. Detecting the peak voltage of the response from the second-IF amplifier 311 would not provide a good basis from which to develop AGC signals.

A second port of the circuitry 313 for generating AGC signals is connected for receiving pilot carrier amplitude information from the pilot carriers processor 288 depicted in FIG. 89 or any of FIGS. 92, 93 and 94. The pilot carrier amplitude information provides a more precise basis for assuring that the level of response from the second IF amplifier 311 is adjusted to suit subsequent analog-to-digital conversion and QAM demapping procedures.

Designs of circuitry for generating AGC signals in double-conversion radio receivers are known in the prior art. The circuitry 313 generates delayed AGC signal for the RF amplifier 306, avoiding reduction of the RF amplifier 306 gain as long as RF signal strength is not so strong that RF amplifier 306 response consistently drives the first mixer 307 outside its range of acceptably linear response. During the reception of such weaker strength RF signals, the circuitry 313 generates AGC signal for the first-IF amplifier 308 that regulates its gain control to maintain desired value of the approximate RMS value of the second IF amplifier 311 response. This maintains the second mixer 310 within its range of acceptably linear response. The circuitry 313 generates the delayed AGC signal for the RF amplifier 306 so as to exhibit slower response to second IF amplifier 311 output signal than the AGC signal for the first-IF amplifier 308. This accommodates clipping of occasional extraordinarily large peaks of received COFDM signal in the first mixer 307 and the RF amplifier 306. The AGC signal for the first-IF amplifier 308 that circuitry 313 generates no longer reduces the gain of the first-IF amplifier 308 when circuitry 313 supplies delayed-AGC signal to the RF amplifier 306 for reducing its gain.

In a front-end tuner 280 configuration as used in FIGS. 92 and 94, the amplified second-IF DCM-COFDM signal supplied from the output port of the second IF amplifier 311 is supplied to the input port of an analog-to-digital converter 314. The A-to-D converter 314 samples the amplified second-IF DCM-COFDM signal at a clock rate determined by the clock oscillator 204 depicted in FIG. 92 or 94. The output port of the A-to-D converter 314 is connected for supplying the resulting digitized second-IF DCM-COFDM signal to the input port of a digital bandpass filter 315. Both the lower- and higher-frequency roll-offs of the bandpass response at the output port of the filter 315 are very steep, better to suppress adjacent-channel interference (ACI). The bandpass-filtered digital second-IF DCM-COFDM signal supplied from the output port of the filter 315 is suitable to provide the intermediate-frequency DCM-COFDM output signal for a front-end tuner 280 configuration.

The amplified second-IF DCM-COFDM signal supplied from the output port of the second IF amplifier 311 is suitable to provide the intermediate-frequency DCM-COFDM output signal for a front-end tuner 180 configuration. In such front-end tuner 180 configuration the A-to-D converter 314 and the digital bandpass filter 315 are unnecessary and can be omitted.

FIGS. 92 and 83 together depict a variant of the receiver apparatus for independent-sideband (ISB) demodulation of DCM-COFDM depicted in FIGS. 89 and 83, digital circuitry shown in FIG. 92 replacing some of the analog circuitry shown in FIG. 89. The front-end tuner 180 of FIG. 89 that converts a selected radio-frequency DCM-COFDM signal to an analog intermediate-frequency DCM-COFDM signal is replaced in FIG. 92 by a front-end tuner 280 that converts a selected RF DCM-COFDM signal to a digitized intermediate-frequency DCM-COFDM signal. This digitized DCM-COFDM signal is supplied from the output port of the front-end tuner 280 to respective signal input ports of +1, (−1) multipliers 213 and 214. A 2-phase divide-by-4 frequency divider 203 responds to rising edges of pulses from a clock oscillator 204, by supplying I and Q square waves to respective carrier input ports of the +1, (−1) multipliers 213 and 214. The clock oscillator 204 is subject to automatic frequency and phase control (AFPC) that adjusts the frequency of clock pulses to be four times the final intermediate-frequency (IF) carrier of the COFDM signals. The clock oscillator 204 is connected for supplying the clock pulses to an analog-to-digital converter in the front-end tuner 280, which A-to-D converter digitizes the intermediate-frequency DCM-COFDM signal supplied to respective signal input ports of the +1, (−1) multipliers 213 and 214.

The leading I square wave that the frequency divider 203 supplies to the control input port of the +1, (−1) multiplier 213 conditions the +1, (−1) multiplier 213 to perform a 2-to-1 decimation of the 0°, 90°, 1800 and 2700 digital samples of DCM-COFDM signal supplied to its input port, selecting the 0° digital samples for multiplication by +1 responsive to positive half cycles of I square wave, and selecting the 180 digital samples for multiplication by −1 responsive to negative half cycles of I square wave. The output port of the +1, (−1) multiplier 213 is connected for supplying the in-phase synchrodyne results to the input port of a digital lowpass filter 207. The lowpass filter 207 responds to the baseband portion of the in-phase synchrodyne results, but not to image signal. FIG. 92 shows the output port of the lowpass filter 207 connected for supplying its response the input port of the clocked digital delay line 210 providing compensatory delay for the latent delay of the digital FIR filter 209 used to perform Hilbert transformation.

The lagging Q square wave that the frequency divider 203 supplies to the control input port of the +1, (−1) multiplier 214 conditions the +1, (−1) multiplier 214 to perform a 2-to-1 decimation of the 0°, 90°, 1800 and 2700 digital samples of DCM-COFDM signal supplied to its input port, selecting the 900 digital samples for multiplication by −1 responsive to negative half cycles of Q square wave, and selecting the 2700 digital samples for multiplication by +1 responsive to positive half cycles of Q square wave. The output port of the +1, (−1) multiplier 214 is connected for supplying quadrature-phase synchrodyne results to the input port of to the input port of a digital lowpass filter 208. The lowpass filter 208 responds to the baseband portion of the quadrature-phase synchrodyne results, but not to image signal. FIG. 92 shows the output port of the lowpass filter 208 connected for supplying its response the input port of the FIR filter 209 for performing Hilbert transformation.

If the front-end tuner 280 contains digital lowpass filtering of the digitized IF DCM-COFDM signal with rapid roll-off to suppress ACI, there is no reason for the digital lowpass filters 207 and 208 necessarily having to have sharp roll-offs of higher frequencies to suppress AC. The Hilbert transform response of the FIR filter 209 and the response from digital delay line 210 are utilized in the subsequent portions of the FIG. 92 and FIG. 83 receiver apparatus in the same way as in the corresponding portions of the FIG. 89 and FIG. 83 receiver apparatus.

FIGS. 93 and 83 together depict another general structure of receiver apparatus for ISB demodulation of DCM-COFDM signals. In accordance with further aspects of the invention, the portion of this receiver apparatus employs phase-shift methods of ISB demodulation modified in a novel first manner particularly well suited for DCM-COFDM signals. However, initial portions of the FIG. 93 apparatus are similar to the initial portions of the FIG. 89 apparatus.

As with the FIG. 89 apparatus, a reception antenna 81 captures the radio-frequency DCM-COFDM signal for application as input signal to a front-end tuner 180 of the receiver. The front-end tuner 180 converts a selected radio-frequency DCM-COFDM signal to an intermediate-frequency DCM-COFDM signal, which is supplied to the respective signal input ports of mixers 201 and 202. The mixers 201 and 202 are of switching type connected for receiving I and Q square waves at their respective carrier input ports, as supplied from a 2-phase divide-by-4 frequency divider 203 in response to rising edges of pulses from a clock oscillator 204. The clock oscillator 204 is subject to AFPC that adjusts the frequency of clock pulses to be four times the final IF carrier of the COFDM signals. The leading in-phase (I) square wave, which the frequency divider 203 supplies to the carrier input port of the mixer 201, conditions the mixer 201 to provide an in-phase synchrodyning of intermediate-frequency DCM-COFDM signal to baseband. The lagging quadrature-phase (Q) square wave, which the frequency divider 203 supplies to the carrier input port of the mixer 202, conditions the mixer 202 to provide a quadrature-phase synchrodyning of intermediate-frequency DCM-COFDM signal to baseband.

As with the FIG. 89 apparatus, an A-to-D converter 205 performs analog-to-digital conversion of the baseband signal supplied from the output port of the mixer 201 in the FIG. 93 apparatus. The digitized in-phase baseband signal supplied from the output port of the A-to-D converter 205 is supplied to the input port of a digital lowpass filter 208. An A-to-D converter 206 performs analog-to-digital conversion of the baseband signal supplied from the output port of the mixer 202. The digitized quadrature-phase baseband signal supplied from the output port of the A-to-D converter 206 is supplied to the input port of a digital lowpass filter 208.

Subsequent portions of the FIG. 93 apparatus differ from subsequent portions of the FIG. 89 apparatus. The digital FIR filter 209 that the FIG. 89 apparatus includes for performing Hilbert transform is complex in nature and takes up considerable area on the silicon die in a monolithic integrated circuit construction. The FIG. 93 apparatus dispenses with the digital FIR filter 209, the digital delay line 210, the digital adder 211, and the digital subtractor 212.

The digital lowpass filter 207 is connected for supplying digitized samples of baseband folded DCM-COFDM signal to the input port of the cyclic prefix detector 84. (Alternatively, the digital lowpass filter 208 is connected for supplying digitized samples of baseband folded DCM-COFDM signal to the input port of the cyclic prefix detector 84 instead). The cyclic prefix detector 84 differentially combines the digitized samples of baseband folded DCM-COFDM signal with those samples as delayed by the duration of an effective COFDM symbol. Nulls in the difference signal so generated should occur, marking the guard intervals of the baseband folded DCM-COFDM signal. The nulls are processed to reduce any corruption caused by noise and to generate better-defined indications of the phasing of COFDM symbols. The output port of the cyclic prefix detector 84 is connected to supply these indications to the first of two input ports of the timing synchronization apparatus 285.

The signal input port of a guard interval remover 863 is connected for receiving digitized samples of an in-phase baseband COFDM signal from the output port of the digital lowpass filter 207. The output port of the guard interval remover 863 is connected for supplying the input port of a discrete-Fourier-transform (DFT) computer 873 with windowed portions of the quadrature-phase baseband signal that span respective COFDM symbol intervals. The signal input port of the guard interval remover 864 is connected for receiving digitized samples of a quadrature-phase baseband COFDM signal from the output port of the digital lowpass filter 208. The output port of the guard interval remover 864 is connected for supplying the input port of a discrete-Fourier-transform (DFT) computer 874 with windowed portions of the in-phase baseband signal that span respective COFDM symbol intervals. The DFT computers 873 and 874 are similar in construction, each having the capability of transforming a respective half of the COFDM carriers nominally 4K, 8K or 16K in number to the complex coordinates of respective QAM symbols. The DFT computers 873 and 874 perform bandpass filtering of individual OFDM carriers which bandpass filtering should be unresponsive to frequencies outside baseband. This bandpass filtering may allow digital lowpass filters 207 and 208 to be replaced by respective direct connections in modified FIG. 93 structure.

The timing synchronization apparatus 285 is connected for supplying gating control signals to respective control input ports of the guard interval removers 863 and 864. The timing synchronization apparatus 285 is further connected for supplying COFDM symbol timing information to the DFT computers 873 and 874. The indications concerning the phasing of COFDM symbols that the cyclic prefix detector 84 supplies to the timing synchronization apparatus 285 are sufficiently accurate for (a) initial windowing of the in-phase baseband folded COFDM signal that the guard interval remover 863 supplies to the DFT computer 873 and (b) initial windowing of the quadrature-phase baseband folded COFDM signal that the guard interval remover 862 supplies to the DFT computer 874.

The output port of the DFT computer 874 is connected via Hilbert transformation connections 875 for supplying complex coordinates of QAM symbols conveyed by respective ones of the received COFDM carriers to first addend input ports of a parallel array 876 of digital complex-number adders and to minuend input ports of a parallel array 877 of digital complex-number subtractors. These connections 875 are such as to perform Hilbert transform of the complex coordinates of QAM symbols, which procedure is explained in greater detail in the remaining portion of this paragraph. The real coordinates of the complex coordinates of QAM symbols are applied as imaginary components of input signals to the first addend input ports of the parallel array 876 of digital adders and to the minuend input ports of the parallel array 877 of digital subtractors. The imaginary coordinates of the complex coordinates of QAM symbols are applied as real components of input signals to the first addend input ports of the parallel array 876 of digital adders and to the minuend input ports of the parallel array 877 of digital subtractors. There is essentially no delay in this Hilbert transformation procedure, and it takes up little (if any) extra area on the silicon die in a monolithic integrated circuit construction. The output port of the DFT computer 873 is connected for supplying complex coordinates of QAM symbols conveyed by respective ones of the received COFDM carriers to second addend input ports of the parallel array 876 of digital complex-number adders and to subtrahend input ports of the parallel array 877 of digital complex-number subtractors.

The parallel array 876 of digital adders additively combines the complex coordinates of QAM symbols the DFT computer 873 generates, as transformed by the Hilbert transformation connections 875, with the complex coordinates of corresponding QAM symbols the DFT computer 874 generates. The sum output ports of the parallel array 876 of digital adders recover at baseband the complex coordinates of QAM symbols from the lower subband of the DCM-COFDM signal. The complex coordinates of QAM symbols extracted from pilot carriers in each COFDM symbol sampling interval are supplied as parallel input signal to the pilot carriers processor 288. The complex coordinates of QAM symbols extracted from carriers in each COFDM symbol sampling interval that convey coded data are supplied as parallel input signal to the frequency-domain channel equalizer 893 for QAM symbols extracted from the lower subband of the DCM-COFDM signal.

The parallel array 877 of digital subtractors differentially combines the complex coordinates of QAM symbols the DFT computer 874 generates, as transformed by the Hilbert transformation connections 875, with the complex coordinates of corresponding QAM symbols the DFT computer 873 generates. The difference output ports of the parallel array 877 of digital subtractors recover at baseband the complex coordinates of QAM symbols from the upper subband of the DCM-COFDM signal. The complex coordinates of QAM symbols extracted from pilot carriers in each COFDM symbol sampling interval are supplied as parallel input signal to the pilot carriers processor 288. The complex coordinates of QAM symbols extracted from carriers in each COFDM symbol sampling interval that convey coded data are supplied as parallel input signal to the frequency-domain channel equalizer 894 for QAM symbols extracted from the upper subband of the DCM-COFDM signal.

FIGS. 94 and 83 together depict a variant of the receiver apparatus for ISB demodulation of DCM-COFDM depicted in FIGS. 93 and 83, digital circuitry depicted in FIG. 94 replacing some of the analog circuitry depicted in FIG. 93. FIG. 94 depicts modification of FIG. 93 morphologically and operationally similar to the modification of FIG. 89 depicted in FIG. 92. The components 180, 201, 202, 205 and 206 of FIG. 93 are replaced in FIG. 94 by components 280, 213 and 214 described supra in reference to FIG. 92. The DFT computers 873 and 874 perform bandpass filtering of individual OFDM carriers which bandpass filtering should be unresponsive to frequencies outside baseband. This bandpass filtering may allow digital lowpass filters 207 and 208 to be replaced by respective direct connections in modified FIG. 94 structure.

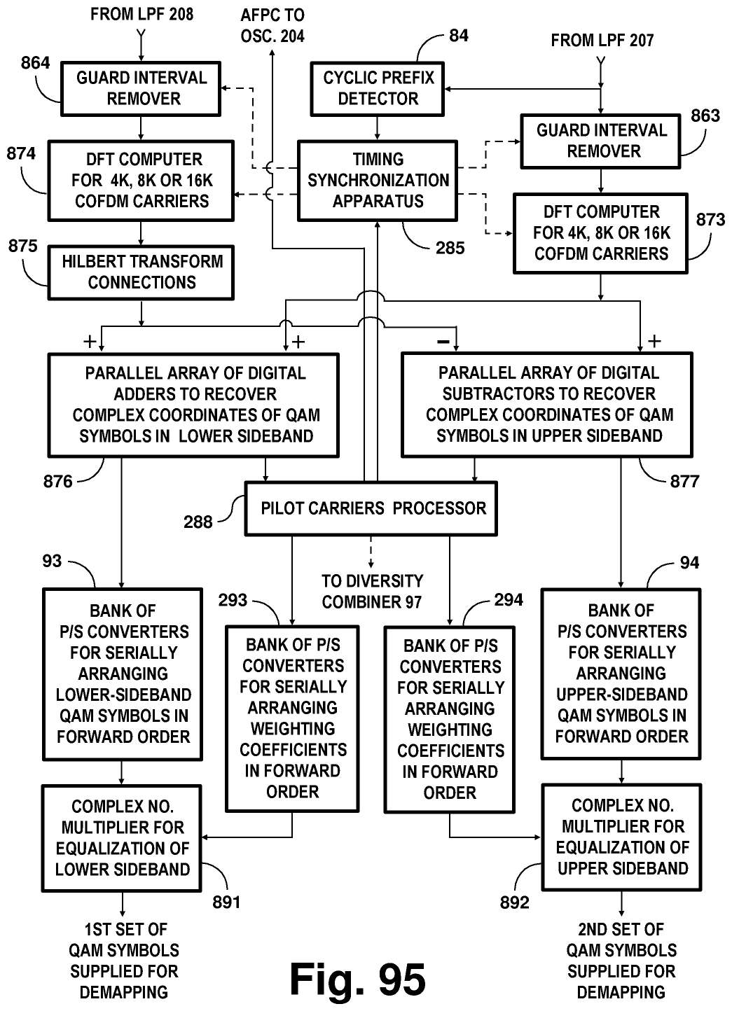

FIG. 95 depicts modifications of either of the receiver structures depicted in FIGS. 93 and 94, which modifications reduce the number of complex-number multipliers needed for frequency domain channel equalization. The channel equalizer 893 that performed multiplications on each of the QAM symbols supplied it in parallel from the parallel array 876 of digital adders is omitted, and the channel equalizer 894 that performed multiplications on each of the QAM symbols supplied to it in parallel from the parallel array 877 of digital subtractors is also omitted. A complex-number multiplier 891 performs frequency-domain channel equalization on each of the QAM symbols from the lower subband of the DCM-COFDM signal furnished it by the parallel array 876 of digital adders after their serialization by a selected one of the parallel-to-serial (P/S) converters in the bank 93 of them. Another complex-number multiplier 892 performs frequency-domain channel equalization on each of the QAM symbols from the upper subband of the DCM-COFDM signal furnished it by the parallel array 877 of digital subtractors after their serialization by a selected one of the parallel-to-serial (P/S) converters in the bank 94 of them. The first and second sets of QAM symbols supplied from the respective product output ports of the multipliers 891 and 892 are suitable input signals for subsequent demapping apparatus e.g., as depicted in FIG. 83 or 84.

More particularly, the QAM symbols from the lower subband of the DCM-COFDM signal that convey data are supplied by respective ones of the parallel array 876 of digital adders directly to respective ones of the parallel input ports of the selected one of the P/S converters in the bank 93 of them. The output port of that selected P/S converter responds to supply serialized QAM symbols from the lower subband of the DCM-COFDM signal to the multiplicand input port of the multiplier 891. The parallel input ports of a selected one of the parallel-to-serial (P/S) converters in a bank 293 of them receives, in parallel from the pilot carriers processor 288, the weighting coefficients for frequency-domain channel equalization of the lower subband of the DCM-COFDM signal. The output port of that selected P/S converter responds to supply serialized weighting coefficients for the lower subband of the DCM-COFDM signal to the multiplier input port of the complex-number multiplier 891. The multiplier 891 responds to its multiplicand and multiplier input signals to supply from its product output port an equalized first set of QAM symbols, suitable for subsequent demapping.

More particularly, the QAM symbols from the upper subband of the DCM-COFDM signal that convey data are supplied by respective ones of the parallel array 877 of digital subtractors directly to the parallel input ports of the selected one of the P/S converters in the bank 94 of them. The output port of that selected P/S converter responds to supply serialized QAM symbols from the upper subband of the DCM-COFDM signal to the multiplicand input port of the multiplier 892. The parallel input ports of a selected one of the parallel-to-serial (P/S) converters in a bank 294 of them receives, in parallel from the pilot carriers processor 288, the weighting coefficients for frequency-domain channel equalization of the upper subband of the DCM-COFDM signal. The output port of that selected P/S converter responds to supply serialized weighting coefficients for the lower subband of the DCM-COFDM signal to the multiplier input port of the complex-number multiplier 891. The multiplier 891 responds to its multiplicand and multiplier input signals to supply from its product output port an equalized second set of QAM symbols, suitable for subsequent demapping.

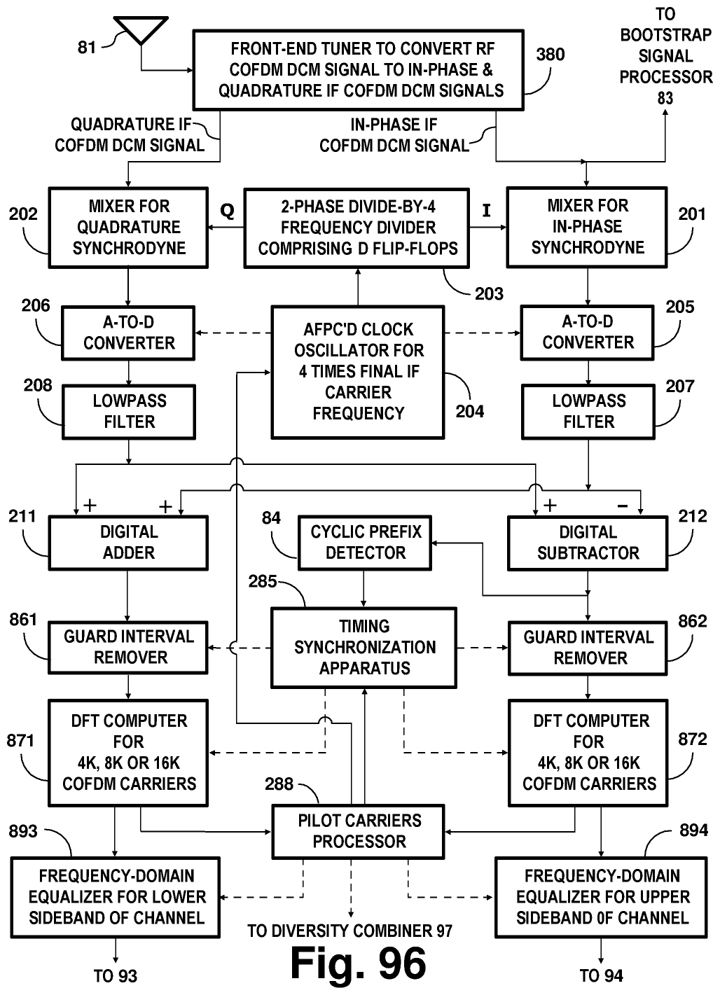

The modified phase shift method of ISB demodulation as described in connection with FIGS. 93, 94 and 95 avoids the need for a digital FIR filter to perform Hilbert transform, but introduces parallel arrays of digital adders and digital subtractors to separate the lower-subband QAM symbols from the upper-subband QAM symbols. Receiver apparatus using a Weaver method of ISB demodulation as described in connection with FIGS. 96 and 83 also avoids the need for a digital FIR filter to perform Hilbert transform, but the modified phase shift method of ISB demodulation is more practical to implement.

FIGS. 96 and 83 together depict the general structure of receiver apparatus for ISB demodulation of DCM-COFDM signals using methods based on methods for demodulating SSB amplitude-modulation signals described by Donald K. Weaver, Jr. in his paper “A third method of generation and detection of single sideband signals”, Proceedings of the IRE, vol. 44, December 1956 issue, pp. 1203-1205. The FIG. 96 structure for ISB demodulation of DCM-COFDM signals differs from the FIG. 90 structure for ISB demodulation of DCM-COFDM signals in the following regards. The front-end tuner 180 to convert RF DCM-COFDM signal to IF DCM-COFDM signal for application to the multiplicand input ports of the mixers 201 and 202 is replaced by a front-end tuner 380 to convert RF DCM-COFDM signal to (a) an in-phase IF DCM-COFDM signal for application to the multiplicand input port of the mixer 201 and (b) a quadrature IF DCM-COFDM signal for application to the multiplicand input port of the mixer 202. The application of quadrature-phase IF DCM-COFDM signal, rather than in-phase IF DCM-COFDM signal, to the multiplicand input port of the mixer 202 obviates the need for an FIR digital filter 209 for Hilbert transformation. Accordingly, there is no call for digital delay line 210 to compensate for latent delay through the filter 209.

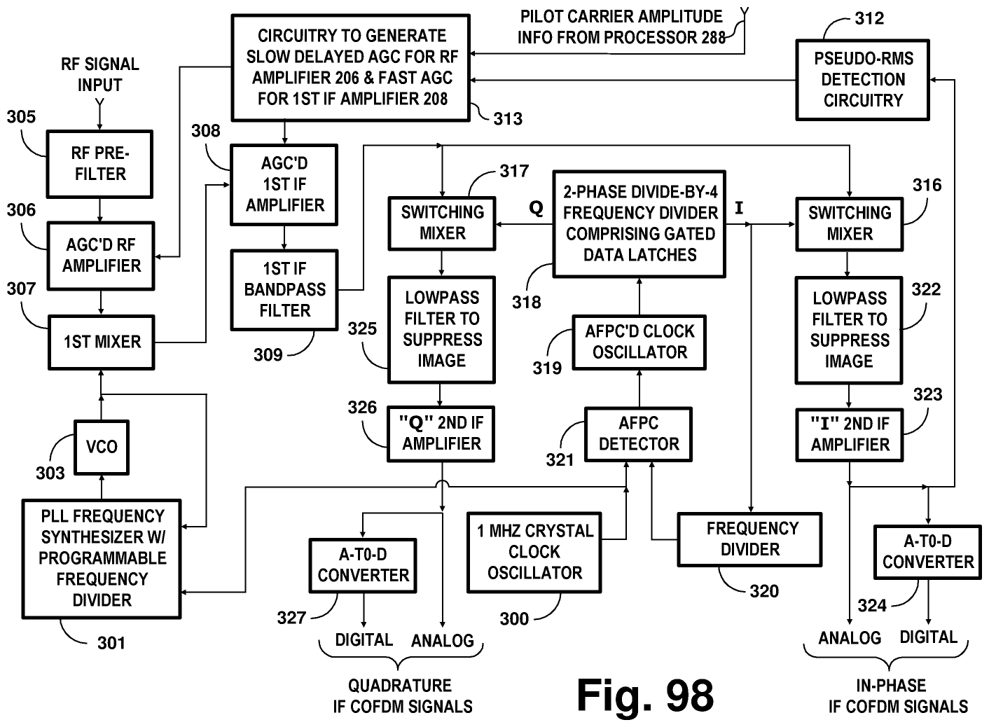

An A-to-D converter 205 performs analog-to-digital conversion of the in-phase and quadrature-phase components of the baseband signal supplied from the output port of the mixer 201. An A-to-D converter 206 performs analog-to-digital conversion of the in-phase and quadrature-phase components of the baseband signal supplied from the output port of the mixer 202. The digitized in-phase baseband signal supplied from the output port of the A-to-D converter 205 is supplied to the input port of a digital lowpass filter 207. The digitized quadrature-phase baseband signal supplied from the output port of the A-to-D converter 206 is supplied to the input port of a digital lowpass filter 208. Preferably, the design of the digital lowpass filters 207 and 208 provides a rapid roll-off in frequency response, so as to suppress adjacent-channel interference (ACI). The DFT computers 871 and 872 perform bandpass filtering of individual OFDM carriers which bandpass filtering should be unresponsive to frequencies outside baseband. This bandpass filtering may allow digital lowpass filters 207 and 208 to be replaced by respective direct connections in modified FIG. 98 structure.

The output port of the lowpass filter 207 and the output port of the lowpass filter 208 are connected to respective addend input ports of the digital adder 211, which is operative to recover at baseband the lower subband of the DCM-COFDM signal at its sum output port. The output ports of the lowpass filters 207 and 208 are respectively connected to the subtrahend input port and the minuend input port of the digital subtractor 212, which is operative to recover at baseband the upper subband of the DCM-COFDM signal at its difference output port. The responses from the sum output port of the digital adder 211 and from the difference output port of the digital subtractor 212 are utilized in the subsequent portions of the FIG. 96 and FIG. 83 receiver apparatus in the same way as in the corresponding portions of the FIG. 90 and FIG. 83 receiver apparatus.

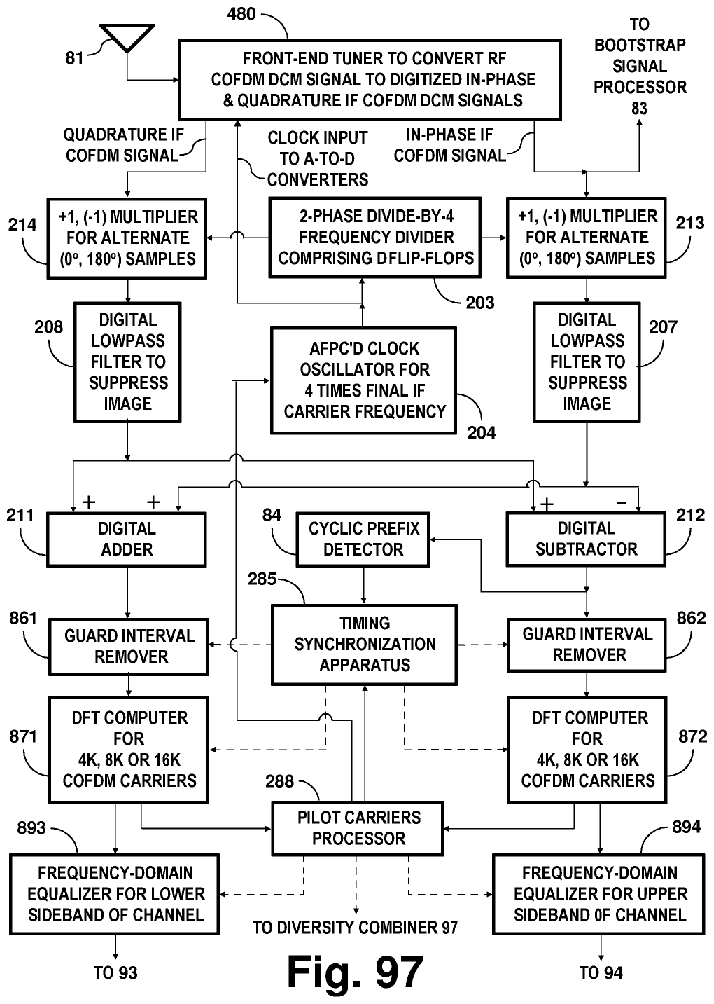

FIGS. 97 and 83 together form a schematic diagram of a variant of the receiver apparatus for ISB demodulation of DCM-COFDM depicted in FIGS. 95 and 83, digital circuitry depicted in FIG. 97 replacing some of the analog circuitry depicted in FIG. 96. The front-end tuner 380 depicted in FIG. 96 that is operable to convert RF COFDM signal to both in-phase and quadrature-phase analog IF COFDM signals is replaced in FIG. 97 by a front-end tuner 480 operable to convert RF COFDM signal to both in-phase and quadrature-phase digital IF DCM-COFDM signals. The front-end tuner 480 is connected to supply the in-phase digital IF DCM-COFDM signals to the multiplicand input port of the +1, (−1) multiplier 213 for in-phase synchrodyne to baseband. The front-end tuner 480 is connected to supply the quadrature-phase digital IF DCM-COFDM signals to the multiplicand input port of a +1, (−1) multiplier 214 for quadrature-phase synchrodyne to baseband. A 2-phase divide-by-4 frequency divider 203 responds to rising edges of pulses from a clock oscillator 204, by supplying I and Q square waves to respective carrier input ports of the +1, (−1) multipliers 213 and 214. The clock oscillator 204 is subject to automatic frequency and phase control (AFPC) that adjusts the frequency of clock pulses to be four times the final intermediate-frequency (IF) carrier of the COFDM signals.

The leading I square wave that the frequency divider 203 supplies to the control input port of the +1, (−1) multiplier 213 conditions the +1, (−1) multiplier 213 to select the 0° digital samples of the in-phase second-IF DCM-COFDM signal for multiplication by +1 responsive to positive half cycles of I square wave, and selecting the 180 digital samples of the in-phase second-IF DCM-COFDM signal for multiplication by −1 responsive to negative half cycles of I square wave. The output port of the +1, (−1) multiplier 213 is connected for supplying the in-phase synchrodyne results to the input port of a digital lowpass filter 207. The lowpass filter 207 responds to the baseband portion of the in-phase synchrodyne results, but not to image signal.

The lagging Q square wave that the frequency divider 203 supplies to the control input port of the +1, (−1) multiplier 214 conditions the +1, (−1) multiplier 214 to select the −90° digital samples of the quadrature-phase second-IF DCM-COFDM signal for multiplication by +1 responsive to positive half cycles of Q square wave, and selecting the 90 digital samples of the quadrature-phase second-IF DCM-COFDM signal for multiplication by −1 responsive to negative half cycles of Q square wave. The output port of the +1, (−1) multiplier 214 is connected for supplying quadrature-phase synchrodyne results to the input port of to the input port of a digital lowpass filter 208. The lowpass filter 208 responds to the baseband portion of the quadrature-phase synchrodyne results, but not to image signal.

If the front-end tuner 480 contains digital lowpass filtering of the digitized IF COFDM DCM signal with rapid roll-off in frequency response for suppressing ACI, there is no reason for the digital lowpass filters 207 and 208 necessarily having to have rapid roll-offs in frequency response to suppress AC. The output port of the lowpass filter 207 and the output port of the lowpass filter 208 are connected to respective addend input ports of the digital adder 211, which is operative to recover at baseband the lower subband of the DCM-COFDM signal at its sum output port. The output ports of the lowpass filters 207 and 208 are respectively connected to the minuend input port and the subtrahend input port of the digital subtractor 212, which is operative to recover at baseband the upper subband of the DCM-COFDM signal at its difference output port. The responses from the sum output port of the digital adder 211 and from the difference output port of the digital subtractor 212 are utilized in the subsequent portions of the FIG. 97 and FIG. 83 receiver apparatus in the same way as in the corresponding portions of the FIG. 96 and FIG. 83 receiver apparatus. The bandpass filtering of individual OFDM carriers in DFT computers 871 and 872 may allow digital lowpass filters 207 and 208 to be replaced by respective direct connections in modified FIG. 97 structure.

FIG. 98 depicts plural superheterodyne front-end tuner structure suitable for implementing the front-end tuner 380 depicted in FIG. 96 or for implementing the front-end tuner 480 depicted in FIG. 97. Elements 300-309, 312 and 313 of the FIG. 98 structure are similar to the elements 300-309, 312 and 313 in the FIG. 91 double-superheterodyne front-end tuner structure. A crystal clock oscillator 300 is connected for supplying 1 MHz reference oscillations to a PLL frequency synthesizer 301 that supplies AFPC voltage to a voltage-controlled oscillator 303. VCO 303 generates the first local oscillations used in the upward conversion of radio-frequency DCM-COFDM signal to first-IF DCM-COFDM signal. The input port of a pre-filter 305 is connected for receiving RF DCM-COFDM signal supplied by an antenna or a cable distribution system. The RF output of the pre-filter 305 is amplified or attenuated to a desired level by an AGC'd RF amplifier 306 and then supplied to a first mixer 307, there to be mixed with oscillations from the first local oscillator 303 to generate first-IF signal. The first-IF output signal supplied from the mixer 307 is amplified by a narrow-band amplifier 308 and then supplied to a first-IF bandpass filter 309 such as a dielectric resonance filter, a strip-line filter or a SAW filter. The input port of pseudo-RMS detection circuitry 312 is connected for receiving amplified second-IF DCM-COFDM signal supplied from the output port of a second IF amplifier. The output port of the pseudo-RMS detection circuitry 312 is connected for supplying an approximation of the root-mean-square RMS voltage of the amplified second-IF DCM-COFDM signal to a first input port of circuitry 313 for generating respective automatic gain control (AGC) signals for the RF amplifier 306 and for the first-IF amplifier 308. A second port of the circuitry 313 for generating AGC signals is connected for receiving pilot carrier amplitude information from the pilot carriers processor 288 depicted in FIG. 96 or in FIG. 97.

The single second mixer 310 of the FIG. 91 front-end tuner structure is replaced by two switching mixers 316 and 317 in the front-end tuner structure depicted in FIG. 98. A 2-phase divide-by-4 frequency divider 318 responds to rising edges of pulses from a clock oscillator 319, by supplying I and Q square waves to respective carrier input ports of the switching mixers 316 and 317. The fundamental frequency of the Q square wave lags the fundamental frequency of the Q square wave by 90° (π/4 radians). The clock oscillator 319 is subject to automatic frequency and phase control (AFPC) responsive to voltage supplied from a PLL frequency synthesizer comprising the divide-by-4 frequency divider 318, a further frequency divider 320 and an AFPC detector 321. The input port of the frequency divider 320 is connected to receive the I square wave applied to the carrier input port of the switching mixer 316. The output port of the frequency divider 230 is connected to a first input port of the AFPC detector 321. A second input port of the AFPC detector 321 is connected for receiving reference-frequency oscillations from the crystal oscillator 300. The output port of the AFPC detector 321 is connected for supplying voltage to the clock oscillator 319 to implement automatic frequency and phase control (AFPC) thereof.

The output port of the switching mixer 316 connects to the input port of a lowpass filter 322 that suppresses image signal in the response supplied from its output port to the input port of an amplifier 323 of the in-phase (“I”) second-IF signal. The output port of the “I” second-IF amplifier 323 is connected to supply analog amplified in-phase second-IF signal that is suitable for an output signal from the FIG. 96 front-end tuner 380. FIG. 98 shows this amplified in-phase second-IF signal applied to the input port of an analog-to-digital converter 324 that responds to supply digital amplified in-phase second-IF signal suitable for a digital output signal from the FIG. 97 front-end tuner 480.

The output port of the switching mixer 317 connects to the input port of a lowpass filter 325 that suppresses image signal in the response supplied from its output port to the input port of an amplifier 326 of the quadrature-phase (“Q”) second-IF signal. The output port of the “Q” second-IF amplifier 326 is connected to supply analog amplified quadrature-phase second-IF signal that is suitable for an output signal from the FIG. 96 front-end tuner 380. FIG. 98 shows this amplified quadrature-phase second-IF signal applied to the input port of an analog-to-digital converter 327 that responds to supply digital amplified quadrature-phase second-IF signal that is suitable for an output signal from the FIG. 97 front-end tuner 480.

FIG. 98 shows the input port of the pseudo-RMS detection circuitry 312 connected for receiving amplified in-phase second-IF signal from the output port of the “I” second-IF amplifier 323. With such connection the measurement of second-IF signal amplitude by the pseudo-RMS detection circuitry 312 takes into account the amplitudes of the pilot carriers in the DCM-COFDM signal. Alternatively, the pseudo-RMS detection circuitry 312 is connected instead for receiving amplified quadrature-phase second-IF signal from the output port of the “Q” second-IF amplifier 326. With such connection the measurement of second-IF signal amplitude by the pseudo-RMS detection circuitry 312 is nonresponsive to the amplitudes of the pilot carriers in the DCM-COFDM signal.

Each of the FIG. 96 and the FIG. 97 COFDM demodulation apparatuses obviates the need for an FIR digital filter to perform Hilbert transformation. However, in order for a Weaver method of demodulation to perform well, these front-end tuners 380 and 480 each need to convert RF DCM-COFDM signal to both in-phase and quadrature-phase IF DCM-COFDM signals subject to the same amplification. The orthogonal relationship between the in-phase and quadrature-phase IF DCM-COFDM signals that either of these front-end tuners 380 and 480 supplies has to be scrupulously maintained, if a Weaver method of ISB demodulation is to perform well. Also, the respective gains of the in-phase and quadrature-phase IF DCM-COFDM signals that the front-end tuner supplies have to match closely, if a Weaver method of ISB demodulation is to perform well. The FIG. 98 structure for front-end tuners addresses these problems by using the 2-phase divide-by-4 frequency divider 318 responsive to output signal from the clock oscillator 319. However, the frequency of oscillations supplied from the clock oscillator 319 will approach 3 GHz, in order to position the fundamental frequencies of the I and Q square waves from the frequency divider 318 above the UHF band for television broadcasting.

The structures depicted in FIGS. 89, 92, 96 and 97 are preferred over variants of them that defer lowpass digital filtering to suppress unwanted image frequencies until after the digital adder 211 and the digital subtractor 212.

Rather than operating two DFT computers in parallel in the in-phase and quadrature-phase branches of the receiver apparatus shown in any of FIGS. 89 and 92, 93, 96 and 97, it is possible to use a single DFT computer in time-division multiplex to serve both branches. While this can reduce “hardware” requirements, higher operating speeds will be required to implement such multiplex.

Various other modifications and variations can be made in the specifically described apparatuses without departing from the spirit or scope of the invention in certain broader ones of its aspects. For example, in variations of the structures depicted in FIGS. 89, 92, 93, 94, 96 and 97 the AFPC'd clock oscillator 204 is replaced by a fixed-frequency clock oscillator, such as a crystal-controlled oscillator. AFPC signals from the pilot carriers processor 288 are supplied to the front-end tuner for fine-tuning a local oscillator therein, so that the principal carrier of intermediate-frequency DCM-COFDM signal(s) supplied from the front end tuner is appropriate for in-phase and quadrature-phase synchrodynes to baseband in those variations of the structures depicted in FIGS. 89, 92, 93, 94, 96 and 97.

The SCM-mapped square 64QAM symbol constellations depicted in FIGS. 8-13, 20, 21, 24, 25, 28, 29,32 and 33 can be modified in the following way, while maintaining their properties that relate to minimizing the PAPR of DCM-COFDM signals and to minimizing the BER of CDD recovered from those DCM-COFDM signals. The six serial bits in 6-bit LPLs of the SCM-mapped square 64QAM symbol constellations depicted in FIGS. 8-13, 20, 21, 24, 25, 28, 29,32 and 33 can be described in general way as being arranged in ABCDEF order. There are N! permutations of N items. That is, the ABCDEF order can be rearranged 6!−1=23 other ways.

By way of example, consider ACEFDB being a revised order in which CDD bits are apportioned to LPLs of SCM-mapped square 64QAM symbol constellations.

1. The palindromic label 000000 in ABCDEF order remains 000000 in ACEFDB order.

2. The palindromic label 001100 in ABCDEF order becomes 010010 in ACEFDB order.

3. The palindromic label 010010 in ABCDEF order becomes 001001 in ACEFDB order.

4. The palindromic label 011110 in ABCDEF order becomes 011011 in ACEFDB order.

5. The palindromic label 100001 in ABCDEF order becomes 100100 in ACEFDB order.

6. The palindromic label 101101 in ABCDEF order becomes 110110 in ACEFDB order.

7. The palindromic label 110011 in ABCDEF order becomes 101101 in ACEFBF order.

8. The palindromic label 111111 in ABCDEF order remains 111111 in ACEBDF order.

Note that not all the palindromic labels in ABCDEF order retain their palindromic appearance after the rearrangement of CDD bit positions to ACEBDF order in LPLs. Despite the rearrangement of CDD bit positions to ACEBDF order in LPLs, the technique for keeping PAPR low in the DCM-COFDM signal remains essentially the same as for the CDD bit positions being in ABCDEF order in LPLs.

There are 3!=6 permutations of the order in which 3-bit sequences can be arranged in the initial halves of 6-bit sequences. In a 6-bit sequence that appears palindromic when viewed in a prescribed order, perforce, the order in which the 3-bit sequence is arranged in the final half of the 6-bit sequence mirrors the order in which the 3-bit sequence in the initial half of the 6-bit sequence is arranged. Accordingly, if the 6-bit-position order ABCDEF be palindromic, there are five other orders of the six bit-positions A, B, C, D, E and F that are palindromic if the following condition be imposed. If bit positions A, B and C are confined to the initial halves of the 6-bit sequences, there are five other orders of the six bit-positions that are palindromic. However the order of the six bit-positions in each of these six 6-bit sequence can be reversed, while keeping palindromic appearance. So, there are altogether twelve possible orders of the six bit-positions A, B, C, D, E and F that are palindromic. Any one of these twelve palindromic orders of the six bit-positions A, B, C, D, E and F is apt to be preferred over revised orders like the ACEBDF order, in which revised orders the palindromic appearance of the original palindromic labels is not retained fully after rearrangement of the sequential order of CDD bits in the LPLs.

By way of further example, then, consider ACEFDB being a revised order in which CDD bits are apportioned to LPLs of SCM-mapped square 64QAM symbol constellations

1. The palindromic label 000000 in ABCDEF order remains 000000 in ACEBDF order.

2. The palindromic label 001100 in ABCDEF order becomes 010010 in ACEBDF order.

3. The palindromic label 010010 in ABCDEF order becomes 001100 in ACEBDF order.

4. The palindromic label 011110 in ABCDEF order remains 011110 in ACEBDF order.

5. The palindromic label 100001 in ABCDEF order remains 100001 in ACEBDF order.

6. The palindromic label 101101 in ABCDEF order becomes 110011 in ACEBDF order.

7. The palindromic label 110011 in ABCDEF order becomes 101101 in ACEBDF order.

8. The palindromic label 111111 in ABCDEF order remains 111111 in ACEBDF order.

Note that, despite the rearrangement of CDD bit positions in LPLS from ABCDEF order to ACEBDF order, the palindromic appearance of each and all of the eight palindromic LPLs from ABCDEF order is fully preserved after the rearrangement to ACEBDF order. Also, despite the rearrangement of CDD bit positions to ACEBDF order, the technique for keeping PAPR low in the DCM-COFDM signal remains essentially the same as for the CDD bit positions being in ABCDEF order in LPLs.

The serial bits in 8-bit LPLs of the SCM-mapped square 256QAM symbol constellations depicted in FIGS. 36-61 can be described in general way as being arranged in ABCDEFGH order. The SCM-mapped square 256QAM symbol constellations depicted in FIGS. 36-61 can be modified by rearranging the order of those bits in the LPLs, while maintaining their properties that relate to minimizing the PAPR of DCM-COFDM signals and to minimizing the BER of CDD recovered from those DCM-COFDM signals. There are sixteen palindromic LPLs in a SCM-mapped square 256QAM symbol constellation, irrespective of the order in which the CDD bits are apportioned to LPLs. Since there are N! permutations of N items, the ABCDEFGH order can be rearranged 8!−1=40,319 other ways, and the palindromic appearance of all 16 of the palindromic LPLs will be fully preserved in 47 of these rearrangements. In some of these revised orders of serial bits in the LPLs of SCM-mapped square 256QAM symbol constellations, the palindromic appearance of the original palindromic labels is fully retained after rearrangement of the sequential order of CDD bits in the LPLs. In others of these revised orders of serial bits in the LPLs of SCM-mapped square 256QAM symbol constellations, however, the palindromic appearance of the original palindromic labels is not fully retained after rearrangement of the sequential order of CDD bits in the LPLs.

The serial bits in 10-bit LPLs of the SCM-mapped square 1024QAM symbol constellations can be described in general way as being arranged in ABCDEFGHIJ order. The LPLs of SCM-mapped square 1024QAM symbol constellations tabulated in FIGS. 78-81 can be modified by rearranging the order of those bits in the LPLs, while maintaining their properties that relate to minimizing the PAPR of DCM-COFDM signals and to minimizing the BER of CDD recovered from those DCM-COFDM signals. There are 64 palindromic LPLs in a SCM-mapped square 1024QAM symbol constellation, irrespective of the order in which the CDD bits are apportioned to LPLs. Since there are N! permutations of N items, the ABCDEFGHIJ order can be rearranged 10!−1=3,628,799 other ways, and the palindromic appearance of all 64 of the palindromic LPLs will be fully preserved in 239 of these rearrangements. In some of these revised orders of serial bits in the LPLs of SCM-mapped square 1024QAM symbol constellations, the palindromic appearance of the original palindromic labels is fully retained after rearrangement of the sequential order of CDD bits in the LPLs. In many others of these revised orders of serial bits in the LPLs of SCM-mapped square 1024QAM symbol constellations, however, the palindromic appearance of the original palindromic labels is not fully retained after rearrangement of the sequential order of CDD bits in the LPLs.

The serial bits in 12-bit LPLs of the SCM-mapped square 4096QAM symbol constellations can be described in general way as being arranged in ABCDEFGHIJKL order. The LPLs of SCM-mapped square 4096QAM symbol constellations tabulated in FIGS. 78-81 can be modified by rearranging the order of those bits in the LPLs, while maintaining their properties that relate to minimizing the PAPR of DCM-COFDM signals and to minimizing the BER of CDD recovered from those DCM-COFDM signals. There are 256 palindromic LPLs in a SCM-mapped square 4096QAM symbol constellation, irrespective of the order in which the CDD bits are apportioned to LPLs. Since there are N! permutations of N items, the ABCDEFGHIJKL order can be rearranged 10!−1=479,001,599 other ways, and the palindromic appearance of all 256 of the palindromic LPLs will be fully preserved in 1,439 of these rearrangements. In some of these revised orders of serial bits in the LPLs of SCM-mapped square 4096QAM symbol constellations, the palindromic appearance of the original palindromic labels is fully retained after rearrangement of the sequential order of CDD bits in the LPLs. In many others of these revised orders of serial bits in the LPLs of SCM-mapped square 4096QAM symbol constellations, however, the palindromic appearance of the original palindromic labels is not fully retained after rearrangement of the sequential order of CDD bits in the LPLs.

Persons skilled in the art of designing OFDM communications systems and acquainted with this disclosure are apt to discern that various modifications and variations can be made in the specifically described apparatuses without departing from the spirit or scope of the invention in certain broader ones of its aspects. (For example, the invention can be usefully employed in electronic apparatus used in wireless telephonic communication systems.) Accordingly, it is intended that such modifications and variations be considered to result in further embodiments of the invention, to be included within the scope of the appended claims and their equivalents in accordance with the doctrine of equivalents.

In the appended claims, the word “said” rather than the word “the” is used to indicate the existence of an antecedent basis for a term being provided earlier in the claims. The word “the” is used for purposes other than to indicate the existence of an antecedent basis for a term appearing earlier in the claims, the usage of the word “the” for other purposes being consistent with customary grammar in the American English language.

What is claimed is:

1. Electronic apparatus configured for combination with a dual-carrier-modulation (DCM) coded orthogonal-frequency-division-multiplex (COFDM) signal conveyed by a plurality of quadrature-amplitude-modulated (QAM) electromagnetic carrier waves, said combination useful in an enabling manner within in a communication system for conveying coded digital data, said DCM-COFDM signal further characterized by:
(a) a first half of said plurality of electromagnetic carrier waves being amplitude modulated by respective ones of a first set of successive square QAM symbols of a specific size larger than 16QAM, each superposition-coded-modulation (SCM) mapped in accordance with a first pattern of lattice-point labeling, thereby to convey a respective set of soft bits of coded digital data via each QAM symbol in said first set of successive square QAM symbols, each QAM symbol SCM mapped in accordance with said first pattern of SCM mapping square QAM symbol constellations comprising a respective −I,+Q quadrant and a respective +I,+Q quadrant and a respective +I,−Q quadrant and a respective −I,−Q quadrant, each of said quadrants in said first pattern of SCM mapping digital lattice-point labels to QAM symbol constellations being composed of an innermost sub-quadrant thereof and an outermost sub-quadrant thereof and two flanking sub-quadrants thereof;
(b) a second half of said plurality of electromagnetic carrier waves being amplitude modulated by respective ones of a second set of successive square QAM symbols of said specific size larger than 16QAM, each SCM mapped in accordance with a second pattern of lattice-point labeling, thereby to convey a respective set of soft bits of said coded digital data via each QAM symbol in said second set of successive square QAM symbols, each QAM symbol SCM mapped in accordance with said second pattern of SCM mapping square QAM symbol constellations comprising a respective −I,+Q quadrant and a respective +I,+Q quadrant and a respective +I,−Q quadrant and a respective −I,−Q quadrant, each of said quadrants in said second pattern of SCM mapping digital lattice-point labels to QAM symbol constellations being composed of an innermost sub-quadrant thereof and an outermost sub-quadrant thereof and two flanking sub-quadrants thereof
(c) the lattice points in the outermost sub-quadrants of said four quadrants of said second pattern of SCM mapping having respective digital map labels corresponding to digital map labels of lattice points in the innermost sub-quadrants of said four quadrants of said first pattern of SCM mapping, the lattice points in the innermost sub-quadrants of said four quadrants of said second pattern of SCM mapping having respective digital map labels corresponding to digital map labels of lattice points in the outermost sub-quadrants of said four quadrants of said first pattern of SCM mapping;
(d) each lattice-point label associated with higher energy in said first pattern of lattice-point labeling being associated with lower energy in said second pattern of lattice-point labeling, each lattice-point label associated with lower energy in said first pattern of lattice-point labeling being associated with higher energy in said second pattern of lattice-point labeling;
(e) bits more likely to experience error in the lattice-point labeling of the first set of successive QAM symbols per said first mapping pattern correspond to bits less likely to experience error in the lattice-point labeling of the second set of successive square QAM symbols per said second mapping pattern; and
(f) bits more likely to experience error in the lattice-point labeling of the second set of successive square QAM symbols per said second mapping pattern correspond to bits less likely to experience error in the lattice-point labeling of the first set of successive square QAM symbols per said first mapping pattern.

2. Electronic apparatus configured for combination with a DCM-OFDM signal, as set forth in claim 1, said DCM-COFDM signal further characterized by:
(g) certain ones of said lattice points in said first mapping pattern having lattice-point labels (LPLs) that are palindromic when their bits are considered in a particular sequential order;
(h) different one-quarters of all those certain ones of said lattice points in said first mapping pattern being arranged along respective diagonals of its said quadrants, which diagonals extend to the center of said first mapping pattern;
(i) each of said different one-quarters of all those certain ones of said lattice points in said first mapping pattern being confined to one of the innermost and outermost sub-quadrants of the one of said quadrants it is arranged along a respective diagonal thereof;
(j) certain ones of said lattice points in said second mapping pattern having lattice-point labels (LPLs) that are palindromic when their bits are considered in said particular sequential order;
(k) different one-quarters of all those certain ones of said lattice points in said second mapping pattern being arranged along respective diagonals of its said quadrants, which diagonals extend to the center of said second mapping pattern; and
(l) each of said different one-quarters of all those certain ones of said lattice points in said second mapping pattern being confined to one of the innermost and outermost subquadrants of the one of said quadrants it is arranged along a respective diagonal thereof.

3. Electronic apparatus configured for combination with a DCM-OFDM signal, as set forth in claim 2, said DCM-COFDM signal further characterized by
(m) said certain ones of said lattice points in said first mapping pattern have lattice-point labels (LPLs) that are palindromic when their bits are considered in the same sequential order as those bits successively occur in said coded digital data; and
(n) said certain ones of said lattice points in said second mapping pattern have lattice-point labels (LPLs) that are palindromic when their bits are considered in the same sequential order as those bits successively occur in said coded digital data.

4. Electronic apparatus configured for combination with a DCM-OFDM signal, as set forth in claim 2, said DCM-COFDM signal further characterized by:
said first half of said plurality of electromagnetic carrier waves being disposed in a first subband of a communication channel, which first subband is lower in frequency than a second subband of said communication channel;
said second half of said plurality of electromagnetic carrier waves being disposed in said second subband of said communication channel;
the electromagnetic carrier waves conveying a respective set of soft bits of coded digital data via each QAM symbol in said first set of successive square QAM symbols being arranged in said first subband of said communication channel in a prescribed sequential order of carrier frequencies; and
the electromagnetic carrier waves conveying a respective set of soft bits of coded digital data via each QAM symbol in said second set of successive square QAM symbols being arranged in said second subband of said communication channel in said prescribed sequential order of carrier frequencies.

5. Electronic apparatus configured for combination with a DCM-OFDM signal, as set forth in claim 2, said electronic apparatus being transmitter apparatus for said DCM COFDM signal, said transmitter apparatus comprising:
first modulation means for modulating the respective amplitudes of said first half of said plurality of electromagnetic carrier waves in accordance with said respective ones of said first set of successive square QAM symbols of said specific size larger than 16QAM;
second modulation means for modulating the respective amplitudes of said second half of said plurality of electromagnetic carrier waves in accordance with said respective ones of said second set of successive square QAM symbols of said specific size larger than 16QAM;
means for arranging said first and said second halves of said of said plurality of electromagnetic carrier waves within a radio-frequency (RF) full-channel plural-carrier-wave signal for power amplification;
means for linearly amplifying the power of said RF full-channel plural-carrier-wave signal; and
means for transmitting said RF full-channel plural-carrier-wave signal subsequent to linear amplifying thereof, said means for transmitting providing an initial part of said communication system for conveying coded digital data.

6. Electronic apparatus configured for combination with a DCM-OFDM signal, as set forth in claim 2, said electronic apparatus being receiver apparatus for said DCM COFDM signal, said receiver apparatus comprising:
a front-end tuner for selectively receiving a radio-frequency (RF) full-channel plural-carrier signal comprising said DCM COFDM signal and converting said RF full-channel plural-carrier signal to a baseband DCM COFDM signal;
means responsive to said baseband DCM COFDM signal to compute both (a) the discrete Fourier transform of the lower half of the frequency spectrum of said baseband DCM COFDM signal and (b) the discrete Fourier transform of the lower half of the frequency spectrum of said baseband DCM COFDM signal;
means for extracting a first set of successive square QAM symbols of a specific size larger than 16QAM, each superposition-coded-modulation (SCM) mapped in accordance with a first pattern of lattice-point labeling, said first set of successive square QAM symbols being extracted from the discrete Fourier transform of the lower half of the frequency spectrum of said baseband DCM COFDM signal;
means for extracting a second set of successive square QAM symbols of a specific size larger than 16QAM, each superposition-coded-modulation (SCM) mapped in accordance with a second pattern of lattice-point labeling, said second set of successive square QAM symbols being extracted from the discrete Fourier transform of the upper half of the frequency spectrum of said baseband DCM COFDM signal;
first demapping means configured for demapping said first set of successive square QAM symbols of said specific size larger than 16QAM, each SCM mapped in accordance with said first pattern of lattice-point labeling, thereby to recover a respective set of soft bits of said coded digital signal from each QAM symbol in said first set of successive square QAM symbols;
second demapping means configured for demapping said second set of successive square QAM symbols of said specific size larger than 16QAM, each SCM mapped in accordance with said second pattern of lattice-point labeling, thereby to recover a respective set of soft bits of said coded digital signal from each QAM symbol in said second set of successive square QAM symbols;
means for providing maximal ratio combining of corresponding soft bits of said coded digital signal to generate a reproduced coded digital signal; and
means for decoding said reproduced coded digital signal to recover the digital signal encoded therein.

7. Electronic apparatus configured for combination with a DCM-OFDM signal, as set forth in claim 1, said DCM-COFDM signal further characterized by:
said first half of said plurality of electromagnetic carrier waves being disposed in a first subband of a communication channel, which first subband is lower in frequency than a second subband of said communication channel;
said second half of said plurality of electromagnetic carrier waves being disposed in said second subband of said communication channel;
the electromagnetic carrier waves conveying a respective set of soft bits of coded digital data via each QAM symbol in said first set of successive square QAM symbols being arranged in said first subband of said communication channel in a prescribed sequential order of carrier frequencies; and
the electromagnetic carrier waves conveying a respective set of soft bits of coded digital data via each QAM symbol in said second set of successive square QAM symbols being arranged in said second subband of said communication channel in said prescribed sequential order of carrier frequencies.

8. Electronic apparatus configured for combination with a DCM-OFDM signal, as set forth in claim 1, said electronic apparatus being transmitter apparatus for said DCM COFDM signal, said transmitter apparatus comprising:
first modulation means for modulating the respective amplitudes of said first half of said plurality of electromagnetic carrier waves in accordance with said respective ones of said first set of successive square QAM symbols of said specific size larger than 16QAM;
second modulation means for modulating the respective amplitudes of said second half of said plurality of electromagnetic carrier waves in accordance with said respective ones of said second set of successive square QAM symbols of said specific size larger than 16QAM;
means for arranging said first and said second halves of said of said plurality of electromagnetic carrier waves within a radio-frequency (RF) full-channel plural-carrier-wave signal for power amplification;
means for linearly amplifying the power of said RF full-channel plural-carrier-wave signal; and
means for transmitting said RF full-channel plural-carrier-wave signal subsequent to linear amplifying thereof, said means for transmitting providing an initial part of said communication system for conveying coded digital data.

9. Electronic apparatus configured for combination with a DCM-OFDM signal, as set forth in claim 1, said electronic apparatus being receiver apparatus for said DCM COFDM signal, said receiver apparatus comprising:
a front-end tuner for selectively receiving a radio-frequency (RF) full-channel plural-carrier signal comprising said DCM COFDM signal and converting said RF full-channel plural-carrier signal to a baseband DCM COFDM signal;
means responsive to said baseband DCM COFDM signal to compute both (a) the discrete Fourier transform of the lower half of the frequency spectrum of said baseband DCM COFDM signal and (b) the discrete Fourier transform of the lower half of the frequency spectrum of said baseband DCM COFDM signal;
means for extracting a first set of successive square QAM symbols of a specific size larger than 16QAM, each superposition-coded-modulation (SCM) mapped in accordance with a first pattern of lattice-point labeling, said first set of successive square QAM symbols being extracted from the discrete Fourier transform of the lower half of the frequency spectrum of said baseband DCM COFDM signal;
means for extracting a second set of successive square QAM symbols of a specific size larger than 16QAM, each superposition-coded-modulation (SCM) mapped in accordance with a second pattern of lattice-point labeling, said second set of successive square QAM symbols being extracted from the discrete Fourier transform of the upper half of the frequency spectrum of said baseband DCM COFDM signal;
first demapping means configured for demapping said first set of successive square QAM symbols of said specific size larger than 16QAM, each SCM mapped in accordance with said first pattern of lattice-point labeling, thereby to recover a respective set of soft bits of said coded digital signal from each QAM symbol in said first set of successive square QAM symbols;
second demapping means configured for demapping said second set of successive square QAM symbols of said specific size larger than 16QAM, each SCM mapped in accordance with said second pattern of lattice-point labeling, thereby to recover a respective set of soft bits of said coded digital signal from each QAM symbol in said second set of successive square QAM symbols;
means for providing maximal ratio combining of corresponding soft bits of said coded digital signal to generate a reproduced coded digital signal; and
means for decoding said reproduced coded digital signal to recover the digital signal encoded therein.
